(19) United States
(12) Patent Application Publication
(10) Pub. No.: US 2010/0091150 A1
(43) Pub. Date: Apr. 15, 2010

(54) SOLID-STATE IMAGING DEVICE AND SIGNAL PROCESSING SYSTEM

(75) Inventors: Hidehiko OGASAWARA, Chiba (JP); Toshiyuki SEKIYA, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/555,235

(22) Filed: Sep. 8, 2009

(30) Foreign Application Priority Data
Oct. 10, 2008 (JP) 2008-264577

(51) Int. Cl. H04N 5/335; H04N 5/225

(52) U.S. Cl. 348/294; 348/340; 348/E05.091; 348/E05.024

(57) ABSTRACT

A solid-state imaging device includes: a pixel portion configured to convert light into an electric signal; a substrate where the pixel portion is formed; an A/D conversion unit configured to convert a signal read out from the pixel portion into a digital signal; and an optical communication unit configured to convert a signal digitized by the A/D conversion unit into an optical signal, and output the optical signal, with the single optical communication unit or a plurality of the optical communication units being disposed grouped in the vicinity portion of the substrate around the pixel portion.

### BACKGROUND OF THE INVENTION

1. Field of the Invention

The present invention relates to a solid-state imaging device which converts an optical image into an electric signal, and a signal processing system including this solid-state imaging device, and more specifically, relates to a solid-state imaging device which converts an optical image into an electric signal, and a signal processing system including this solid-state imaging device, whereby a pixel signal to be read out from the solid-state imaging device can be output as an optical signal.

2. Description of the Related Art

Increased speed and integration of circuit substrates has advanced, and accordingly, there is pressing demand for handling of problems such as signal delay, occurrence of EMI, and so forth. Optical wiring technology has attracted attention wherein signal delay, signal deterioration, and electromagnetic interference noise irradiated from wiring that have been problems due to electric wiring are solved, and high-speed transmission is enabled.

Technology using such optical wiring technology has been proposed wherein a lens configured so as to be detachable from a camera main unit includes a solid-state imaging device, whereby a signal to be output from the solid-state imaging device can be propagated to the camera main unit (e.g., see Japanese Unexamined Patent Application Publication No. 2006-196972).

On the other hand, in order to suppress heat generated at a solid-state imaging device, technology has been proposed wherein power supply is controlled so as not to drive an output unit at timing unnecessary for pixel output (e.g., see Japanese Unexamined Patent Application Publication No. 2004-112422).

### SUMMARY OF THE INVENTION

High-speed transmission of a signal can be executed by using the optical wiring technology. However, with the technology described in Japanese Unexamined Patent Application Publication No. 2006-196972, only a configuration has been disclosed wherein light emitting elements are mounted on a substrate on which a solid-state imaging device has been mounted, and no description has been made regarding the layout of the light emitting elements. Therefore, a problem regarding heat due to positional relationship between the solid-state imaging device and the light emitting elements has not been solved. Also, such as the technology described in Japanese Unexamined Patent Application Publication No. 2004-112422, influence that not heat generated by the solid-state imaging device but heat generated by the light emitting elements provides to the solid-state imaging device has not been considered.

It has been found to be desirable to a solid-state imaging device and a signal processing system which enable a pixel signal to be read out from a pixel portion to be transmitted at high speed using an optical signal, while suppressing influence of heat due to optical communication.

According to an embodiment of the present invention, a solid-state imaging device includes: a pixel portion configured to convert light into an electric signal; a substrate where the pixel portion is formed; an A/D conversion unit configured to convert a signal read out from the pixel portion into a digital signal; and an optical communication unit configured to convert a signal digitized by the A/D conversion unit into an optical signal, and output the optical signal, with the single optical communication unit or a plurality of the optical communication units being disposed grouped in the vicinity portion of the substrate around the pixel portion.

According to an embodiment of the present invention, a solid-state imaging device includes: a pixel portion configured to convert light into an electric signal; a substrate where the pixel portion is formed; an A/D conversion unit configured to convert a signal read out from the pixel portion into a digital signal; and an optical communication unit configured to convert a signal digitized by the A/D conversion unit into an optical signal, and output the optical signal, with the single optical communication unit being disposed discretely in the vicinity portion of the substrate around the pixel portion.

According to an embodiment of the present invention, a solid-state imaging device includes: a pixel portion configured to convert light into an electric signal; a substrate where the pixel portion is formed; an A/D conversion unit configured to convert a signal read out from the pixel portion into a digital signal; and an optical communication unit configured to convert a signal digitized by the A/D conversion unit into an optical signal, and output the optical signal, with a plurality of the optical communication units being disposed discretely grouped in the vicinity portion of the substrate around the pixel portion.

According to an embodiment of the present invention, a signal processing system includes: an optical apparatus including a solid-state imaging device configured to convert incident light into an electric signal, and an optical element configured to allow the solid-state imaging device to input light; and a signal processing apparatus to which the optical apparatus is connected, with the solid-state imaging device including a pixel portion configured to convert light into an electric signal; a substrate where the pixel portion is formed; an A/D conversion unit configured to convert a signal read out from the pixel portion into a digital signal; and an optical communication unit configured to convert a signal digitized by the A/D conversion unit into an optical signal, and output the optical signal, and with the single optical communication unit or a plurality of the optical communication units being disposed grouped in the vicinity portion of the substrate around the pixel portion, the single optical communication unit being disposed discretely in the vicinity portion of the substrate around the pixel portion, or a plurality of the optical communication units being disposed discretely grouped in the vicinity portion of the substrate around the pixel portion.

With the above configurations, a electric signal photoelectric-converted by light inputting to the pixel portion is read out, and is input to the A/D conversion unit. The signal input to the A/D conversion unit is converted into a digital signal, transmitted through a signal wiring, and input to the optical communication unit. The digital signal input to the optical communication unit is converted into an optical signal, and the signal light is output. The optical communication units have a configuration wherein heat sources are grouped to be cooled in a batch according to the number of transmission channels and load and so forth, a configuration wherein heat is dispersed, or the like, whereby a layout based on heat management is selected, and the optical communication units are disposed grouped, discretely, or discretely grouped in the vicinity portion of the substrate.

With the above configurations, the signal read out from the pixel portion is transmitted as an optical signal, and also the optical communication units are disposed grouped, disposed discretely, or disposed discretely grouped. Thus, optimization according to the layout of the optical communication units can be executed regarding heat, electromagnetic noise, and false optical signals generated from the optical communication units, and effective removal of noise components can be executed.

Also, flexibility regarding the layout of the optical communication unit improves, whereby flexibility regarding the layout of the cooling units for the optical communication units also improves. Various types of cooling system can be employed, for example, such as a system wherein the optical communication units are disposed grouped, and are cooled in a batch, a system wherein the optical communication units are disposed discretely, and heat sources are cooled discretely, and so forth.

Further, flexibility regarding the layout of the optical communication units improves, whereby various types of signal transmission method can be employed, for example, such as parallel transmission, serial transmission wherein a synchronizing signal and a clock signal are superposed on a data line, multiple transmissions between a serialized data line and a clock signal, and so forth.

Also, the optical communication units can be disposed according to the readout method from the pixel portion, whereby the optimal layout of the optical communication units can be used for each readout method, and also a configuration according to the readout data amount or the like can be selected, and consequently, flexibility regarding the signal readout method of the solid-state imaging device increases.

### BRIEF DESCRIPTION OF THE DRAWINGS

FIG. 1 is a schematic plan view illustrating an example of a solid-state imaging device in which optical communication units are disposed grouped;

FIG. 2 is a functional block diagram illustrating an example of functions used for realizing the solid-state imaging device according to each of embodiments;

FIG. 3 is a schematic plan view illustrating a layout example of an optical communication unit which realizes a single transmission channel;

FIG. 4 is a schematic plan view illustrating a layout example of an optical communication unit which realizes multiple transmission channels;

FIG. 5 is a schematic plan view illustrating a layout example of optical communication units which realize multiple transmission channels;

FIG. 6 is a schematic plan view illustrating a layout example of optical communication units which realize multiple transmission channels;

FIG. 7 is a schematic plan view illustrating an example of a solid-state imaging device in which optical communication units are disposed discretely;

FIG. 8 is a schematic plan view illustrating an example of a solid-state imaging device in which optical communication units are disposed discretely grouped;

FIG. 9 is a configuration diagram illustrating an example of an optical communication unit of a solid-state imaging device;

FIG. 10 is a configuration diagram illustrating another example of an optical communication unit of a solid-state imaging device;

FIG. 11 is a graph illustrating relationship between applied voltage and the absorption amount of light;

FIG. 12 is a configuration diagram illustrating another example of an optical communication unit of a solid-state imaging device;

FIG. 13 is a configuration diagram illustrating another example of an optical communication unit of a solid-state imaging device;

FIG. 14 is a schematic plan view illustrating a first layout example of components making up an optical communication unit;

FIG. 15 is a schematic side view illustrating the first layout example of the components making up the optical communication unit;

FIG. 16 is a schematic plan view illustrating a second layout example of components making up an optical communication unit;

FIG. 17 is a schematic side view illustrating the second layout example of the components making up the optical communication unit;

FIG. 18 is a schematic plan view illustrating a third layout example of components making up an optical communication unit;

FIG. 19 is a schematic plan view illustrating a fourth layout example of components making up an optical communication unit;

FIG. 20 is a schematic side view illustrating a fifth layout example of components making up an optical communication unit;

FIG. 21 is a schematic plan view illustrating the fifth layout example of the components making up the optical communication unit;

FIG. 22 is a schematic side view illustrating a sixth layout example of components making up an optical communication unit;

FIG. 23 is a schematic plan view illustrating the sixth layout example of the components making up the optical communication unit;

FIG. 24 is a schematic plan view illustrating a seventh layout example of components making up an optical communication unit;

FIG. 25 is a schematic plan view illustrating an eighth layout example of components making up an optical communication unit;

FIGS. 26A and 26B are schematic perspective views illustrating the eighth layout example of the components making up the optical communication unit;

FIG. 27 is a schematic plan view of a solid-state imaging device illustrating a configuration example of a cooling unit of a self-emitting optical communication unit disposed grouped;

FIG. 28 is a schematic plan view of a solid-state imaging device illustrating another configuration example of a cooling unit of a self-emitting optical communication unit disposed grouped;

FIG. 29 is a schematic plan view of a solid-state imaging device illustrating a configuration example of a cooling unit of a self-emitting optical communication unit disposed discretely grouped;

FIG. 30 is a schematic plan view of a solid-state imaging device illustrating a configuration example of a cooling unit of a self-emitting optical communication unit disposed discretely;

FIG. 31 is a schematic plan view of a solid-state imaging device illustrating a configuration example of a cooling unit of an external-modulating optical communication unit disposed discretely grouped;

FIG. 32 is a schematic plan view of a solid-state imaging device illustrating a configuration example of a cooling unit of an external-modulating optical communication unit disposed discretely;

FIG. 33 is a schematic plan view of a solid-state imaging device illustrating another configuration example of a cooling unit of an external-modulating optical communication unit disposed discretely;

FIG. 34 is a functional block diagram illustrating an overview of a signal processing system including a solid-state imaging device;

FIG. 35 is a schematic perspective view illustrating an example of a camera system serving as an application of the signal processing system;

FIG. 36 is a schematic front view of a lens unit making up the camera system;

FIG. 37 is a schematic perspective view illustrating another example of a camera system serving as an application of the signal processing system;

FIG. 38 is a schematic front view of a lens unit making up the camera system;

FIG. 39 is a functional block diagram illustrating a specific example of the solid-state imaging device according to each of embodiments;

FIG. 40 is a circuit configuration diagram illustrating a specific example of a pixel array;

FIG. 41 is a cross-sectional configuration diagram illustrating a configuration model example of each of pixels;

FIG. 42 is a functional block diagram illustrating a layout example of an optical communication unit with a solid-state imaging device according to each of embodiments;

FIG. 43 is a functional block diagram illustrating a layout example of an optical communication unit with a solid-state imaging device according to each of embodiments;

FIG. 44 is a functional block diagram illustrating a layout example of an optical communication unit with a solid-state imaging device according to each of embodiments;

FIG. 45 is a functional block diagram illustrating a layout example of an optical communication unit with a solid-state imaging device according to each of embodiments;

FIG. 46 is a schematic plan view illustrating a layout example of optical communication units at the time of multi-line readout according to a pixel configuration;

FIG. 47 is a schematic plan view illustrating a layout example of optical communication units at the time of multi-line readout according to electronic shutter timing;

FIG. 48 is a time chart illustrating electronic shutter timing and exposure time;

FIG. 49 is a schematic plan view illustrating a layout example of optical communication units at the time of multi-line readout according to pixel readout speed;

FIG. 50 is a schematic plan view illustrating a layout example of optical communication units at the time of multi-line readout according to area readout;

FIG. 51 is a schematic plan view illustrating a layout example of optical communication units at the time of multi-line readout according to French-door readout;

FIG. 52 is a schematic plan view illustrating a layout example of optical communication units at the time of multi-line readout according to field readout;

FIG. 53 is a schematic plan view illustrating a layout example of optical communication units at the time of multi-line readout according to four-pixel addition readout;

FIG. 54 is a functional block diagram illustrating an example of arrayed optical communication units;

FIG. 55 is a schematic plan view of a solid-state imaging device illustrating a layout example of an optical communication unit which executes parallel transmission;

FIGS. 56A through 56C are functional block diagrams illustrating an example of an optical communication unit which serializes pixel data to execute optical communication;

FIG. 57 is a schematic plan view of a solid-state imaging device illustrating a layout example of optical communication units which execute serial transmission;

FIGS. 58A and 58B are functional block diagrams illustrating an example of an optical communication unit which serializes pixel data to execute optical communication using multiple optical output units; and

FIG. 59 is a schematic plan view of a solid-state imaging device illustrating a layout example of optical communication units which transmit a serialized data signal and a clock signal using independent channels.

### DESCRIPTION OF THE PREFERRED EMBODIMENTS

Description will be made below regarding embodiments of a solid-state imaging device of the present invention, an optical apparatus including the solid-state imaging device, a signal processing apparatus to which the optical apparatus is connected, and a signal processing system including the optical apparatus and the signal processing apparatus.

### Configuration Example of Solid-State Imaging Device According to First Embodiment

### (1-1) Configuration Example of Solid-State Imaging Device in which Optical Communication Units are Disposed Grouped

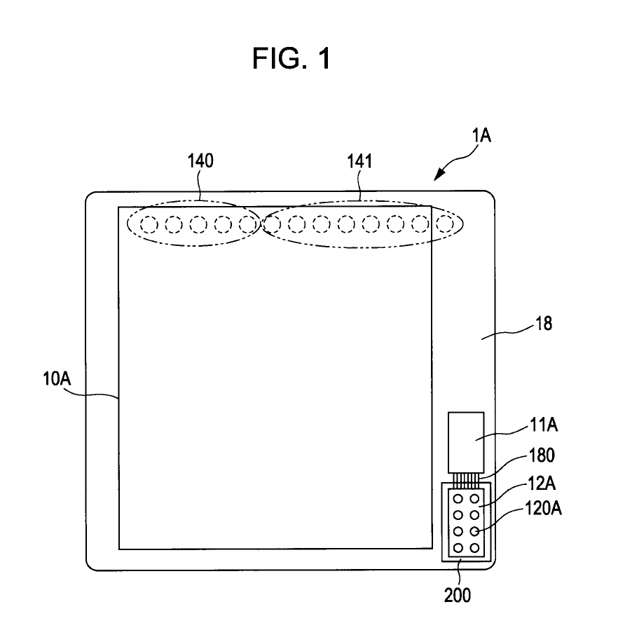

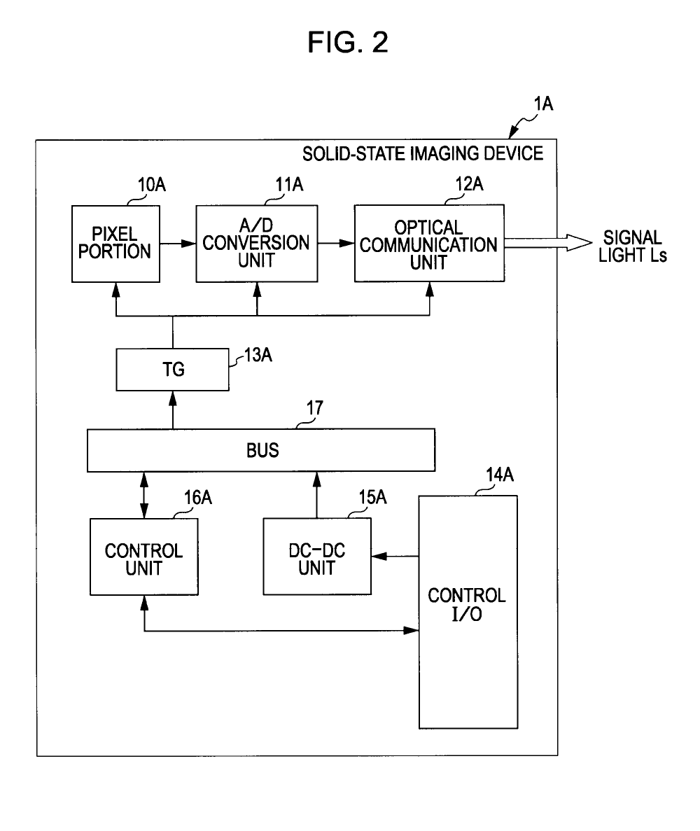

FIG. 1 is a schematic plan view illustrating an example of a solid-state imaging device in which optical communication units are disposed grouped. FIG. 2 is a functional block diagram illustrating an example of functions used for realizing the solid-state imaging device according to each of embodiments.

A solid-state imaging device 1A in which an optical communication unit is disposed grouped is configured of a CMOS (Complementary Metal Oxide Semiconductor) image sensor, or a CCD (Charge Coupled Device) image sensor. The solid-state imaging device 1A includes a pixel portion 10A which converts light into an electric signal to output this. With the pixel portion 10A, pixels which convert light into electricity are arrayed two-dimensionally or one-dimensionally, from which an electric signal according to the intensity of incident light is output.

The solid-state imaging device 1A includes an A/D conversion unit 11A which converts the electric signal output from the pixel portion 10A into a digital signal, and an optical communication unit 12A which converts the electric signal digitized at the A/D conversion unit 11A into an optical signal to output this.

The optical communication unit 12A includes a single or multiple optical output units 120A which convert an electric signal into an optical signal. The optical communication unit 12A includes a self-emitting light emitting element as a first embodiment of the optical output unit 120A, for example, such as a semiconductor laser (LD) or the like which emits light by voltage being applied thereto. With a light emitting element such as a semiconductor laser or the like, light can be modulated using an electric signal due to change in applied voltage or the like. Thus, the optical communication unit 12A modulates self-luminous light based on the electric signal converted into a digital signal at the A/D conversion unit 11A, thereby outputting signal light Ls based on pixel data read out from the pixel portion 10A.

Also, the optical communication unit 12A includes an optical modulator as a second embodiment of the light output 120A, which externally modulates light that has externally been input and transmitted or reflected, based on the electric signal due to change in voltage or the like. With the optical communication unit 12A, external fixed light is input to the optical modulator, and also the electric signal converted into a digital signal at the A/D conversion unit 11A is input to the optical modulator. Thus, the optical communication unit 12A modulates light that has been input externally, based on the electric signal input from the A/D conversion unit 11A, thereby outputting signal light Ls based on the pixel data read out from the pixel portion 10A.

The solid-state imaging device 1A includes a timing generator (TG) 13A which generates a driving clock (CLK) according to a mode of operation, and supplies this to each functional block of the pixel portion 10A, A/D conversion unit 11, and optical communication unit 12A. Also, the solid-state imaging device 1A includes a control I/O 14A where input/output of a control signal or the like is executed, a DC-DC unit 15A which supplies power, and a control unit 16A which controls readout of pixel data. The control unit 16A, DC-DC unit 15A, and timing generator 13A are connected to a bus 17, where exchange of a control signal or data is executed.

The control unit 16A controls the DC-DC unit 15A to switch on/off of the power of the solid-state imaging device 1A. Also, the control unit 16A generates a driving clock at the timing generator 13A to supply this to the pixel portion 10A, A/D conversion unit 11A, and optical communication unit 12A, and operates the pixel portion 10A, A/D conversion unit 11A, and optical communication unit 12A in sync with the driving clock.

The pixel portion 10A, A/D conversion unit 11A, and optical communication unit 12A synchronize input/output of a signal using the driving clock supplied from the timing generator 13A. With the pixel portion 10A, pixel data according to the image of incident light is read out as an electric signal. With the A/D conversion unit 11A, the pixel data read out from the pixel portion 10A is input thereto, converted into a digital signal, and is output. With the optical communication unit 12A, the electric signal read out from the pixel portion 10A, and converted into a digital signal at the A/D conversion unit 11A is input thereto, converted into an optical signal based on the pixel data, and signal light Ls is output.

With the solid-state imaging device 1A, the pixel portion 10A, A/D conversion unit 11A, optical communication unit 12A, timing generator 13A, DC-DC unit 15A, and control unit 16A are formed integrally on a substrate 18 configured of silicon (Si). The solid-state imaging device 1A is configured as one chip by using semiconductor manufacturing processes to form such components integrally.

With the solid-state imaging device 1A, the pixel portion 10A is formed on one surface of the substrate 18. With the pixel portion 10A, light is input from one face side of the substrate 18. Also, with the solid-state imaging device 1A, the A/D conversion unit 11A, the DC-DC unit 15A, and control unit 16A where input/output of an electric signal and power is executed are formed on one face side of the substrate 18. Further, with the solid-sate imaging device 1A, the optical communication unit 12A is formed on one face of the substrate 18. Also, with the solid-sate imaging device 1A, power supply lines 140 and control lines 141 are formed on the rear surface of the substrate 18 as the control I/O 14A. Note that an arrangement may be made wherein the power supply lines 140 and control lines 141 are formed on the surface of the substrate 18.

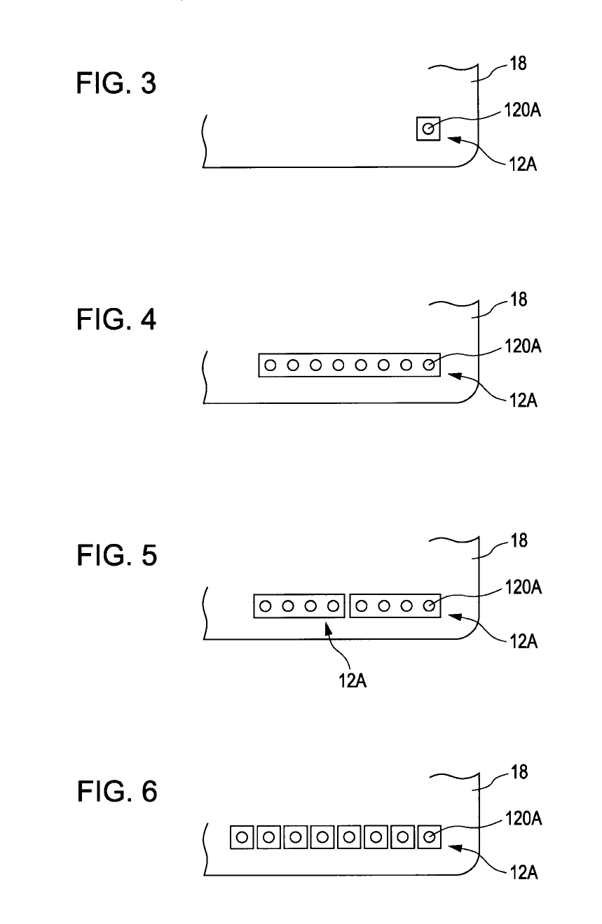

FIG. 3 is a schematic plan view illustrating a layout example of the optical communication unit which realizes a single transmission channel. Also, FIGS. 4 through 6 are schematic plan views illustrating a layout example of the optical communication unit which realizes multiple transmission channels.

The solid-state imaging device 1A includes, as shown in FIG. 3, the single optical communication unit 12A including the signal optical output unit 120A, thereby providing a configuration wherein signal transmission using light is executed by one channel. Also, the solid-state imaging device 1A includes, as shown in FIGS. 4 and 5, the single or multiple optical communication units 12A in which the multiple optical output units 120A are arrayed, thereby providing a configuration wherein signal transmission using light is executed by multiple channels. Further, as shown in FIG. 6, the multiple optical communication units 12A including the single optical output unit 120A are provided, thereby providing a configuration wherein signal transmission using light is executed by multiple channels.

With the solid-state imaging device 1A, signal transmission using light can be executed by one channel in the case of a configuration wherein, for example, a digital signal of n bits (n>1) to be output from the A/D conversion unit 11A is serial-transmitted as described later.

For example, a digital signal wherein a synchronizing signal and a clock signal are superposed on a data signal and serialized is generated, whereby signal transmission can be executed by one channel. Thus, the solid-state imaging device 1A includes, as shown in FIG. 3, the single optical communication unit 12A including the single optical output unit 120A, whereby serial transmission is realized.

Also, the solid-state imaging device 1A can execute signal transmission using light by multiple (two) channels in the case of a configuration wherein a serialized data signal and a clock signal are transmitted by independent channels.

The solid-state imaging device 1A includes the two optical communication units 12A including the single optical output unit 120A, whereby serial transmission in which a clock signal is transmitted independently is realized. Also, the solid-state imaging device 1A includes the single optical communication unit 12A in which the two optical output units 120A are arrayed, whereby serial transmission in which a clock signal is transmitted independently is realized similarly.

Further, the solid-state imaging device 1A can execute signal transmission using light by multiple channels in the case of a configuration wherein, for example, a digital signal of n bits to be output from the A/D conversion unit 11A is parallel-transmitted as described later.

The solid-state imaging device 1A includes the single optical communication unit 12A in which the optical output units 120A for the worth of the number of transmission channels are arrayed, whereby parallel transmission is realized. For example, in the case of a configuration wherein parallel transmission of an 8-bit digital signal is executed, the solid-state imaging device 1A should include, as shown in FIG. 4, the single optical communication unit 12A in which the eight optical output units 120A are arrayed.

Also, the solid-state imaging device 1A includes the multiple optical communication units 12A in which the multiple optical output units 120A are arrayed for the worth of the number of transmission channels, whereby parallel transmission is realized. For example, in the case of a configuration wherein parallel transmission of an 8-bit digital signal is executed, the solid-state imaging device 1A should include, as shown in FIG. 5, the two optical communication units 12A in which the four optical output units 120A are arrayed.

Alternatively, the solid-state imaging device 1A includes the optical communication units 12A including the single optical output unit 120A for the worth of the number of transmission channels, whereby parallel transmission is realized. For example, in the case of a configuration wherein parallel transmission of an 8-bit digital signal is executed, the solid-state imaging device 1A should include, as shown in FIG. 6, the eight optical communication units 12A including the single optical output unit 120A.

With the solid-state imaging device 1A shown in FIG. 1, for example, the optical communication unit 12A in which the multiple optical output units 120A are arrayed is disposed in one place of the substrate 18. Thus, the layout of the optical communication unit 12A where the multiple optical output units 120A are grouped in one place will be referred to as a grouped layout.

Also, as shown in FIG. 5, a mode is also a grouped layout wherein the multiple optical communication units 12A in which the multiple optical output units 120A are arrayed are disposed grouped in one place of the substrate 18. Similarly, as shown in FIG. 6, a mode is also a grouped layout wherein the multiple optical communication units 12A including the single optical output unit 120A are disposed grouped in one place of the substrate 18. Note that, as shown in FIG. 4, a mode is also included in a grouped layout wherein the single optical communication unit 12A including the eight optical output units 120A is disposed in one place of the substrate 18.

With the solid-state imaging device 1A, in the case of a configuration wherein the multiple optical communication units 12A are connected to the subsequent stage of the single A/D conversion unit 11A, the A/D conversion unit 11A and each of the optical communication units 12A are connected by a signal wiring 180. With the solid-state imaging device 1A where the optical communication units 12A are disposed grouped, an arrangement is made wherein the wiring length of the signal wiring 180 between the A/D conversion unit 11A and each of the optical communication units 12A is reduced as a layout such that all the optical communication units 12A come close to the subsequent stage of the single A/D conversion unit 11A.

### (1-2) Examples of Advantages of Solid-State Imaging Device in which Optical Communication Units are Disposed Grouped

With the solid-state imaging device 1A where the optical communication units 12A are disposed grouped, the optical communication units 12A serving as heat sources can be grouped in one place. Thus, heat generated at the optical communication units 12A can be cooled locally. For example, a cooling unit 200 is included in the optical communication unit 12A, whereby heat generated at the optical communication unit 12A can be radiated externally without reaching the pixel portion 10A. Note that the details of the cooling unit at a grouped layout will be described later.

Also, the optical communication units 12A are grouped in one place of the substrate 18, and accordingly, the optical communication units 12A are provided at the subsequent stage of the A/D conversion unit 11A, whereby all the optical communication units 12A can come close to the A/D conversion unit 11A. Thus, the digital signal after A/D conversion does not have to be drawn around over long length by an electric signal, and accordingly, electric wiring can be reduced. Therefore, occurrence of electromagnetic noise, and signal deterioration due to transmission of an electric signal can be suppressed.

Alternatively, a manufacturing process may be assumed wherein the optical communication unit 12A including the optical output units 120A for the worth of the number of transmission channels is manufactured separately, and is then assembled, whereby both of high integration and improvement in manufacturing easiness can be realized.

### (2-1) Configuration Example of Solid-State Imaging Device in which Optical Communication Units are Disposed Discretely

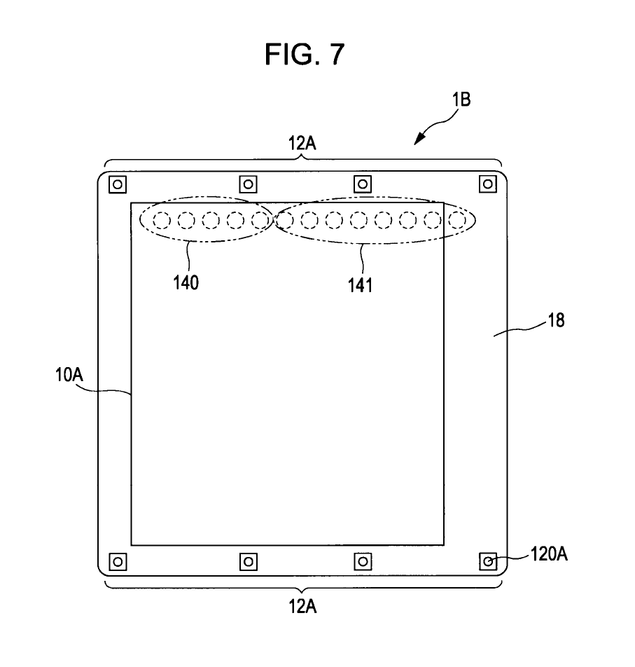

FIG. 7 is a schematic plan view illustrating an example of a solid-state imaging device in which optical communication units are disposed discretely. With the solid-state imaging device 1B shown in FIG. 7, the multiple optical communication units 12A including the signal optical output unit 120A are disposed discretely in multiple places of the substrate 18. Thus, the layout of the optical communication units 12A where the single optical output unit 120A is disposed discretely in multiple places will be referred to as a discrete layout.

With the solid-state imaging device 1B where the optical communication units 12A are disposed discretely, the position of each optical communication unit 12A is determined such that the distance between the optical communication units 12A becomes as long as possible. In general, solid-state imaging devices have a square shape, and accordingly, the optical communication units 12A are disposed in the vicinity portion of the substrate 18, e.g., the facing two sides.

Note that, with the solid-state imaging device 1B where the optical communication units 12A are disposed discretely, an arrangement is made wherein a digital signal is parallel-transmitted by synchronizing the multiple optical communication units 12A.

### (2-2) Examples of Advantages of Solid-State Imaging Device in which Optical Communication Units are Disposed Discretely

With the solid-state imaging device 1B where the optical communication units 12A are disposed discretely, each of the optical communication units 12A has charge of signal transmission for the one bit worth of parallel transmission. Therefore, the transmission amount of signals to be output from each of the optical communication units 12A can be reduced. Thus, heat generated at each of the optical communication units 12A becomes small as compared to an optical communication unit wherein the optical output units are arrayed within the single optical communication unit 12A.

Such optical communication units 12A are disposed discretely on the substrate 18, whereby heat generated at the optical communication units 12A can be distributed to the whole of the solid-state imaging device 1B. Thus, influence that heat generated at each of the optical communication units 12A provides to the pixel portion 10A can be reduced extremely. Also, the heat divergence at the optical communication units 12A, and influence provided to the pixel portion can be reduced, the cooling unit used for cooling the optical communication unit 12A does not have to be used.

### (3-1) Configuration Example of Solid-State Imaging Device in which Optical Communication Units are Disposed Discretely Grouped

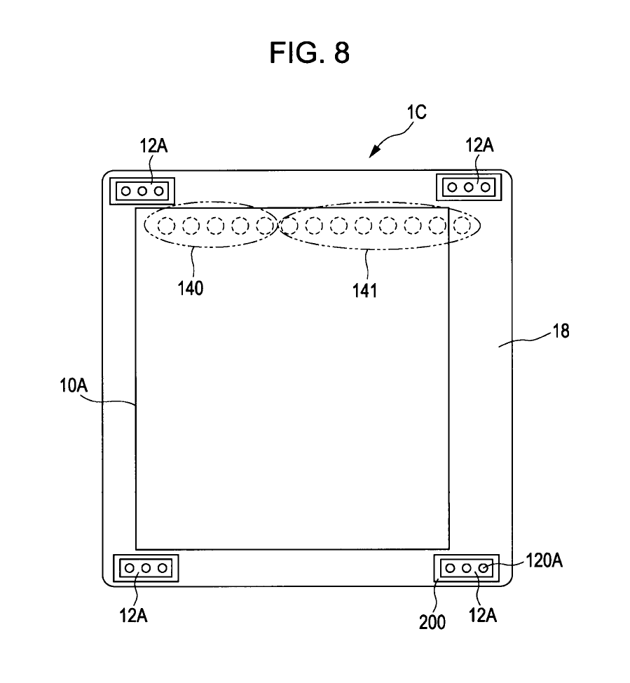

FIG. 8 is a schematic plan view illustrating an example of a solid-state imaging device in which the optical communication units are disposed discretely grouped. With the solid-state imaging device 1C shown in FIG. 8, the multiple optical communication units 12A including the multiple optical output units 120A are disposed discretely in multiple places of the substrate 18. Thus, the layout of the optical communication units 12A where the multiple optical output units 120A are disposed discretely in multiple places will be referred to as a discrete grouped layout.

Also, as shown in FIG. 5, a mode is also a discrete grouped layout wherein the multiple optical communication units 12A in which the multiple optical output units 120A are arrayed are disposed discretely in multiple places of the substrate 18. Similarly, as shown in FIG. 6, a mode is also a discrete grouped layout wherein the multiple optical communication units 12A including the single optical output unit 120A are disposed discretely in multiple places of the substrate 18.

### (3-2) Examples of Advantages of Solid-State Imaging Device in which Optical Communication Units are Disposed Discretely Grouped

With the solid-state imaging device 1C where the optical communication units 12A are disposed discretely grouped, both of manufacturing easiness and wiring easiness depending on that the multiple optical communication units are disposed grouped, and heat homogeneity ensuring depending on that the multiple optical communication units are disposed discretely can be realized.

With the present example, the solid-state imaging device has a configuration wherein, in order to execute readout of a signal for each of increments divided according to the property of each pixel making up the pixel portion 10A, and the position of each pixel, or the like, readout of a signal using multi-line is executed.

With such a solid-state imaging device, a signal is read out at multiple signal lines from the pixel portion 10A, and each of the signal lines from which a signal is read out is connected to the A/D conversion unit 11A. Therefore, in the event of employing a grouped layout wherein all the optical communication units 12A are grouped in one place of the substrate 18, signal wiring of an electric signal has to be formed over long distance from each of the A/D conversion units 11A to the optical communication unit 12A in one place.

Therefore, the multiple optical communication units 12A in which the multiple optical output units 120A are arrayed, or the multiple optical communication units 12A including the single optical output unit 120A are disposed discretely in multiple places of the substrate 18. Subsequently, each of the optical communication units 12A is disposed close to the subsequent stage of each of the A/D conversion units 11A. Thus, the digital signal after A/D conversion does not have to be drawn around over long distance by an electric signal, and accordingly, electric wiring can be reduced. Therefore, occurrence of electromagnetic noise, and signal deterioration due to transmission of an electric signal can be suppressed.

Also, the multiple optical communication units 12A are disposed discretely in multiple places of the substrate 18, whereby heat generated at each of the optical communication units 12A can be distributed to the whole of the solid-state imaging device 1C. Also, the cooling unit 200 is provided as to the multiple optical communication units 12A disposed discretely at each place, cooling can be executed for each place where the optical communication units 12A are disposed discretely. Note that the details of the cooling unit with a discrete grouped layout will be described later.

### Configuration Example of Optical Communication Unit of Solid-State Imaging Device

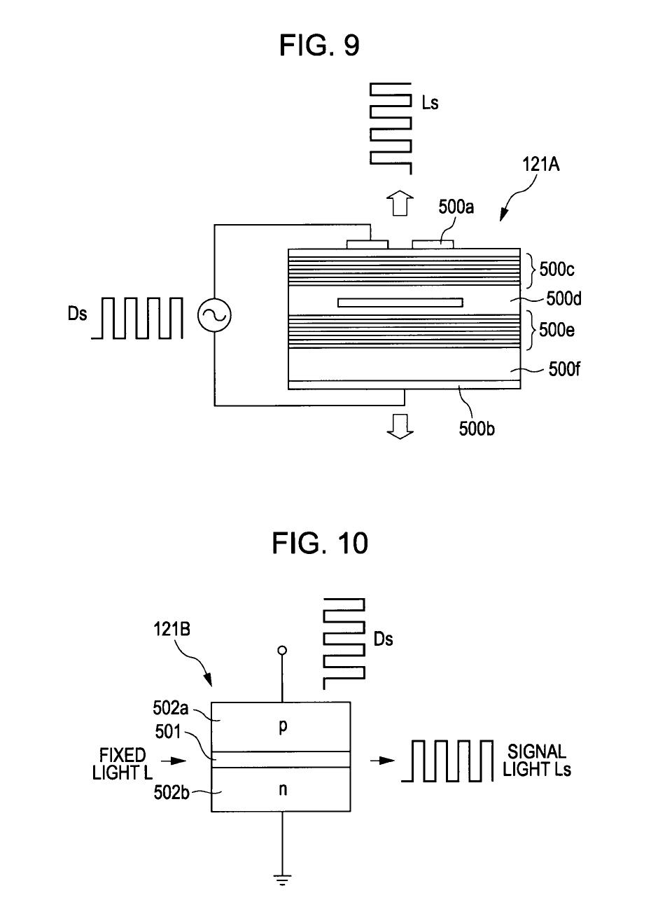

FIG. 9 is a configuration diagram illustrating an example of the optical communication unit of the solid-state imaging device. The optical communication units 12A of the solid-state imaging devices 1A through 1C (hereinafter, also referred to as “solid-state imaging device 1”) according to the embodiments include a self-emitting light emitting element as the optical output unit 120A. For example, a surface-emitting semiconductor laser (VCSEL: Vertical Cavity Surface Emitting Laser) 121A is employed as the self-emitting light emitting element, which emits light in the vertical direction as to the surface of the substrate.

With the surface-emitting semiconductor laser 121A, an upward black reflecting mirror (DBR mirror) 500c, an active layer 500d, a downward black reflecting mirror (DBR mirror) 500e, and an n-type semiconductor substrate 500f are layered between a p-type electrode 500a and an n-type electrode 500b. With the surface-emitting semiconductor laser 121A, the upward black reflecting mirror 500c and the downward black reflecting mirror 500e which are made up of a dielectric multilayer are formed above and below the active layer 500d, whereby a resonator is configured between the mirrors.

Next, the principle of operation of the surface-emitting semiconductor laser 121A will be described.

(1) Voltage is applied to the p-type electrode 500a and the n-type electrode 500b, and current is externally sent, thereby causing an inverted distribution state at an energy level of the active layer 500d.
(2) A photon having energy corresponding to an energy gap is spontaneously emitted at the active layer 500d, and the photon thereof causes induced emission, thereby amplifying the light.
(3) The light is reflected at the mirrors above and below the active layer 500d, and a portion thereof is guided to the inside of the active layer 500d again, and is amplified by induced emission.
(4) A portion of the amplified light is passed through the edge face at the p-type electrode 500a side and emitted externally.

Thus, 1 and 0 of the digital signal to be output from the A/D conversion unit 11A are correlated with on and off of voltage, which represents on and off of light, and accordingly, modulation is realized. Note that an edge-emitting semiconductor laser may be employed as the self-emitting light emitting element.

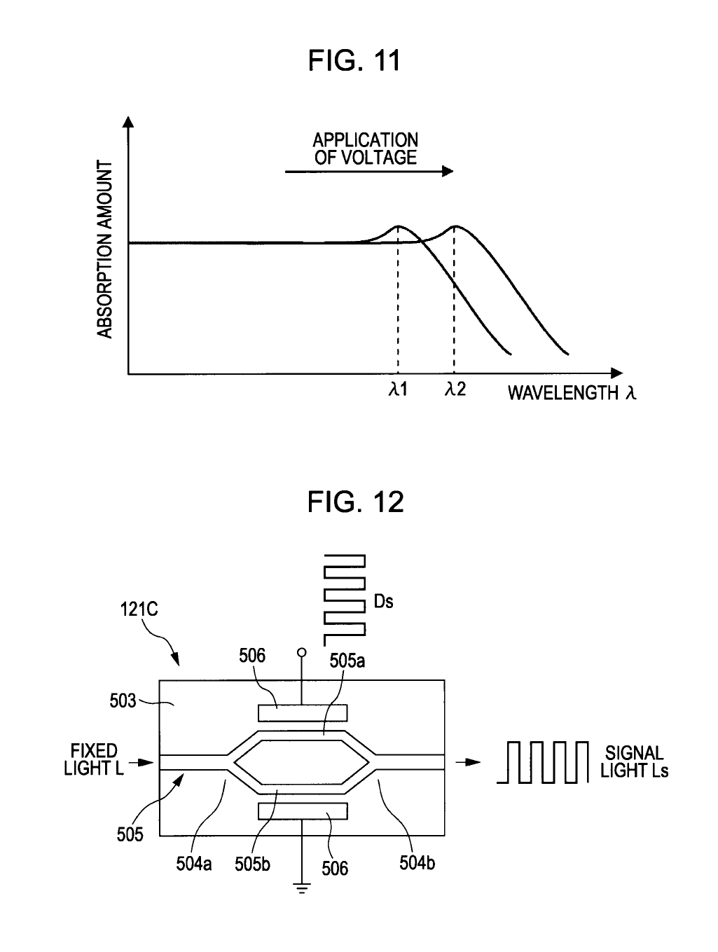

FIG. 10 is a configuration diagram illustrating another example of the optical communication unit of the solid-state imaging device, and FIG. 11 is a graph illustrating relationship between applied voltage and the absorption amount of light. The optical communication unit 12A of the solid-state imaging device 1 includes an external-modulating optical modulator as the optical output unit 120A. The optical communication unit 12A includes an electroabsorption optical modulator 121B as an external-modulating optical modulator. The electroabsorption optical modulator 121B takes advantage of a phenomenon wherein upon an electric field being applied to the fine structure of a semiconductor called as a quantum well, the band structure of the semiconductor is changed, and the absorption amount of light is changed.

The electroabsorption optical modulator 121B has a configuration wherein a waveguide layer 501 having a multiquantum well structure is sandwiched with a P layer 502a and an N layer 502b. With regard to the optical absorption amount of the waveguide layer 501 at the electroabsorption optical modulator 121B, the absorption band is shifted such as shown in FIG. 11 by bias voltage. Thus, for example, in the case that light having a wavelength of λ2 is input to the waveguide layer 501, the light is absorbed at the time of voltage being applied, and the light is transmitted at the time of no voltage being applied, and accordingly, the intensity of the light input to the waveguide layer 501 is modulated by loss being changed according to the applied voltage.

With the solid-state imaging device 1A, the voltage corresponding to the electric signal output from the A/D conversion unit 11A is applied to the electroabsorption optical modulator 121B, whereby modulation of the light is realized. Therefore, the optical communication unit 12A of the solid-state imaging device 1A is configured such that the voltage due to an electric signal converted into a digital signal at the A/D conversion unit 11A and output is applied to the P layer 502a and the N layer 502b of the electroabsorption optical modulator 121B.

Thus, with the optical communication unit 12A of the solid-state imaging device 1A, fixed light externally input is modulated based on an electric signal Ds read out from the pixel portion 10A and digitized, and is output as signal light Ls.

FIG. 12 is a configuration diagram illustrating another example of the optical communication unit of the solid-state imaging device. The optical communication unit 12A of the solid-state imaging device 1A includes a Mach-Zehnder-type optical modulator 121C as another example of the external-modulating optical modulator. The Mach-Zehnder-type optical modulator 121C takes advantage of an electro-optical effect (Pockels effect) wherein the refractive index is changed by voltage being applied. With an optical modulator using an electro-optical effect, the phase of light can be modulated by applied voltage.

The Mach-Zehnder-type optical modulator 121C takes advantage of optical phase difference caused due to an electro-optical effect to generate optical path length difference with two waveguides making up a Mach-Zehnder interferometer, thereby interfering in light to realize on and off of the light.

The Mach-Zehnder-type optical modulator 121C includes a substrate 503 of a ferroelectric crystal such as lithium niobate (LiNbO₃) or the like, and an optical waveguide 505 to be branched/coupled into/from a first waveguide 505a and a second waveguide 505b by a branching portion 504a and a coupling portion 504b. Also, the Mach-Zehnder-type optical modulator 121C includes an electrode 506 to which voltage is applied. Note that the Mach-Zehnder-type optical modulator 121C may be configured of a semiconductor material such as GaAs (gallium arsenide), InP (indium phosphorus), or the like. The Mach-Zehnder-type optical modulator 121C made up of a semiconductor material is created above the InP substrate by a semiconductor process, and reduction in size can be realized as compared to the Mach-Zehnder-type optical modulator made up of LiNbO₃.

With the Mach-Zehnder-type optical modulator 121C, upon voltage V1 being applied such that the phase of light that passes through the first waveguide 505a and the second waveguide 505b is shifted by π, the light branched at the branching portion 504a is multiplexed at the coupling portion 504b by the phase thereof being shifted by π. The light multiplexed by the phase thereof being shifted by π is canceled out mutually by interference, and the output thereof becomes zero.

On the other hand, upon voltage V0 being applied such that the phase of light that passes through the first waveguide 505a and the second waveguide 505b is not shifted, the light branched at the branching portion 504a is multiplexed with the same phase at the coupling portion 504b. The light multiplexed with the same phase is intensified by interference, and the output thereof becomes 1.

Thus, with the Mach-Zehnder-type optical modulator 121C, on/off control of light is realized by applying voltage such that the phase of the light is shifted by π.

With the solid-state imaging device 1A, modulation of light is realized by applying the voltage corresponding to the electric signal output from the A/D conversion unit 11A to the Mach-Zehnder-type optical modulator 121C. Therefore, the optical communication unit 12A of the solid-state imaging device 1A is configured such that voltage due to the electric signal converted into a digital signal at the A/D conversion unit 11A and output is applied to the electrode 506 of the Mach-Zehnder-type optical modulator 121C.

Thus, with the optical communication unit 12A of the solid-state imaging device 1A, fixed light L input externally is modulated based on an electric signal Ds read out from the pixel portion 10A and digitized, and is output as signal light Ls.

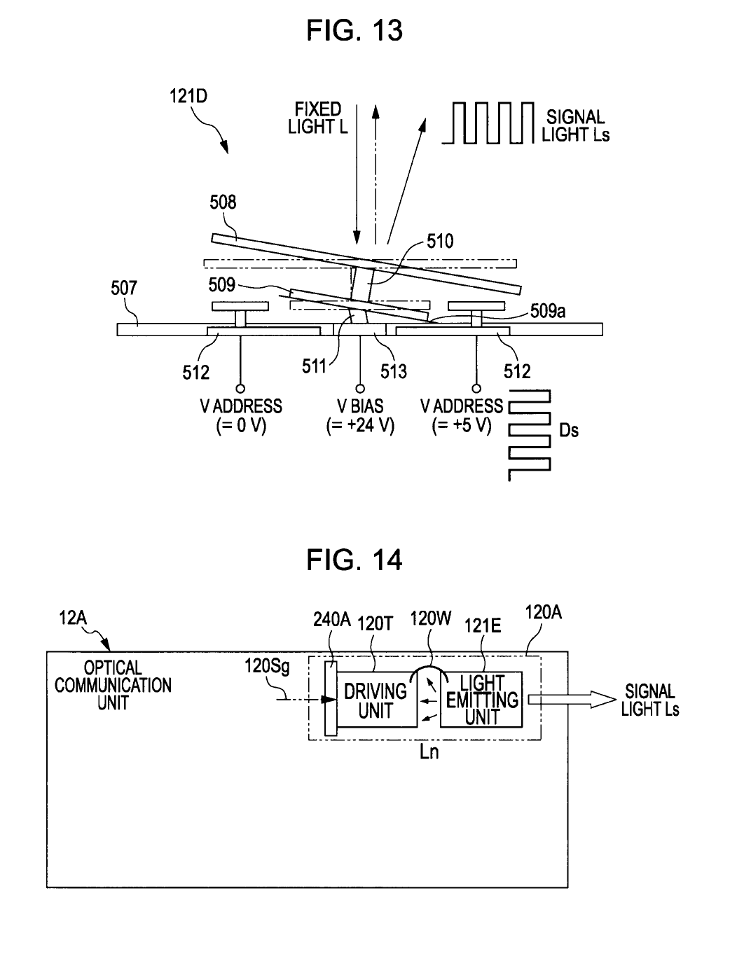

FIG. 13 is a configuration diagram illustrating another example of the optical communication unit of the solid-state imaging device. The optical communication unit 12A of the solid-state imaging device 1A includes a mirror unit 121D as an optical modulating unit. The mirror unit 121D is a micromirror device (DMD; Digital Micromirror Device) formed using the MEMS (Micro Electro Mechanical Systems).

The mirror unit 121D includes a reflecting mirror 508, a yoke 509 to be attached to the reflecting mirror 508, and a mirror support host 510 which fixes the reflecting mirror 508 to the yoke 509, on a substrate 507 formed of silicon (Si), for example. The reflecting mirror 508 and the yoke 509 are supported by the substrate 507 using a hinge 511. An impingement plate 509a is formed on the tip of the yoke 509. The hinge 511 has elasticity to be deformed or restored. An address electrode 512 is formed on the substrate 507. The address electrode 512 faces the yoke 509 and the reflecting mirror 508. The yoke 509 and the reflecting mirror 508 are mechanically or electrically connected to a bias reset bus 513.

When the mirror unit 121D applies bias voltage and voltage to the address electrode 512, electrostatic attraction affects between the reflecting mirror 508 and the address electrode 512, and between the yoke 509 and the address electrode 512, thereby generating electrostatic torque. Thus, the reflecting mirror 508 and the yoke 509 rotate until the impingement plate 509a lands and stops, thereby inclining the reflecting mirror 508. In the case that bias voltage is not applied, the reflecting mirror 508 and the yoke 509 are stabilized in horizontal positions according to the restoring force of the hinge 511.

Thus, with the mirror unit 121D, the direction where light input to the reflecting mirror 508 is reflected is changed depending on whether or not voltage is applied, on the optical reception side the optical reception amount is changed according to the angle of the reflecting mirror 508, whereby on/off control of light is realized.

With the solid-state imaging device 1A, the voltage corresponding to the electric signal output from the A/D conversion unit 11A is applied to the mirror unit 121D, thereby realizing modulation of light. Therefore, the optical communication unit 12A of the solid-state imaging device 1A is configured such that the voltage due to the electric signal converted into a digital signal at the A/D conversion unit 11A and output is applied to the mirror unit 121D.

Thus, with the optical communication unit 12A of the solid-state imaging device 1A, fixed light L input externally is modulated based on an electric signal Ds read out from the pixel portion 10A and digitized, and is output as signal light Ls.

### Internal Layout Example of Components Making Up Optical Communication Unit of Solid-State Imaging Device According to Each Embodiment

With the solid-state imaging device according to each embodiment, the optical communication unit includes as an optical output unit a self-emitting light emitting element or external-modulating optical modulator, and a driving unit of the light emitting element or optical modulator, and so forth. Next, a preferred layout example of the light emitting element or optical modulator, and the driving unit will be described.

### (1) Layout Example Including Single Self-Emitting Optical Output Unit

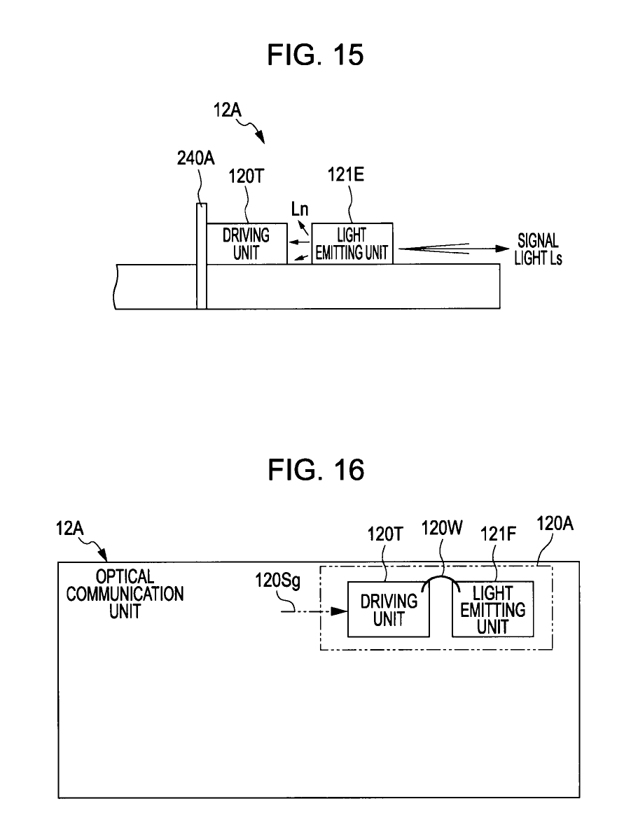

FIGS. 14 and 15 illustrate a first layout example of components making up an optical communication unit, wherein FIG. 14 is a schematic plan view illustrating the first layout example of the components making up the optical communication unit, and FIG. 15 is a schematic side view illustrating the first layout example of the components making up the optical communication unit.

With the example shown in FIGS. 14 and 15, the optical communication unit 12A of the solid-state imaging device 1 has a configuration including a single self-emitting light emitting element, and has a configuration including a light emitting unit 121E made up of an edge-emitting semiconductor laser as an optical output unit 120A.

With the light emitting unit 121E, one side edge face is a light emitting face, where the signal light Ls is output in the direction indicated with an arrow. Note that with the light emitting unit 121E, leakage light Ln of certain quantity is output in the direction indicated with arrows from the side edge face of the opposite side of the light emitting face.

The optical output unit 120A includes a driving unit 120T which drives the light emitting unit 121E. The driving unit 120T is disposed aside of the light emitting unit 121E on the side facing the side edge face where the leakage light Ln is output, in series with the output direction of the signal light Ls of the light emitting unit 121E. The electric signal converted into a digital signal is supplied to the driving unit 120T from the opposite side of the light emitting unit 121E in series with the driving unit 120T by way of a driving signal line 120S, for example, in the direction indicated with an arrow. Note that, with the optical output unit 120A, in the case of a configuration wherein the light emitting unit 121E and the driving unit 120T are formed as independent components, between the driving unit 120T and the light emitting unit 121E is connected with a bonding wire 120W, where the electric signal is supplied. Also, with the optical output unit 120A, in the case of a configuration wherein the light emitting unit 121E and the driving unit 120T are integrated, between the driving unit 120T and the light emitting unit 121E is connected with a wiring layer made up of aluminum, tungsten, or the like within a semiconductor, where the electric signal is supplied.

The optical communication unit 12A includes a light shielding portion 240A which shields the leakage light Ln output from the light emitting unit 121E. The light shielding portion 240A is configured of a material which does not transmit at least light having an oscillation wavelength at the light emitting unit 121E, and is disposed facing the side edge face where the leakage light Ln is output, as to the light emitting unit 121E.

With the present example, the driving unit 120T is disposed in series with the light emitting unit 121E, and accordingly, the light shielding portion 240A is disposed on the opposite side of the light emitting unit 121E as to the driving unit 120T disposed in series with the light emitting unit 121E. Thus, the leakage light Ln output from the light emitting unit 121E can be shielded by the light shielding portion 240A.

With the example shown in FIGS. 14 and 15, the driving unit 120T is disposed in series with the direction where light is output at the light emitting unit 121E. Thus, in the case that the optical output units 120A are arrayed, the light emitting unit 121E is disposed in parallel with the direction where the light emitting unit 121E and the driving unit 120T are disposed in series, and accordingly, no driving unit 120T is disposed between the adjacent light emitting units 121E, and reduction in size can be realized.

### (2) Another Layout Example Including Single Self-Emitting Optical Output Unit

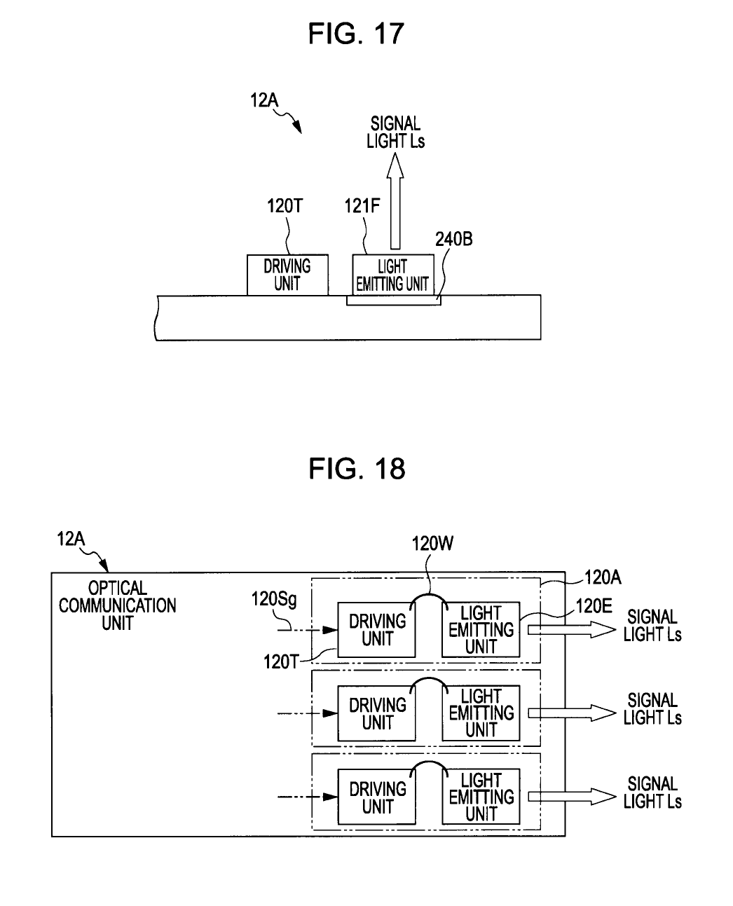

FIGS. 16 and 17 illustrate a second layout example of components making up an optical communication unit, wherein FIG. 16 is a schematic plan view illustrating the second layout example of the components making up the optical communication unit, and FIG. 17 is a schematic side view illustrating the second layout example of the components making up the optical communication unit.

With the example shown in FIGS. 16 and 17, the optical communication unit 12A of the solid-state imaging device 1 has a configuration including a single self-emitting light emitting element, and has a configuration including a light emitting unit 121F made up of a surface-emitting semiconductor laser (VCSEL) such as shown in FIG. 9 as an optical output unit 120A.

With the light emitting unit 121F, the upper face is a light emitting face, where the signal light Ls is output in the direction indicated with an arrow. Note that with the light emitting unit 121F, leakage light Ln of certain quantity is output from the lower face of the opposite side of the light emitting face.

The optical output unit 120A includes a driving unit 120T which drives the light emitting unit 121F. The electric signal converted into a digital signal is supplied to the driving unit 120T from the opposite side of the light emitting unit 121F in series with the driving unit 120T by way of a driving signal line 120Sg, for example, in the direction indicated with an arrow. Note that, with the optical output unit 120A, in the case of a configuration wherein the light emitting unit 121F and the driving unit 120T are formed as independent components, between the driving unit 120T and the light emitting unit 121F is connected with a bonding wire 120W, where the electric signal is supplied. Also, with the optical output unit 120A, in the case of a configuration wherein the light emitting unit 121F and the driving unit 120T are integrated, between the driving unit 120T and the light emitting unit 121F is connected with a wiring layer made up of aluminum, tungsten, or the like within a semiconductor, where the electric signal is supplied.

The optical communication unit 12A includes a light shielding portion 240B which shields the leakage light Ln output from the light emitting unit 121F. The light shielding portion 240B is configured of a material which does not transmit at least light having an oscillation wavelength at the light emitting unit 121F, and is disposed in the lower face where the leakage light is output, as to the light emitting unit 121F. Thus, the leakage light output from the light emitting unit 121F can be shielded by the light shielding portion 240B.

With the example shown in FIGS. 16 and 17 as well, the driving unit 120T is disposed in series with the light emitting unit 121F. Thus, in the case that the optical output units 120A are arrayed, the light emitting unit 121F is disposed in parallel with the direction where the light emitting unit 121F and the driving unit 120T are disposed in series, and accordingly, no driving unit 120T is disposed between the adjacent light emitting units 121F, and reduction in size can be realized.

(3) Layout Example in which Self-Emitting Optical Output Units are Arrayed

FIG. 18 is a schematic plan view illustrating a third layout example of components making up an optical communication unit. The example shown in FIG. 18 has a configuration wherein a light emitting unit 121E configured of an edge-emitting semiconductor laser is included as a light emitting element, and optical output units 120A including the light emitting unit 121E and the driving unit 120T are arrayed.

As described above, the driving unit 120T is disposed in series with the direction where light is output at the light emitting unit 121E. In the case that the optical output units 120A are arrayed, the light emitting unit 121E is disposed in parallel with the direction where the light emitting unit 121E and the driving unit 120T are disposed in series.

Thus, the multiple light emitting units 121E and the driving units 120T are adjacently integrated respectively, and no driving unit 120T is disposed between the adjacent light emitting units 121E, whereby reduction in size of the optical communication unit 12A can be realized. Note that, with the configuration in FIG. 18, the same advantage is obtained even in the event that the edge-emitting semiconductor laser is replaced with a surface-emitting semiconductor laser.

With the configuration in FIG. 18, the optical communication unit 12A is configured such that a plurality of signal light Ls are output in parallel. The pitch of the signal light Ls can be determined without being restricted to the positions of the driving units 120T, and accordingly, flexibility in arrayed light pitch increases.

### (4) Layout Example Including Single External-Modulating Optical Output Unit

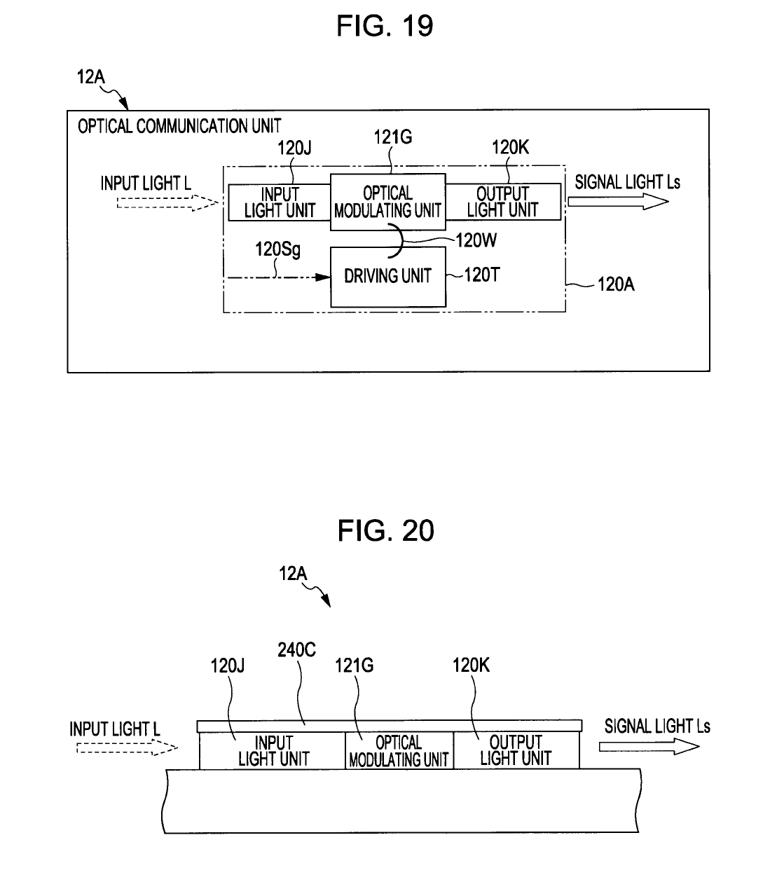

FIG. 19 is a schematic plan view illustrating a fourth layout example of components making up an optical communication unit. With the example shown in FIG. 19, the optical communication unit 12A of the solid-state imaging device 1 has a configuration including a single external-modulating optical modulating unit 121G as an optical output unit 120A, and the optical modulating unit 121G is configured of an electroabsorption optical modulator 121B described in FIG. 10, or a Mach-Zehnder-type optical modulator 121C described in FIG. 12.

With the optical output unit 120A, one edge face side of the optical modulating unit 121G becomes the input edge of light, and the other edge portion of the opposite side becomes the output edge of light, and an input light unit 120J configured of an optical waveguide or the like is connected to the input edge. Also, an output light unit 120K configured of an optical waveguide or the like is connected to the output edge.

With the optical modulating unit 121G, external fixed light L is input to the input light unit 120J from the direction indicated with an arrow. Also, modulated signal light Ls is output to the opposite side of the input light L, i.e., the direction indicated with an arrow from the output light unit 120K.

The optical communication unit 12A includes a driving unit 120T which drives the optical modulating unit 121G. The driving unit 120T is disposed aside of the optical modulating unit 121G, at a position orthogonal to the light L to be input to the optical modulating unit 121G, and the signal light Ls to be output therefrom. Thus, a configuration is realized wherein the light L to be input to the optical modulating unit 121G, and the signal light Ls to be output therefrom are not interrupted by the driving unit 120T. The electric signal converted into a digital signal is supplied to the driving unit 120T by way of a driving signal line 120Sg, for example, in the direction indicated with an arrow. Note that, with the optical output unit 120A, in the case of a configuration wherein the optical modulating unit 121G and the driving unit 120T are formed as independent components, between the driving unit 120T and the optical modulating unit 121G is connected with a bonding wire 120W, where the electric signal is supplied. Also, with the optical output unit 120A, in the case of a configuration wherein the optical modulating unit 121G and the driving unit 120T are integrated, between the driving unit 120T and the optical modulating unit 121G is connected with a wiring layer made up of aluminum, tungsten, or the like within a semiconductor, where the electric signal is supplied.

### (5) Another Layout Example Including Single External-Modulating Optical Output Unit

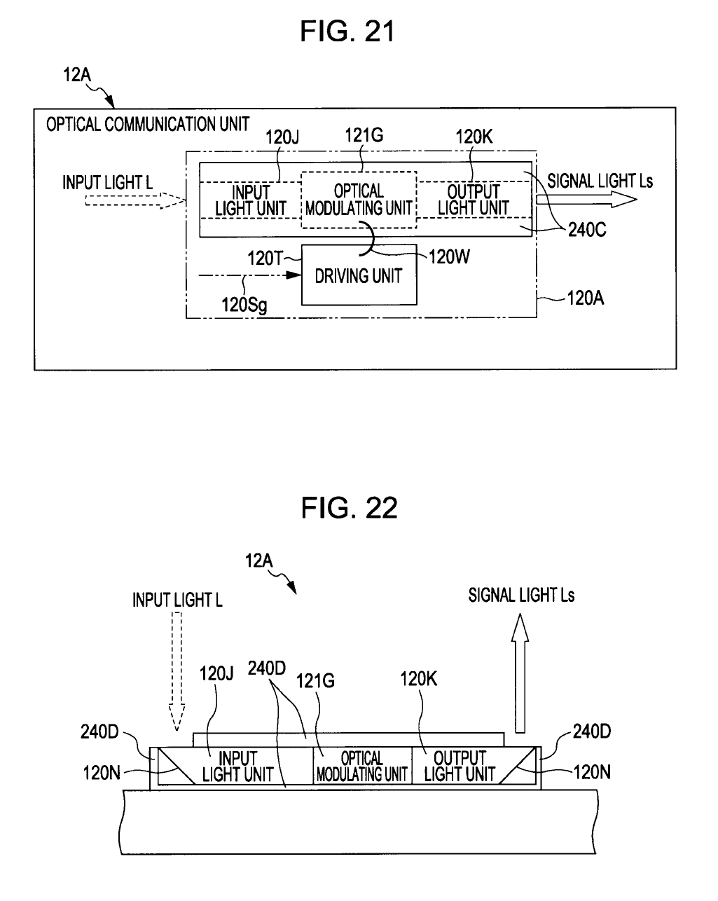

FIGS. 20 and 21 illustrate a fifth layout example of components making up an optical communication unit, wherein FIG. 20 is a schematic side view illustrating the fifth layout example of the components making up the optical communication unit, and FIG. 21 is a schematic plan view illustrating the fifth layout example of the components making up the optical communication unit.

With the example shown in FIGS. 20 and 21, the optical communication unit 12A of the solid-state imaging device 1 has, as described above, a configuration including a single external-modulating optical modulating unit 121G, and includes an input light unit 120J, an output light unit 120K, and a light shielding portion 240C, which are connected to the optical modulating unit 121G.

With the optical modulating unit 121G, external light L is input to the input light unit 120J from the horizontal direction. Also, the modulated signal light Ls is output in the horizontal direction from the output light unit 120K. The light shielding portion 240C is configured so as to cover the whole of the side faces and the upper faces of the input light unit 120J and the output light unit 120K except for the edge faces where an input portion of light from the outside of the input light unit 120J, and an output portion of light to the outside of the output light unit 120K are formed.

Note that the whole of the lower faces of the input light unit 120J and the output light unit 120K may also be covered so as to prevent leakage of light to the substrate making up the optical communication unit 12A. Further, in order to prevent leakage of light from connection portions with the input light unit 120J, output light unit 120K, and optical modulating unit 121G, the input light unit 120J and output light unit 120K including the optical modulating unit 121G may be covered with the light shielding portion 240C.

Thus, the light L to be input to the input light unit 120J and wave-guided to the optical modulating unit 121G can be prevented from leaking from the input light unit 120J. Also, the signal light Ls to be output from the optical modulating unit 121G and wave-guided to the output light unit 120K can be prevented from leaking from other than the output portion of the output light unit 120K.

### (6) Another Layout Example Including Single External-Modulating Optical Output Unit

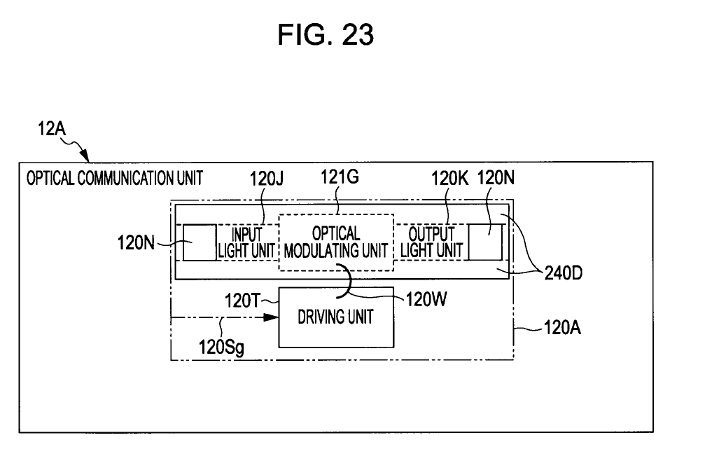

FIGS. 22 and 23 illustrate a sixth layout example of components making up an optical communication unit, wherein FIG. 22 is a schematic side view illustrating the sixth layout example of the components making up the optical communication unit, and FIG. 23 is a schematic plan view illustrating the sixth layout example of the components making up the optical communication unit.

With the example shown in FIGS. 22 and 23, the optical communication unit 12A of the solid-state imaging device 1 has, as described above, a configuration including a single external-modulating optical modulating unit 121G, and includes an input light unit 120J, an output light unit 120K, and a light shielding portion 240D, which are connected to the optical modulating unit 121G.

With the input light unit 120J, a reflecting face 120N of 45 degrees is formed in the input portion of external light, and the light L from the outside is input to the input light unit 120J from the vertical direction. With the output light unit 120K as well, a reflecting face 120N of 45 degrees is formed in the input portion of external light, and the modulated signal light Ls is output from the output light unit 120K to the vertical direction.

The light shielding portion 240D is configured so as to cover the whole of the edge faces, side faces, and lower faces of the input light unit 120J and the output light unit 120K, and the portion of the upper face except for the portion of the upper face where the input light unit 120J for input of external light and the output portion of light to the outside from the output light unit 120K are formed.

Note that, in order to prevent leakage of light from the connected portions between the input light unit 120J and the output light unit 120K, and the optical modulating unit 121G, the input light unit 120J and the output light unit 120K including the optical modulating unit 121G may be covered with the light shielding portion 240D.

Thus, the light L to be input to the input light unit 120J and wave-guided to the optical modulating unit 121G can be prevented from leaking from the input light unit 120J due to reflection or the like. Also, the signal light Ls to be output from the optical modulating unit 121G and wave-guided to the output light unit 120K can be prevented from leaking from other than the output portion of the output light unit 120K due to reflection or the like.

(7) Layout Example in which External-Modulating Optical Output Unit are Arrayed

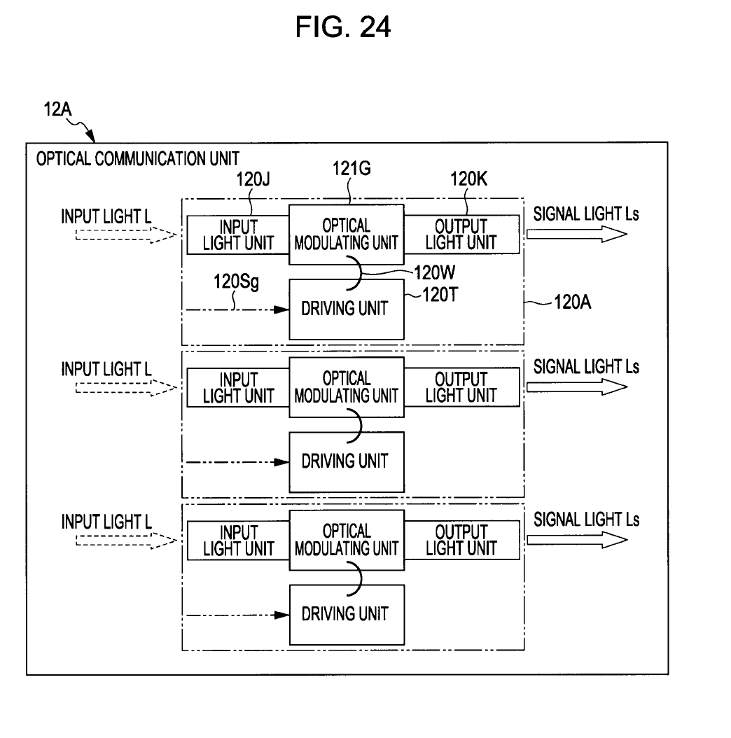

FIG. 24 is a schematic plan view illustrating a seventh layout example of components making up an optical communication unit. With the example shown in FIG. 24, the optical communication unit 12A of the solid-state imaging device 1 includes an external-modulating optical modulating unit 121G as described above, and has a configuration wherein optical output units 120A including the optical modulating unit 121G, and the driving unit 120T are arrayed.

With the optical modulating unit 121G, as described above, the input light unit 120J is connected to one of facing edge faces, and the output light unit 120K is connected to the other thereof, and accordingly, the driving unit 120T is disposed to the side portion of the optical modulating unit 121G. In the case that the optical output units 120A are arrayed, a layout is employed wherein the optical modulating units 121G are arrayed in parallel in the direction orthogonal to the light L input to the optical modulating unit 121G and the signal light Ls output from the optical modulating unit 121G, and the optical modulating units 121G and the driving units 120T are disposed alternately.

### (8) Another Layout Example Including Single External-Modulating Optical Output Unit

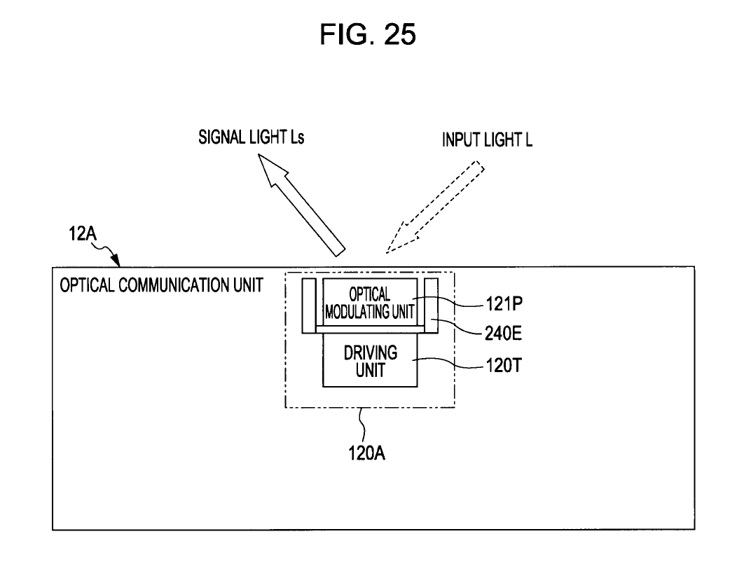

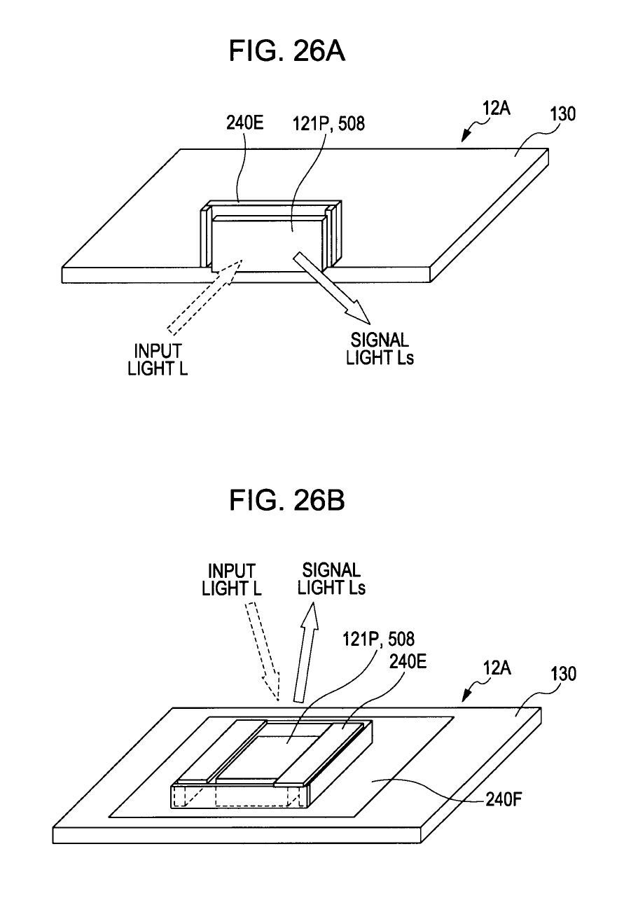

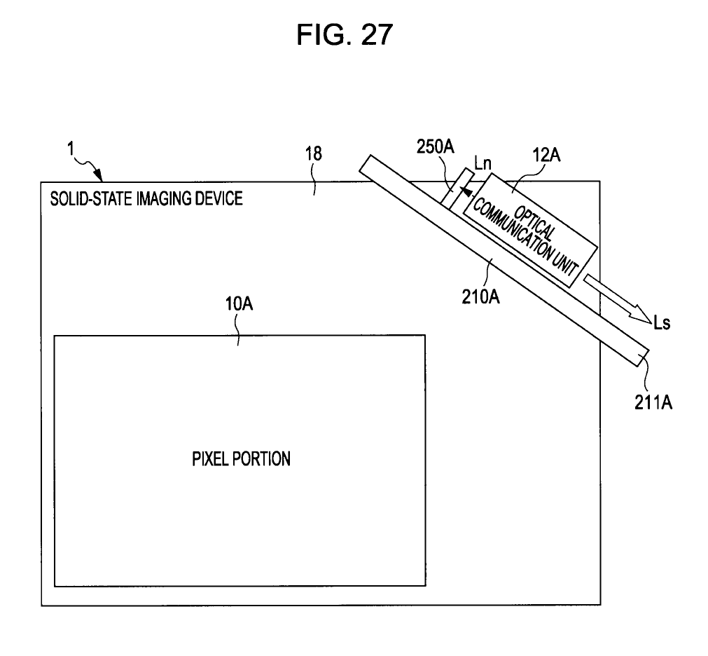

FIGS. 25, 26A, and 26B illustrate an eighth layout example of components making up an optical communication unit, wherein FIG. 25 is a schematic side view illustrating the eighth layout example of the components making up the optical communication unit, and FIGS. 26A and 26B are schematic perspective views illustrating the eighth layout example of the components making up the optical communication unit.

With the example shown in FIGS. 25 and 26, the optical communication unit 12A of the solid-state imaging device 1 has a configuration including a single external-modulating optical modulating unit 121P, and the optical modulating unit 121P is configured of a mirror unit 121D which is a micromirror device described in FIG. 13.

The optical modulating unit 121P outputs the signal light Ls by switching the reflecting direction at the time of reflecting the light L from the outside. In FIG. 26A, for example, light is input/output from the horizontal direction to a substrate 130 in a mode wherein the reflecting mirror 508 described in FIG. 13 is erected in the vertical direction as to the substrate 130 making up the optical communication unit 12A. Therefore, in order to prevent the light L input to the optical modulating unit 121P, and the signal light Ls reflected and output therefrom from leaking other than a predetermined direction from the optical modulating unit 121P, a light shielding portion 240E is provided around the optical modulating unit 121P. The driving unit 120T of the optical modulating unit 121P is, for example, disposed on the rear side of the light shielding portion 240E. In FIG. 26B, for example, the reflecting mirror 508 described in FIG. 13 is level to the substrate 130, where light is input/output from the vertical direction as to the substrate 130. Therefore, in order to prevent the light L input to the optical modulating unit 121P, and the signal light Ls reflected and output therefrom from leaking other than a predetermined direction from the optical modulating unit 121P, a light shielding portion 240E is provided with predetermined height around the optical modulating unit 121P. Also, an ambient light shielding portion 240F which shields light not input to the optical modulating unit 121P is provided in the lower portion around the optical modulating unit 121P.

### Configuration Example of Cooling Unit According to Configuration and Layout of Optical Communication Unit

With the solid-state imaging device 1, there is a possibility that heat generated at the optical communication unit 12A have an influence on the pixel portion 10A, an analog processing unit such as each scanning circuit or the like, and an imaging unit such as an A/D conversion unit 11A or the like. Therefore, a heat radiator is disposed so as to cool the optical communication unit 12A locally, and radiate heat generated at the optical communication unit 12A in the opposite direction of the pixel portion 10A, whereby influence of heat can be removed. Thus, heat generated at the optical communication unit 12A is cooled.

### (1) Configuration Example of Cooling Unit of Self-Emitting Optical Communication Units Disposed Grouped

FIG. 27 is a schematic plan view of a solid-state imaging device illustrating a configuration example of a cooling unit of a self-emitting optical communication unit disposed grouped. With the solid-state imaging device 1, the single optical communication unit 12A is disposed grouped at one corner in the vicinity portion of the substrate 18. The optical communication unit 12A includes, for example, an edge-emitting semiconductor laser.

With an edge-emitting semiconductor laser, the signal light Ls is output from one edge face. On the other hand, some light is also output from the edge face of the opposite side thereof. Therefore, with the optical communication unit 12A including an edge-emitting semiconductor laser, the edge face of the opposite side of the output edge of the signal light Ls is disposed inclined in a direction not facing the pixel portion 10A. Thus, leakage light Ln is prevented from inputting to the pixel portion 10A.

The solid-state imaging device 1 includes a cooling unit 210A around the optical communication unit 12A. The cooling unit 210A is configured of a material having high thermal conductivity as compared to the substrate 18, and has a function to radiate heat generated at the optical communication unit 12A without propagating this to the substrate 18.

Therefore, in the case that an edge-emitting semiconductor laser is employed as a light emitting element, the cooling unit 210A has a configuration wherein the lower face and the side face of the optical communication unit 12A are covered with, and the vicinity thereof is surrounded with, for example, a plate-shaped member except for the light emitting face of the optical communication unit 12A. In this case, an arrangement is also made wherein the cooling unit 210A is formed on the face facing the inner side of the substrate 18 facing the pixel portion 10A around the optical communication unit 12A. Thus, heat is prevented from propagating to the inner side of the substrate 18 where the pixel portion 10A and so forth are formed. Also, with the cooling unit 210A, a heat radiator 211A is formed partially protruding outside the substrate 18 which is outer side than the outer shape of the solid-state imaging device 1.

Thus, the solid-state imaging device 1 in which the optical communication unit 12A is formed grouped in one place of the substrate 18 includes the cooling unit 210A, whereby heat generated by the optical communication unit 12A being driven is propagated to not the substrate 18 but the cooling unit 210A. Thus, heat generated at the optical communication unit 12A is propagated to the opposite direction from the position where the pixel portion 10A is formed to prevent from reaching the pixel portion 10A, whereby influence that the heat generated at the optical communication unit 12A provides to the pixel portion 10A can be reduced extremely. Also, the cooling unit 210A can radiate the heat propagated from the optical communication unit 12A to the outside of the solid-state imaging device 1 by the heat radiator 211A being formed outer side than the outer shape of the solid-state imaging device 1.

In FIG. 27, an example including the single optical communication unit 12A has been described, but as described in FIGS. 4 and 5, with a configuration including the single or multiple optical communication units 12A in which the multiple optical output units 120A are arrayed, the cooling unit 210A may be provided. Similarly, as described in FIG. 6, with a configuration including the multiple optical communication units 12A including the single optical output unit 120A, the cooling unit 210A may be provided. Thus, heat generated at the multiple optical communication units 12A can be cooled locally with the single cooling unit 210A.

### (2) Another Configuration Example of Cooling Unit in Self-Emitting Optical Communication Unit Disposed Grouped

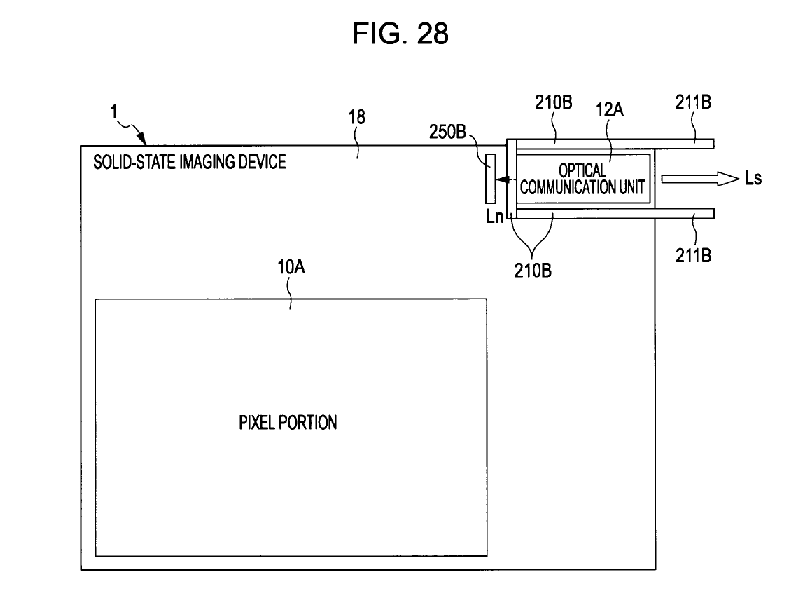

FIG. 28 is a schematic plan view of a solid-state imaging device illustrating another configuration example of a cooling unit of a self-emitting optical communication unit disposed grouped. With the solid-state imaging device 1, the single optical communication unit 12A is disposed grouped at one corner in the vicinity portion of the substrate 18. The optical communication unit 12A includes, for example, an edge-emitting semiconductor laser. With the example shown in FIG. 28, the optical communication unit 12A is disposed such that the direction where the signal light Ls is output is the direction generally perpendicular to the side of the substrate 18.

The solid-state imaging device 1 includes a cooling unit 210B around the optical communication unit 12A. The cooling unit 210B is configured of a material having high thermal conductivity as compared to the substrate 18, and has a function to radiate heat generated at the optical communication unit 12A without propagating this to the substrate 18.

Therefore, in the case that an edge-emitting semiconductor laser is employed as a light emitting element, the cooling unit 210B has a configuration wherein the lower face and the side face of the optical communication unit 12A are covered with, and the vicinity thereof is surrounded with, for example, a plate-shaped member except for the light emitting face of the optical communication unit 12A. In this case, an arrangement is also made wherein the cooling unit 210B is formed on the two faces facing the inner side of the substrate 18 facing the pixel portion 10A around the optical communication unit 12A. Thus, heat is prevented from propagating to the inner side of the substrate 18 where the pixel portion 10A and so forth are formed. Also, with the cooling unit 210B, a heat radiator 211B is formed partially protruding outside the substrate 18 which is outer side than the outer shape of the solid-state imaging device 1.

The solid-state imaging device 1 includes a light shielding portion 250B around the optical communication unit 12A. The light shielding portion 250B is configured of a material which does not transmit at least light having an oscillation wavelength. In the case that an edge-emitting semiconductor laser is employed as a light emitting element, the light shielding portion 250B is formed at a position facing the edge face of the opposite side of the output edge of the signal light Ls. Thus, leakage light Ln from the optical communication unit 12A is prevented from inputting to the pixel portion 10A.

Thus, the solid-state imaging device 1 in which the optical communication unit 12A is formed grouped in one place of the substrate 18 includes the cooling unit 210B and the light shielding portion 250B, whereby heat generated by the optical communication unit 12A being driven is propagated to not the substrate 18 but the cooling unit 210B. Thus, heat generated at the optical communication unit 12A is propagated to the opposite direction from the position where the pixel portion 10A is formed to prevent from reaching the pixel portion 10A, whereby influence that the heat generated at the optical communication unit 12A provides to the pixel portion 10A can be reduced extremely. Also, the cooling unit 210B can radiate the heat propagated from the optical communication unit 12A to the outside of the solid-state imaging device 1 by the heat radiator 211B being formed outer side than the outer shape of the solid-state imaging device 1.

Further, the light leaked from the optical communication unit 12A is shielded at the light shielding portion 250B, whereby the leakage light Ln from the optical communication unit 12A can be prevented from inputting to the pixel portion 10A as stray light.

### (3) Configuration Example of Cooling Unit in Self-Emitting Optical Communication Unit Disposed Discretely Grouped

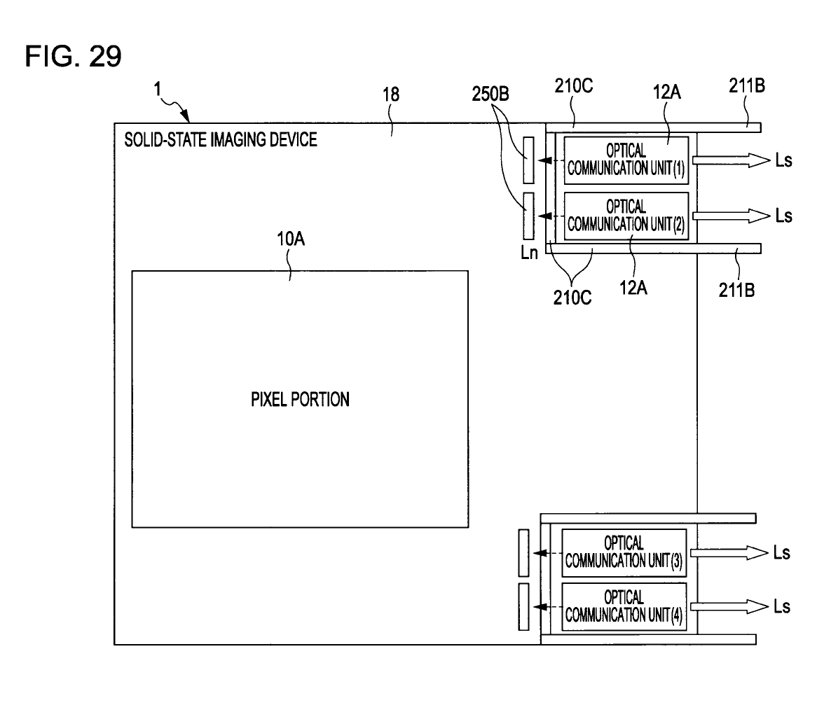

FIG. 29 is a schematic plan view of a solid-state imaging device illustrating a configuration example of a cooling unit of a self-emitting optical communication unit disposed discretely grouped. With the solid-state imaging device 1, the multiple optical communication units 12A are disposed discretely grouped at two corners in the vicinity portion of the substrate 18. The optical communication units 12A include, for example, an edge-emitting semiconductor laser. With the example shown in FIG. 29, the optical communication units 12A are disposed such that the direction where the signal light Ls is output is the direction generally perpendicular to the side of the substrate 18.

The solid-state imaging device 1 includes a cooling unit 210C around the optical communication units 12A. The cooling unit 210C is configured of a material having high thermal conductivity as compared to the substrate 18, and has a function to radiate heat generated at the optical communication units 12A without propagating this to the substrate 18.

Therefore, in the case that an edge-emitting semiconductor laser is employed as a light emitting element, the cooling unit 210C has a configuration wherein the lower face and the side face of each of the optical communication units 12A are covered with, and the vicinity of the multiple optical communication units 12A disposed grouped is surrounded with, for example, a plate-shaped member except for the light emitting face of each of the optical communication units 12A. In this case, an arrangement is also made wherein the cooling unit 210C is formed on the two faces facing the inner side of the substrate 18 facing the pixel portion 10A around the optical communication units 12A. Thus, heat is prevented from propagating to the inner side of the substrate 18 where the pixel portion 10A and so forth are formed. Also, with the cooling unit 210C, a heat radiator 211C is formed partially protruding outside the substrate 18 which is outer side than the outer shape of the solid-state imaging device 1.

The solid-state imaging device 1 includes a light shielding portion 250B around the optical communication units 12A. The light shielding portion 250B is configured of a material which does not transmit at least light having an oscillation wavelength. In the case that an edge-emitting semiconductor laser is employed as a light emitting element, the light shielding portion 250B is formed at a position facing the edge face of the opposite side of the output edge of the signal light Ls with each of the optical communication units 12A. Thus, leakage light Ln from the optical communication units 12A is prevented from inputting to the pixel portion 10A.

Thus, the solid-state imaging device 1 in which the optical communication units 12A are formed discretely grouped in multiple places of the substrate 18 includes the cooling unit 210C and the light shielding portion 250B, whereby heat generated by the optical communication units 12A being driven is propagated to not the substrate 18 but the cooling unit 210C. Thus, heat generated at each of the optical communication units 12A disposed discretely grouped is propagated to the opposite direction from the position where the pixel portion 10A is formed to prevent from reaching the pixel portion 10A, whereby influence that the heat generated at the optical communication units 12A provides to the pixel portion 10A can be reduced extremely. Also, the cooling unit 210C can radiate the heat propagated from the optical communication units 12A to the outside of the solid-state imaging device 1 by the heat radiator 211C being formed outer side than the outer shape of the solid-state imaging device 1.

Further, the light leaked from the optical communication units 12A is shielded at the light shielding portion 250B, whereby the leakage light Ln from the optical communication units 12A can be prevented from inputting to the pixel portion 10A as stray light.

### (4) Configuration Example of Cooling Unit of Self-Emitting Optical Communication Units Disposed Discretely

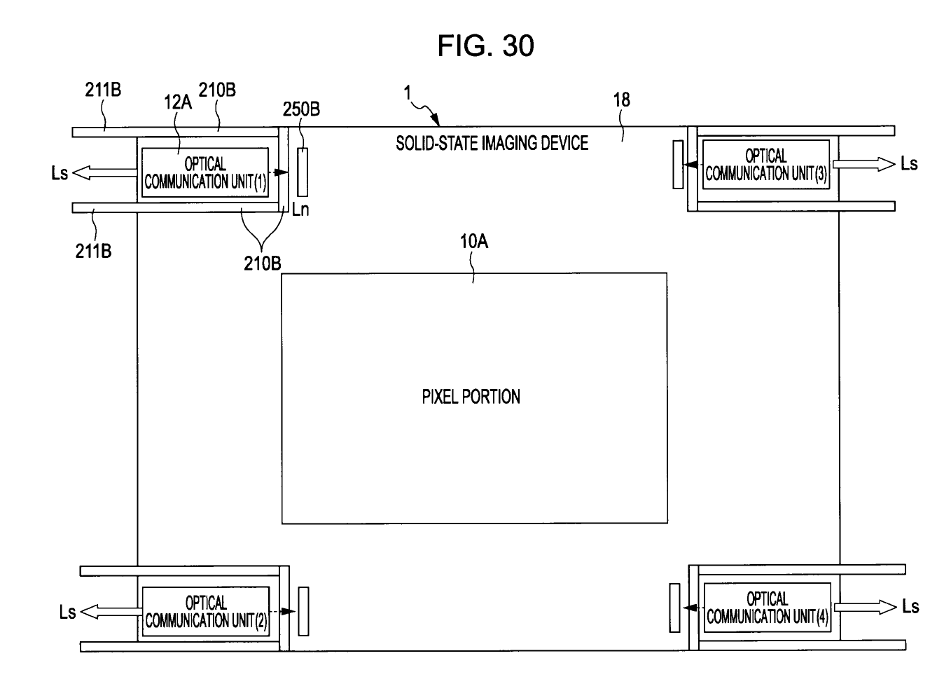

FIG. 30 is a schematic plan view of a solid-state imaging device illustrating a configuration example of a cooling unit of a self-emitting optical communication unit disposed discretely. With the solid-state imaging device 1, the single optical communication unit 12A is disposed discretely at four corners in the vicinity portion of the substrate 18. The optical communication units 12A include, for example, an edge-emitting semiconductor laser. With the example shown in FIG. 30, the optical communication units 12A are disposed such that the direction where the signal light Ls is output is the direction generally perpendicular to the side of the substrate 18.

The solid-state imaging device 1 includes a cooling unit 210B around the optical communication units 12A. The cooling unit 210B is configured of a material having high thermal conductivity as compared to the substrate 18, and has a function to radiate heat generated at the optical communication unit 12A without propagating this to the substrate 18.

Therefore, in the case that an edge-emitting semiconductor laser is employed as a light emitting element, the cooling unit 210B has a configuration wherein the lower face and the side face of the optical communication unit 12A are covered with, and the vicinity of the multiple optical communication unit 12A disposed discretely is surrounded with, for example, a plate-shaped member except for the light emitting face of the optical communication unit 12A. In this case, an arrangement is also made wherein the cooling unit 210B is formed on the two faces facing the inner side of the substrate 18 facing the pixel portion 10A around the optical communication unit 12A. Thus, heat is prevented from propagating to the inner side of the substrate 18 where the pixel portion 10A and so forth are formed. Also, with the cooling unit 210B, a heat radiator 211B is formed partially protruding outside the substrate 18 which is outer side than the outer shape of the solid-state imaging device 1.

The solid-state imaging device 1 includes a light shielding portion 250B around the optical communication units 12A. The light shielding portion 250B is configured of a material which does not transmit at least light having an oscillation wavelength. In the case that an edge-emitting semiconductor laser is employed as a light emitting element, the light shielding portion 250B is formed at a position facing the edge face of the opposite side of the output edge of the signal light Ls with each of the optical communication units 12A. Thus, leakage light Ln from the optical communication units 12A is prevented from inputting to the pixel portion 10A.

Thus, the solid-state imaging device 1 in which the optical communication units 12A are formed discretely in multiple places of the substrate 18 includes the cooling unit 210B and the light shielding portion 250B, whereby heat generated by the optical communication units 12A being driven is propagated to not the substrate 18 but the cooling unit 210B. Thus, heat generated at each of the optical communication units 12A disposed discretely is propagated to the opposite direction from the position where the pixel portion 10A is formed to prevent from reaching the pixel portion 10A, whereby influence that the heat generated at the optical communication units 12A provides to the pixel portion 10A can be reduced extremely. Also, the cooling unit 210B can radiate the heat propagated from the optical communication units 12A to the outside of the solid-state imaging device 1 by the heat radiator 211B being formed outer side than the outer shape of the solid-state imaging device 1.

Further, the light leaked from the optical communication units 12A is shielded at the light shielding portion 250B, whereby the leakage light Ln from the optical communication units 12A can be prevented from inputting to the pixel portion 10A as stray light.

### (5) Configuration Example of Cooling Unit of External-Modulating Optical Communication Units Disposed Discretely Grouped

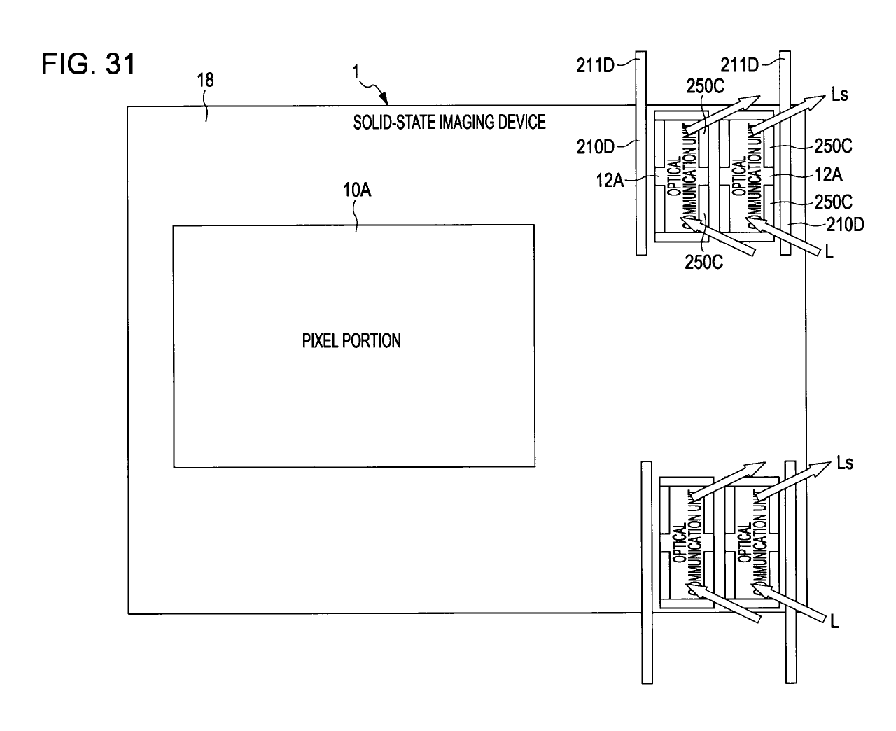

FIG. 31 is a schematic plan view of a solid-state imaging device illustrating a configuration example of a cooling unit of an external-modulating optical communication unit disposed discretely grouped. With the solid-state imaging device 1, the multiple optical communication units 12A are disposed discretely grouped at two corners in the vicinity portion of the substrate 18. The optical communication units 12A have a configuration such as described in FIGS. 22 and 23, wherein an external-modulating optical modulating unit is provided.

The solid-state imaging device 1 includes a cooling unit 210D around the optical communication units 12A. The cooling unit 210D is configured of a material having high thermal conductivity as compared to the substrate 18, and has a function to radiate heat generated at the optical communication units 12A without propagating this to the substrate 18.

Therefore, in the case that an external-modulating optical modulating unit is employed as an optical output unit, the cooling unit 210D has a configuration wherein the lower face and the side face of each of the optical communication units 12A are covered with, for example, a plate-shaped member except for the input portion and output portion of light to each of the optical modulating units. Thus, an arrangement is made wherein the vicinity of the multiple optical communication units 12A disposed grouped is surrounded without the cooling unit 210D interrupting light L to be input to the optical communication units 12A and signal light Ls to be output therefrom. Note that the input/output directions of light indicated with arrows in the drawing are schematically illustrated. In this case, an arrangement is also made wherein the cooling unit 210D is formed on the face facing the inner side of the substrate 18 facing the pixel portion 10A around the optical communication units 12A. Thus, heat is prevented from propagating to the inner side of the substrate 18 where the pixel portion 10A and so forth are formed. Also, with the cooling unit 210D, a heat radiator 211D is formed partially protruding outside the substrate 18 which is outer side than the outer shape of the solid-state imaging device 1.

The solid-state imaging device 1 includes a light shielding portion 250C around the optical communication units 12A. The light shielding portion 250C is configured of a material which does not transmit light having a wavelength to be input to the optical communication units 12A. In the case that an external-modulating optical modulating unit is employed as an optical output unit, the light shielding portion 250C is formed around a waveguide path other than the input/output portion of light to the optical modulating unit, as shown in FIGS. 22 and 23. Thus, leakage light from the optical communication units 12A is prevented from inputting to the pixel portion 10A.

Thus, the solid-state imaging device 1 in which the optical communication units 12A are formed discretely grouped in multiple places of the substrate 18 includes the cooling unit 210D and the light shielding portion 250C, whereby heat generated by the optical communication units 12A being driven is propagated to not the substrate 18 but the cooling unit 210D. Thus, heat generated at each of the optical communication units 12A disposed discretely grouped is propagated to the opposite direction from the position where the pixel portion 10A is formed to prevent from reaching the pixel portion 10A, whereby influence that the heat generated at the optical communication units 12A provides to the pixel portion 10A can be reduced extremely. Also, the cooling unit 210D can radiate the heat propagated from the optical communication units 12A to the outside of the solid-state imaging device 1 by the heat radiator 211D being formed outer side than the outer shape of the solid-state imaging device 1.

Further, the light leaked from the optical communication units 12A is shielded at the light shielding portion 250C, whereby the leakage light from the optical communication units 12A can be prevented from inputting to the pixel portion 10A as stray light.

### (6) Configuration Example of Cooling Unit of External-Modulating Optical Communication Units Disposed Discretely

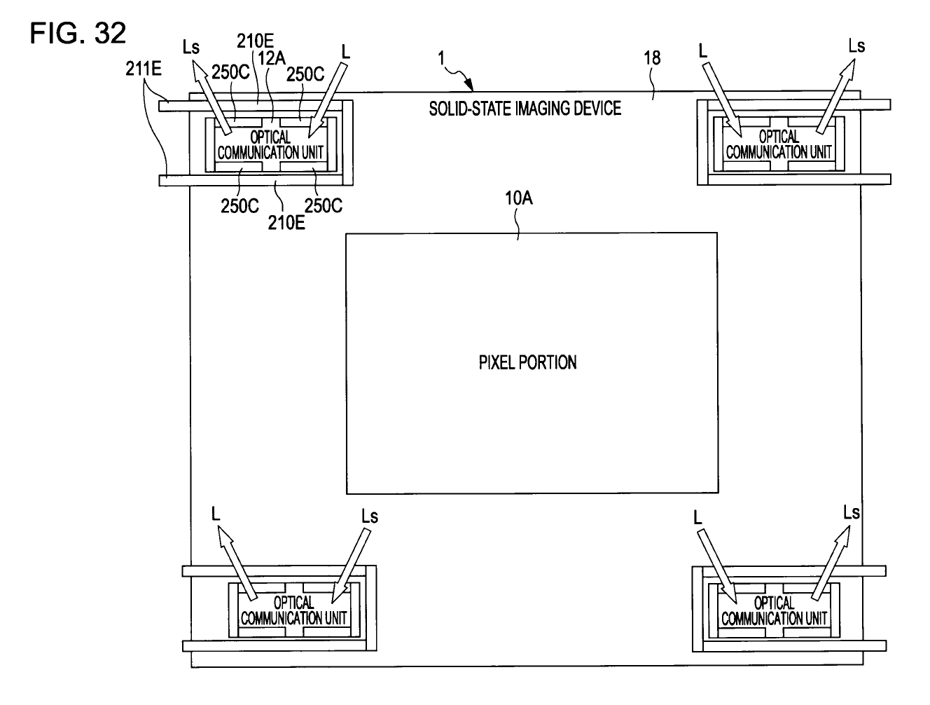

FIG. 32 is a schematic plan view of a solid-state imaging device illustrating a configuration example of a cooling unit of an external-modulating optical communication unit disposed discretely. With the solid-state imaging device 1, the single optical communication unit 12A is disposed discretely at four corners in the vicinity portion of the substrate 18. The optical communication units 12A have a configuration such as described in FIGS. 22 and 23, wherein an external-modulating optical modulating unit is provided.

The solid-state imaging device 1 includes a cooling unit 210E around the optical communication units 12A. The cooling unit 210E is configured of a material having high thermal conductivity as compared to the substrate 18, and has a function to radiate heat generated at the optical communication units 12A without propagating this to the substrate 18.

Therefore, in the case that an external-modulating optical modulating unit is employed as an optical output unit, the cooling unit 210E has a configuration wherein the lower face and the side face of the optical communication unit 12A are covered with, for example, a plate-shaped member except for the input portion and output portion of light to each of the optical modulating units. Thus, an arrangement is made wherein the vicinity of each of the multiple optical communication units 12A disposed discretely is surrounded without the cooling unit 210E interrupting light L to be input to the optical communication unit 12A and signal light Ls to be output therefrom. Note that the input/output directions of light indicated with arrows in the drawing are schematically illustrated. In this case, an arrangement is also made wherein the cooling unit 210E is formed on the two faces facing the inner side of the substrate 18 facing the pixel portion 10A around the optical communication unit 12A. Thus, heat is prevented from propagating to the inner side of the substrate 18 where the pixel portion 10A and so forth are formed. Also, with the cooling unit 210E, a heat radiator 211E is formed partially protruding outside the substrate 18 which is outer side than the outer shape of the solid-state imaging device 1.

The solid-state imaging device 1 includes a light shielding portion 250C around the optical communication units 12A. The light shielding portion 250C is configured of a material which does not transmit light having a wavelength to be input to the optical communication units 12A. In the case that an external-modulating optical modulating unit is employed as an optical output unit, the light shielding portion 250C is formed around a waveguide path other than the input/output portion of light to the optical modulating unit, as shown in FIGS. 22 and 23. Thus, leakage light from the optical communication units 12A is prevented from inputting to the pixel portion 10A.

Thus, the solid-state imaging device 1 in which the optical communication units 12A are formed discretely in multiple places of the substrate 18 includes the cooling unit 210E and the light shielding portion 250C, whereby heat generated by the optical communication units 12A being driven is propagated to not the substrate 18 but the cooling unit 210E. Thus, heat generated at each of the optical communication units 12A disposed discretely is propagated to the opposite direction from the position where the pixel portion 10A is formed to prevent from reaching the pixel portion 10A, whereby influence that the heat generated at the optical communication units 12A provides to the pixel portion 10A can be reduced extremely. Also, the cooling unit 210E can radiate the heat propagated from the optical communication unit 12A to the outside of the solid-state imaging device 1 by the heat radiator 211E being formed outer side than the outer shape of the solid-state imaging device 1.

Further, the light leaked from the optical communication units 12A is shielded at the light shielding portion 250C, whereby the leakage light from the optical communication units 12A can be prevented from inputting to the pixel portion 10A as stray light.

### (7) Another Configuration Example of Cooling Unit of External-Modulating Optical Communication Units Disposed Discretely

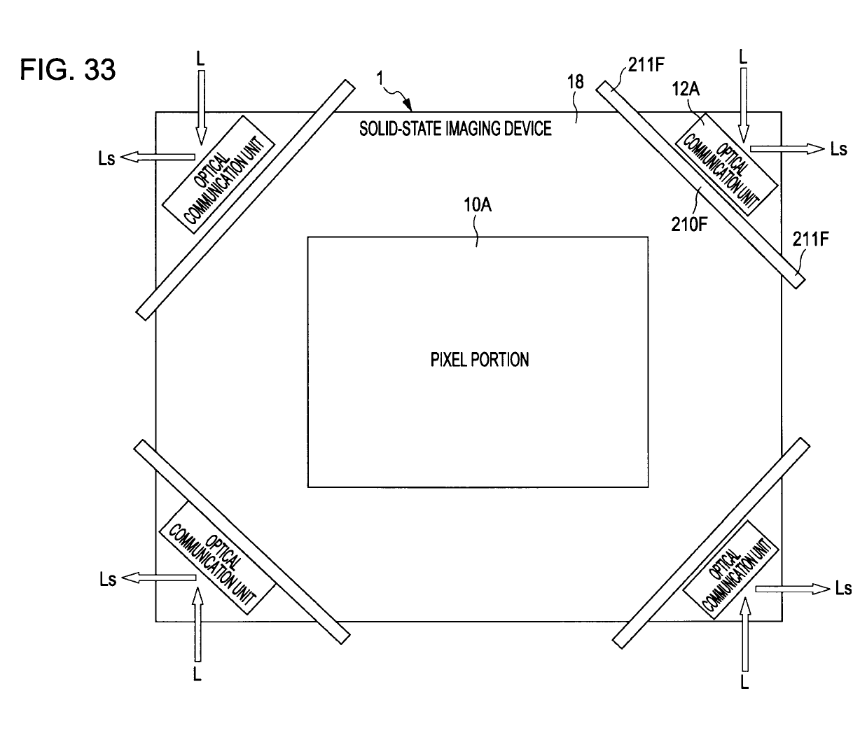

FIG. 33 is a schematic plan view of a solid-state imaging device illustrating another configuration example of a cooling unit of an external-modulating optical communication unit disposed discretely. With the solid-state imaging device 1, the single optical communication unit 12A is disposed discretely at four corners in the vicinity portion of the substrate 18. The optical communication units 12A have a configuration such as described in FIGS. 25 and 26, wherein an external-modulating optical modulating unit is provided.

The solid-state imaging device 1 includes a cooling unit 210F around the optical communication units 12A. The cooling unit 210F is configured of a material having high thermal conductivity as compared to the substrate 18, and has a function to radiate heat generated at the optical communication units 12A without propagating this to the substrate 18.

Therefore, in the case that a reflecting-type optical modulating unit is employed as an optical output unit, the cooling unit 210F is disposed on the opposite side of the input/output direction of light to each of the modulating units. In this case, an arrangement is also made wherein the cooling unit 210F is formed on the face facing the inner side of the substrate 18 facing the pixel portion 10A around the optical communication unit 12A. Thus, heat is prevented from propagating to the inner side of the substrate 18 where the pixel portion 10A and so forth are formed. Also, with the cooling unit 210F, a heat radiator 211F is formed partially protruding outside the substrate 18 which is outer side than the outer shape of the solid-state imaging device 1.

Thus, the solid-state imaging device 1 in which the optical communication units 12A are formed discretely in multiple places of the substrate 18 includes the cooling unit 210F, whereby heat generated by the optical communication units 12A being driven is propagated to not the substrate 18 but the cooling unit 210F. Thus, heat generated at each of the optical communication units 12A disposed discretely is propagated to the opposite direction from the position where the pixel portion 10A is formed to prevent from reaching the pixel portion 10A, whereby influence that the heat generated at the optical communication units 12A provides to the pixel portion 10A can be reduced extremely. Also, the cooling unit 210F can radiate the heat propagated from the optical communication unit 12A to the outside of the solid-state imaging device 1 by the heat radiator 211F being formed outer side than the outer shape of the solid-state imaging device 1.

Note that, with the solid-state imaging device 1 according to each embodiment, an insulating member may be provided as a cooling unit which shields propagation of heat between the optical communication unit 12A and the substrate 18. Also, a cooling unit may be provided wherein according to movement of heat via a medium such as a heat pipe or the like, or movement of heat by way of a Peltier device or the like, heat generated at the optical communication units 12A can be propagated.

### Overview of Signal Processing System Including Solid-State Imaging Device

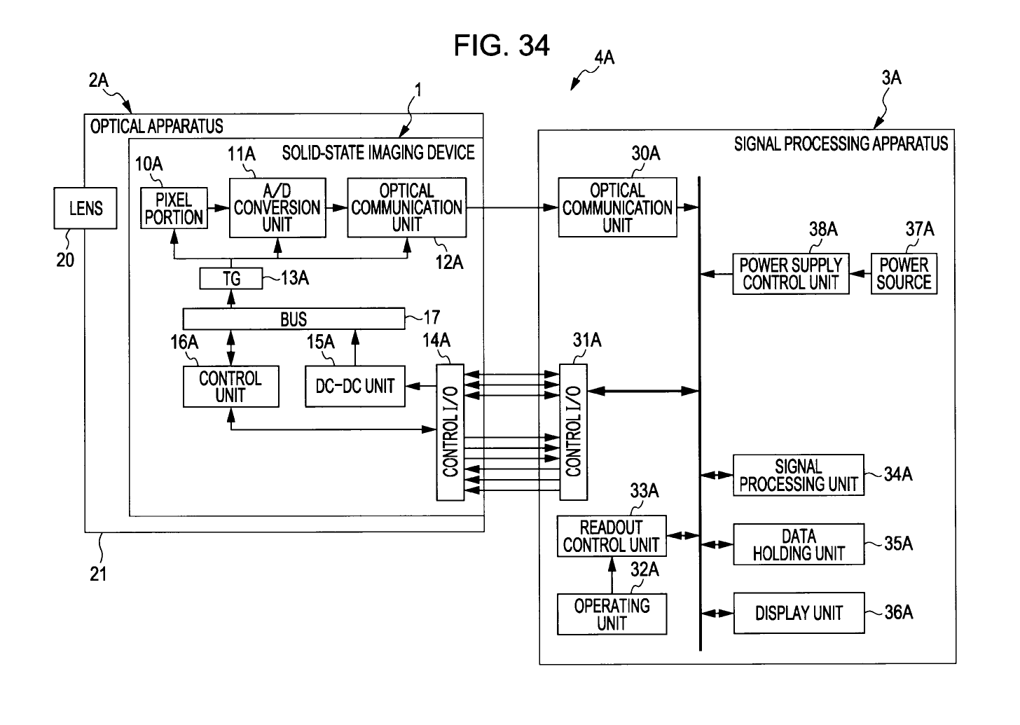

FIG. 34 is a functional block diagram illustrating an overview of a signal processing system including a solid-state imaging device. First, the overview of an optical apparatus having the solid-state imaging device will be described. An optical apparatus 2A includes the above solid-state imaging device 1, a lens portion 20, and a housing 21 in which the solid-state imaging device 1 and the lens portion 20 and so forth are mounted, which make up, for example, a lens unit of a camera system. The lens portion 20 is an example of an optical element, and is configured of a single lens or a combination of multiple lenses.

The optical apparatus 2A is configured such that the pixel portion 10A of the solid-state imaging device 1 is matched with the focal position of the lens portion 20, and the image of light input from the lens portion 20 is formed on the pixel portion 10A of the solid-state imaging device 1.

The optical apparatus 2A sets the focus position of the lens portion 20 to the pixel portion 10A of the solid-state imaging device 1 regardless of distance as to an object to be imaged, and accordingly, includes, for example, a focusing mechanism which moves the lens portion 20 in the optical axis direction as to the solid-state imaging device 1.

Next, description will be made regarding an overview of a signal processing apparatus to which the optical apparatus is connected. A signal processing apparatus 3A includes an optical communication unit 30A which converts an optical signal to an electric signal, and control I/O 31A where input/output such as a control signal or the like is executed, and makes up, for example, a camera main unit of a camera system. With the signal processing apparatus 3A, upon an optical apparatus 2A being connected thereto, the optical communication unit 30A is optically connected to the optical communication unit 12A of the solid-state imaging device 1. Also, the control I/O 31A is connected to control I/O 14A of the solid-state imaging device 1.

The signal processing apparatus 3A includes an operating unit 32A which accepts operations by the user, and a readout control unit 33A which instructs the solid-state imaging device 1 of the optical apparatus 2A to execute readout of pixel data based on the operations at the operating unit 32A.

The signal processing apparatus 3A instructs the solid-state imaging device 1 of the optical apparatus 2A to execute readout of pixel data from the control I/O 31A, and executes optical communication between the optical communication unit 12A of the solid-state imaging device 1 and the optical communication unit 30A of the self apparatus to obtain pixel data from the solid-state imaging device 1.

The optical communication unit 30A includes a light receiving element such as a photodiode (PD) or the like as a light receiving unit wherein the signal light Ls output from the optical communication unit 12A of the solid-state imaging device 1 is input, and pixel data input by an optical signal is converted into an electric signal and output this.

Note that, with a configuration wherein the optical communication unit 12A of the solid-state imaging device 1 includes an optical modulating unit which modulates external light, the optical communication unit 30A of the signal processing apparatus 3A includes a light emitting unit which outputs light to be input to the optical modulating unit of the solid-state imaging device 1. The light emitting unit includes a light emitting element such as a semiconductor laser or the like, and outputs fixed continuous light L.

The signal processing apparatus 3A includes a signal processing unit 34A which executes optical communication with the solid-state imaging device 1, and subjects obtained pixel data to a predetermined signal process to generate image data. Also, the signal processing apparatus 3A includes a data holding unit 35A which holds pixel data obtained from the solid-state imaging device 1, and a display unit 36A which displays an image from the image data generated at the signal processing unit 34A.

The signal processing apparatus 3A includes a power source 37A which supplies power to the self apparatus and the optical apparatus 2A, and a power control unit 38A which controls power supply. The power control unit 38A executes power supply control wherein power supply to the signal processing apparatus 3A, and power supply to the optical apparatus 2A are switched in a predetermined order based on power on operations and power off operations of the signal processing apparatus 3A.

Next, description will be made regarding an overview of a signal processing system including an optical apparatus and a signal processing apparatus. A signal processing system 4A includes the above optical apparatus 2A and signal processing apparatus 3A, and makes up, for example, a camera system. With the camera system, the optical apparatus 2A which makes up a lens unit is configured so as to be replaced detachably as to the signal processing apparatus 3A making up a camera main unit.

With the signal processing system 4A, upon the signal processing apparatus 3A being connected to the optical apparatus 2A, the optical communication unit 30A of the signal processing apparatus 3A, and the optical communication unit 12A of the solid-state imaging device 1 making up the optical apparatus 2A are optically connected. Also, the control I/O 31A of the signal processing apparatus 3A, and the control I/O 14A of the solid-state imaging device 1 are connected.

Thus, with the signal processing system 4A, input/output of data is executed by optical signals between the optical apparatus 2A and the signal processing apparatus 3A by the optical communication unit 12A of the solid-state imaging device 1, and the optical communication unit 30A of the signal processing apparatus 3A.

Also, with the signal processing system 4A, input/output of a control signal is executed between the signal processing apparatus 3A and the optical apparatus 2A by the control I/O 31A of the signal processing apparatus 3A, and the control I/O 14A of the solid-state imaging device 1. Further, with the signal processing system 4A, power supply is executed between the signal processing apparatus 3A and the optical apparatus 2A by the control I/O 31A of the signal processing apparatus 3A, and the control I/O 14A of the solid-state imaging device 1.

With the signal processing system 4A, the operating unit 32A of the signal processing apparatus 3A accepts the operation by the user, and based on the operation at the operating unit 32A, the readout control unit 33A of the signal processing apparatus 3A outputs a control signal to instruct readout of pixel data.

With the signal processing system 4A, the control signal to instruct readout of pixel data is input to the solid-state imaging device 1 of the optical apparatus 2A by the control I/O 31A of the signal processing apparatus 3A, and the control I/O 14A of the optical apparatus 2A.

With the signal processing system 4A, upon the control signal to instruct readout of pixel data being input to the solid-state imaging device 1 of the optical apparatus 2A, the control unit 16A of the solid-state imaging device 1 generates a driving clock at the timing generator 13A.

The driving clock generated at the timing generator 13A is supplied to the pixel portion 10A, A/D conversion unit 11A, and optical communication unit 12A, and pixel data is read out as an electric signal at the pixel portion 10A. With the A/D conversion unit 11A, the pixel data read out from the pixel portion 10A is input, converted into a digital signal, and output. With the optical communication unit 12A, the electric signal converted into a digital signal at the A/D conversion unit 11A is input, and the pixel data is converted into signal light Ls and output. Note that, in the case of a configuration wherein the optical communication unit 12A of the solid-state imaging device 1 includes an optical modulator which modulates external light, with the optical communication unit 12A, the fixed light input from the signal processing apparatus 3A is modulated based on the electric signal converted into a digital signal at the A/D conversion unit 11A, and signal light Ls is output.

With the signal processing system 4A, the pixel data read out at the solid-state imaging device 1 is input to the signal processing apparatus 3A through optical communication by the optical communication unit 12A of the solid-state imaging device 1, and the optical communication unit 30A of the signal processing apparatus 3A.

With the signal processing system 4A, upon the pixel data read out at the solid-state imaging device 1 being input to the signal processing apparatus 3A by optical communication, the optical communication unit 30A of the signal processing apparatus 3A converts the pixel data input by an optical signal into an electric signal, and outputs this.

With the signal processing system 4A, the signal processing unit 34A of the signal processing apparatus 3A subjects the pixel data converted into an electric signal at the optical communication unit 30A of the signal processing apparatus 3A to a predetermined signal process to generate image data, and for example, displays the image on the display unit 36A.

### Specific Example of Signal Processing System

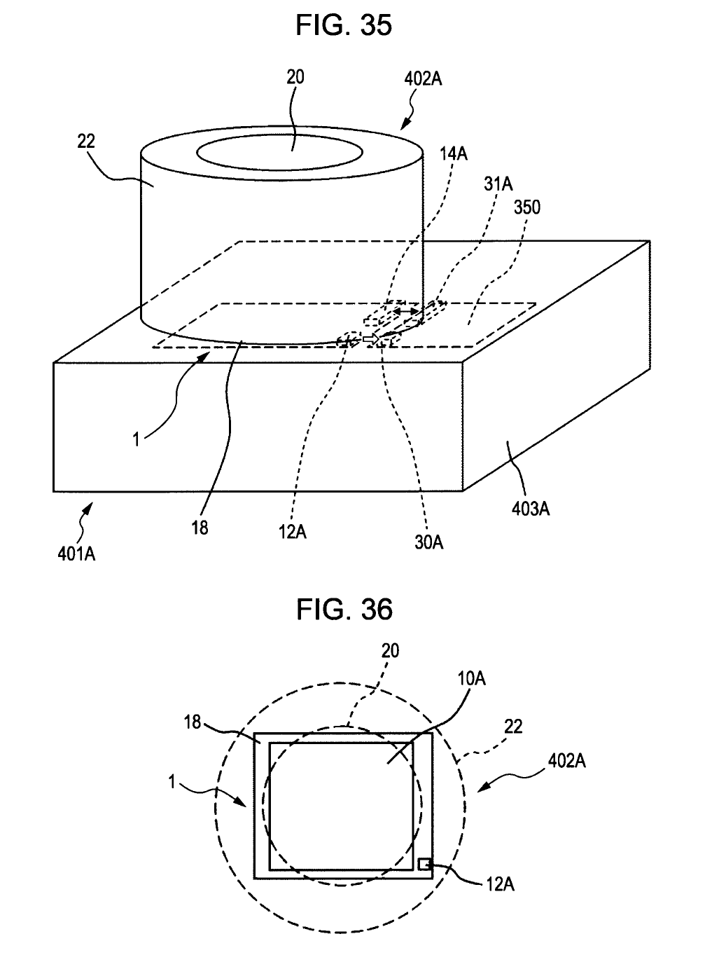

FIG. 35 is a schematic perspective view illustrating an example of a camera system serving as an application of the signal processing system, and FIG. 36 is a schematic front view of a lens unit making up the camera system. A camera system 401A is configured as an example of the signal processing system 4A described in FIG. 34.

The camera system 401A includes a lens unit 402A as the optical apparatus 2A described in FIG. 34, and also includes a camera main unit 403A as the signal processing apparatus 3A. The lens unit 402A includes a lens portion 20, and a lens barrel 22, and also includes the above solid-state imaging device 1. With the solid-state imaging device 1, the size of the pixel portion 10A is, as shown in FIG. 36, stipulated with the lens portion 20 of the lens unit 402A.

The camera main unit 403A includes a signal processing substrate 350 to which the lens unit 402A is attached in an exchangeable manner, for example. The signal processing substrate 350 makes up the signal processing apparatus 3A described in FIG. 34 and others, and upon the lens unit 402A being attached thereto, the optical communication unit 12A of the solid-state imaging device 1, and the optical communication unit 30A are optically connected. Also, the control I/O 14A of the solid-state imaging device 1, and the control I/O 31A are connected.

With the solid-state imaging device 1, as described above, the optical communication unit 12A is provided on the surface side of the substrate 18. In the case that the solid-state imaging device 1 includes an edge-emitting semiconductor laser as the optical communication unit 12A, signal light is output in a direction level to the surface of the substrate 18. Thus, when the lens unit 402A is attached to the camera main unit 403A, the signal processing substrate 350 should be provided in parallel with a lateral direction of the solid-state imaging device 1, e.g., horizontal direction.

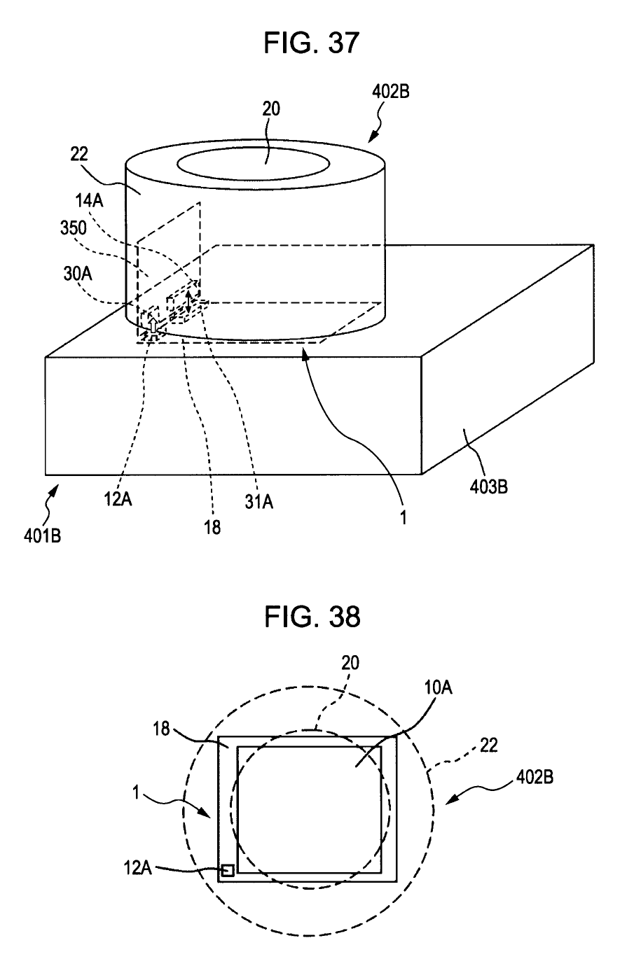

FIG. 37 is a schematic perspective view illustrating another example of a camera system serving as an application of the signal processing system, and FIG. 38 is a schematic front view of a lens unit making up the camera system. A camera system 401B is configured as an example of the signal processing system 4A described in FIG. 34.

The camera system 401B includes a lens unit 402B as the optical apparatus 2A described in FIG. 34, and also includes a camera main unit 403B. The lens unit 402B includes a lens portion 20, and a lens barrel 22, and also includes the above solid-state imaging device 1. With the solid-state imaging device 1, the size of the pixel portion 10A is, as shown in FIG. 38, stipulated with the lens portion 20 of the lens unit 402B.

The camera main unit 403B includes a signal processing substrate 350 to which the lens unit 402B is attached in an exchangeable manner, for example. The signal processing substrate 350 makes up the signal processing apparatus 3A described in FIG. 34 and others, and upon the lens unit 402B being attached thereto, the optical communication unit 12A of the solid-state imaging device 1, and the optical communication unit 30A are optically connected. Also, the control I/O 14A of the solid-state imaging device 1, and the control I/O 31A are connected.

With the solid-state imaging device 1, as described above, the optical communication unit 12A is provided on the surface side of the substrate 18. In the case that the solid-state imaging device 1 includes a surface-emitting semiconductor laser as the optical communication unit 12A, signal light is output in a direction perpendicular to the surface of the substrate 18. Thus, when the lens unit 402B is attached to the camera main unit 403B, the signal processing substrate 350 should be provided longitudinally in the vertical direction of the solid-state imaging device 1.

Thus, the direction or the like of the signal processing substrate 350 to which the solid-state imaging device 1 is connected can be determined according to the configuration of the optical communication unit 12A, whereby the flexibility of the camera main unit, and the signal processing apparatus to which the solid-state imaging device is connected improves. For example, an arrangement may be made wherein the lens unit is integral with the camera main unit, and the signal processing substrate is housed in the lens unit.

### Specific Example of Solid-State Imaging Device According to Each Embodiment

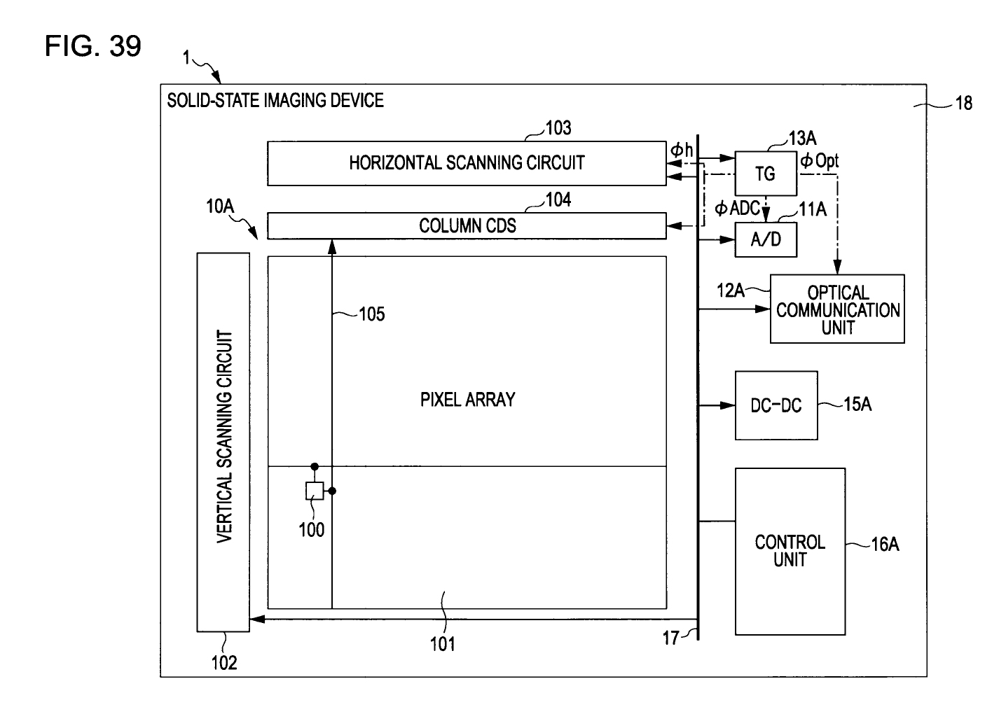

FIG. 39 is a functional block diagram illustrating a specific example of the solid-state imaging device according to each of embodiments. The solid-state imaging device 1 shown in FIG. 39 is configured of a CMOS image sensor.

The pixel portion 10A of the solid-state imaging device 1 making up the CMOS image sensor includes a pixel array 101 in which pixels 100 are arrayed two-dimensionally, and a vertical scanning circuit 102 and a horizontal scanning circuit 103 which select the pixel 100 from which pixel data is read out by the XY address method.

The vertical scanning circuit (Row Decoder/Driver) 102 selects the pixel 100 from which pixel data is read out in the row direction of the pixel array 101. Also, the vertical scanning circuit 102 generates a row selection pattern for every mode of operation, and selects the pixel 100 from which pixel data is read out, based on the generated selection pattern.

The horizontal scanning circuit (Column Decoder/Driver) 103 selects the pixel 100 from which pixel data is read out in the column direction of the pixel array 101. Also, the horizontal scanning circuit 103 generates a column selection pattern for every mode of operation, and selects the pixel 100 from which pixel data is read out, based on the generated selection pattern. Further, the horizontal scanning circuit 103 executes calculation such as pixel addition in the horizontal direction, or the like to convert the sequence of the signal output from each pixel 100 from parallel to serial.

The solid-state imaging device 1 includes a column CDS circuit 104 which removes noise from pixel data. The CDS (Correlated Double Sampling) circuit is a circuit which samples a reference (reset) level and a signal level included in a signal, and executes subtraction between both to calculate difference thereof. The column CDS circuit 104 uses a CDS circuit connected to a column signal line 105 which outputs pixel data from the pixel array 101 to remove irregularities such as amplification or the like for each pixel 100. With the column CDS circuit 104, pixel data is subjected to a process as an analog signal within the circuit.

With the solid-state imaging device 1, the above vertical scanning circuit 102 and horizontal scanning circuit 103 of the pixel portion 10A are connected to a bus 17. Also, the above A/D conversion unit 11A, optical communication unit 12A, timing generator 13A, DC-DC unit 15A, and control unit 16A are connected to the bus 17.

A driving clock φh generated at the timing generator 13A is supplied to the horizontal scanning circuit 103 and the column CDS circuit 104. Also, a driving clock φADC is supplied to the A/D conversion unit 11A. Further, a driving clock φOpt is supplied to the optical communication unit 12A.

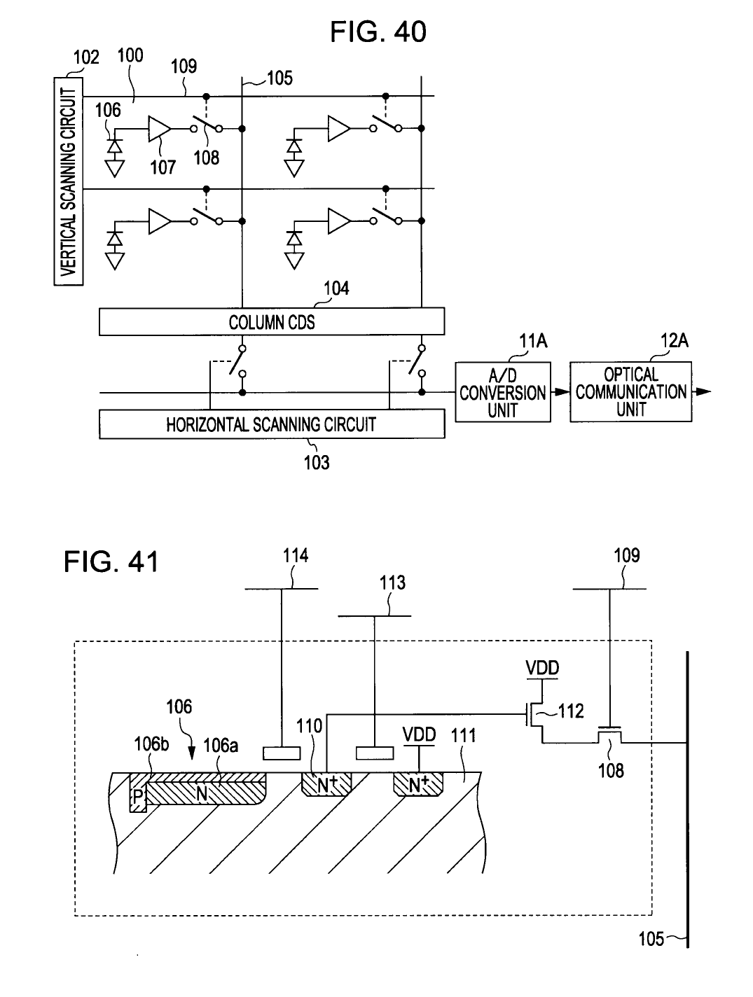

FIGS. 40 and 41 illustrate the configuration of each pixel, and the readout configuration of a pixel signal, wherein FIG. 40 is a circuit configuration diagram illustrating a specific example of the pixel array, and FIG. 41 is a cross-sectional configuration diagram illustrating a configuration model example of each pixel. The pixels 100 include a photodiode (PD) 106 which converts light into electricity (signal charge), an FD amplifier 107 which amplifies an electric signal, and a row selecting transistor (Tr) 108 which makes up a row selection switch. With each of the pixels 100, on/off of the row selecting transistor 108 is switched at a row selection line 109 by the vertical scanning circuit 102, and the electric signal amplified at the FD amplifier 107 is output to a column signal line 105.

The FD amplifier 107 includes a charge detecting unit (FD) 110, a reset transistor 111, and an amplifier transistor 112, and has a function to amplify charge subjected to photoelectric conversion during a storage period.

That is to say, with the FD amplifier 107, upon the storage period being completed, the charge detecting unit 110 is reset by a reset line 113 making up a reset gate (Rst) before a signal is output. The voltage of charge detecting unit 110 which has been reset is connected to the gate of the amplifier transistor 112, and accordingly, a reset level that is in a state in which there is no signal is output from the source of the amplifier transistor 112 to the column signal line 105.

Immediately thereafter, signal charge is read out from the photodiode 106 to the charge detecting unit 110 by a row readout line 114 making up a readout gate (Rd), and upon the row readout line 114 being closed after transfer, the voltage of the charge detecting unit 110 varies for the worth equivalent to the intensity of light input to the photodiode 106, and accordingly, a signal level that is in a certain state of a signal is output from the amplifier transistor 112 to the column signal line 105.

Note that the photodiode 106 shown in FIG. 41 has a configuration referred to as an embedded photodiode wherein a P layer region 106b is formed on the surface of an N layer region 106a, wherein the P layer region 106b prevents occurrence of dark current, and FPN (Fixed Pattern Noise) due to dark current has been improved.

### Layout Example of Optical Communication Unit of Solid-State Imaging Device According to Each Embodiment

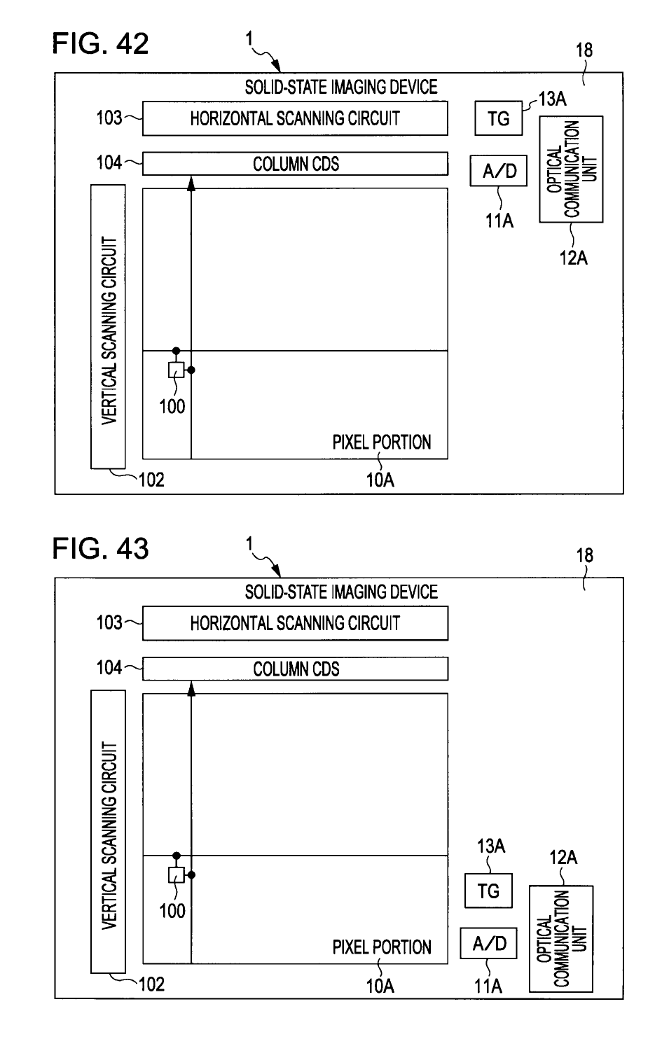

FIGS. 42 through 45 are functional block diagrams illustrating a layout example of an optical communication unit with a solid-state imaging device according to each embodiment. The solid-state imaging device 1 shown in FIGS. 42 through 45 is configured of a CMOS image sensor. Also, signal lines such as the bus and so forth are omitted here. Now, in FIGS. 42 through 45, with the square substrate 18, a side where the horizontal scanning circuit 103 and the column CDS circuit 104 are formed will be referred to as the upper side, and the opposite side thereof will be referred to as the lower side. Also, a side where the vertical scanning circuit 102 is formed will be referred to as the left side, and the opposite side thereof will be referred to as the right side.

With the example in FIG. 42, the optical communication unit 12A, A/D conversion unit 11A, and timing generator 13A are disposed at a right upper corner portion in the vicinity of the column CDS circuit 104 formed on the upper side of the substrate 18. With such a layout, the column CDS circuit 104 and A/D conversion circuit 11A, and the A/D conversion unit 11A and optical communication unit 12A are disposed close, and accordingly, the length of a wiring where an electric signal to be read out from the pixel portion 10A passes can be reduced.

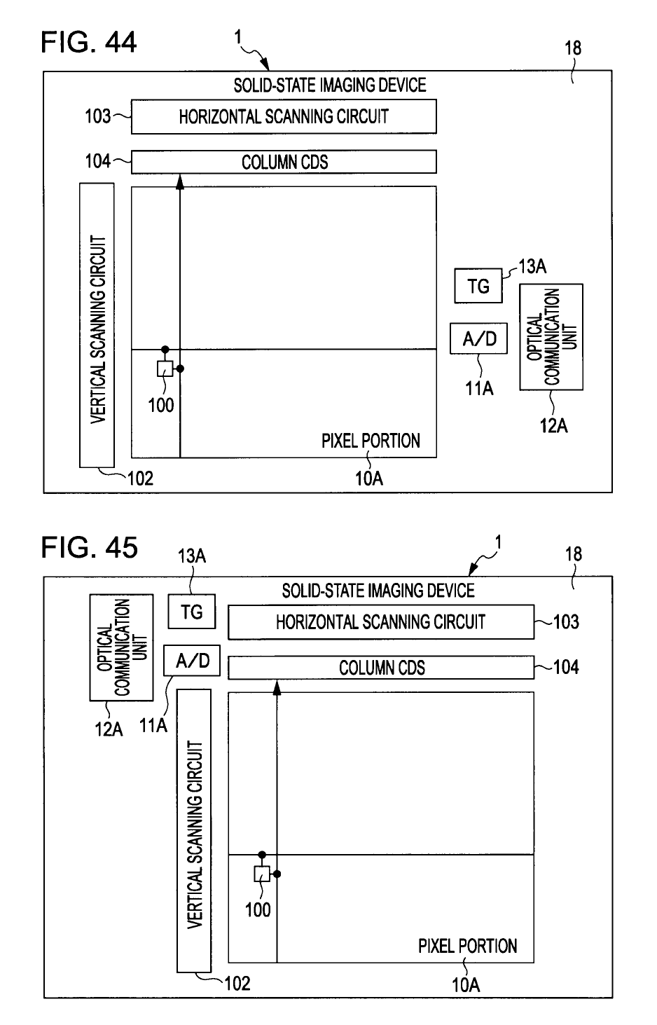

With the example in FIG. 43, the optical communication unit 12A, A/D conversion unit 11A, and timing generator 13A are disposed at a right lower corner portion of the substrate 18, at the lower side of opposite of the column CDS circuit 104. Also, with the example in FIG. 44, the optical communication unit 12A, A/D conversion unit 11A, and timing generator 13A are disposed in a right edge portion near the vertical center of the substrate 18. With layouts such as shown in FIGS. 43 and 44, the optical communication unit 12A serving as a heat source can be separated from the column CDS circuit 104 and so forth.

With the example in FIG. 45, the optical communication unit 12A, A/D conversion unit 11A, and timing generator 13A are disposed at a left upper corner portion of the substrate 18 near the column CDS circuit 104 formed at the upper side of the substrate 18. With such a layout, the optical communication unit 12A serving as a heat source is disposed on the outside of the vertical scanning circuit 102, whereby the optical communication unit 12A can be separated from the pixel portion 10A.

### Layout Example of Optical Communication Unit According to Configuration of Each Increment Pixel Self

With the pixel portion 10A of the solid-state imaging device 1, there is a case where read out of pixel data is executed with multi-line such that readout is executed in increments of pixels having a similar property. In the case that pixel data to be read out with multi-line is transmitted with a single optical communication unit, signal lines where high-speed parallel signals after A/D conversion are transmitted at each readout line from the pixel portion 10A have to be wired over long distance to the optical communication unit. In the case of performing such electric wiring, there is a possibility that electromagnetic noise may frequently occur, and signal deterioration at a transmission path may become intense.

Therefore, the shortest length of a transmission path for an electric signal up to the optical communication unit is realized. Specifically, an arrangement is made wherein the A/D conversion unit is provided on the subsequent stage of each column CDS circuit corresponding to multi-line readout, and the optical communication unit is disposed as to the output of the A/D conversion unit, whereby transmission distance to the optical communication unit is reduced most.

Thus, a layout can be realized such that the optical communication units are grouped on one edge portion side of the solid-state imaging device. Accordingly, an arrangement may be made wherein heat generated at the optical communication units is cooled and radiated effectively.

### (1) Layout Example of Optical Communication Unit in Case of Multi-Line Readout According to Pixel Configuration

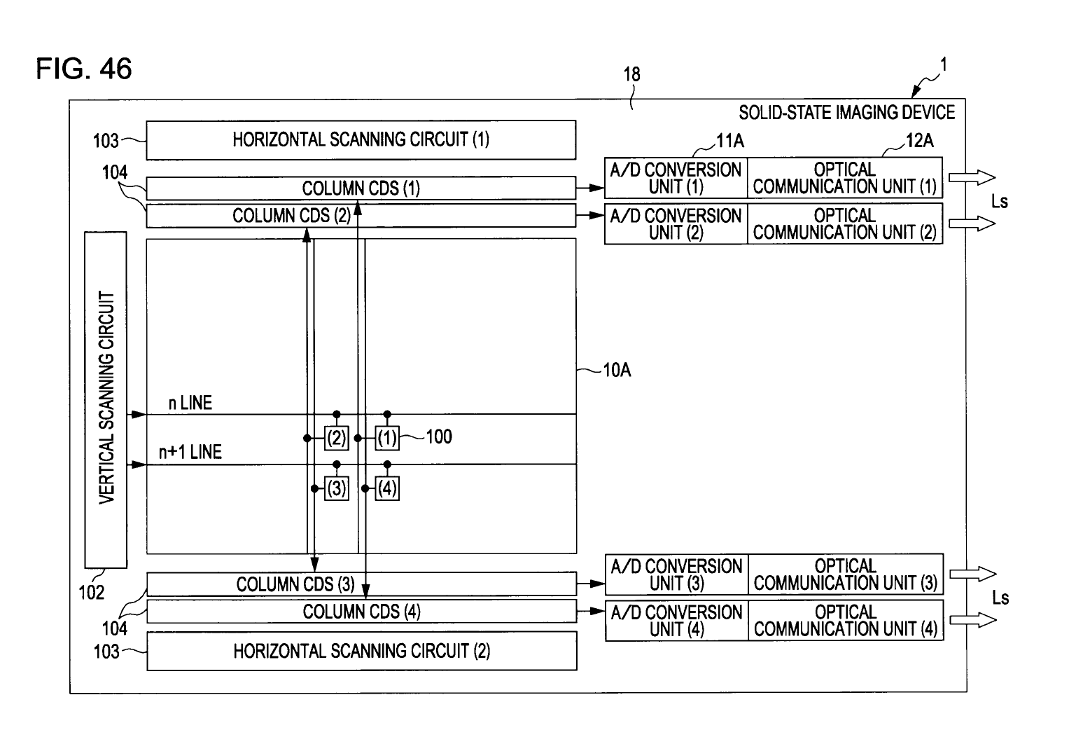

FIG. 46 is a schematic plan view illustrating a layout example of the optical communication units at the time of multi-line readout according to a pixel configuration. The solid-state imaging device 1 may have a configuration wherein a color filter is provided as to each pixel for the sake of color imaging. For example, pixels 100(1), 100(2), 100(3), and 100(4) have a color filter corresponding to a different wavelength. Examples of the color filter include a color filter corresponding to RGB, an infrared filter, and an ultraviolet filter. With the example in FIG. 46, color is taken as a classification axis, and for example, the optical communication unit is disposed according to a pixel filter.

With the present example, four column CDS circuits 104(1), 104(2), 104(3), and 104(4) are provided corresponding to the pixels 100(1) through 100(4) including a different color pixel filter, of the pixel portion 10A. Also, A/D conversion units 11A(1) through 11A(4) are provided on the subsequent stages of the column CDS circuits 104(1) through 104(4), respectively. Further, optical communication units 12A(1) through 12A(4) are provided as to the outputs of the A/D conversion units 11A(1) through 11A(4), respectively.

The positions where the column CDS circuits 104(1) and 104(2) are formed will be referred to as the upper side of the substrate 18, and the positions where the column CDS circuits 104(3) and 104(4) are formed will be referred to as the lower side of the substrate 18.

The A/D conversion unit 11A(1) is disposed on the right side of the column CDS circuit 104(1), and the optical communication unit 12A(1) is disposed on the right side of the A/D conversion unit 11A(1). Between the column CDS circuit 104(1) and the A/D conversion unit 11A(1), and between the A/D conversion unit 11A(1) and the optical communication unit 12A(1) are connected with a signal line made up of an electric wiring, respectively. The column CDS circuit 104(1), A/D conversion unit 11A(1), and optical communication unit 12A(1) are formed on the surface of the substrate 18, and accordingly, electric wiring between components may be formed on the surface of the substrate 18.

Similarly, the A/D conversion unit 11A(2) is disposed on the right side of the column CDS circuit 104(2), and the optical communication unit 12A(2) is disposed on the right side of the A/D conversion unit 11A(2). The A/D conversion unit 11A(3) is disposed on the right side of the column CDS circuit 104(3), and the optical communication unit 12A(3) is disposed on the right side of the A/D conversion unit 11A(3). The A/D conversion unit 11A(4) is disposed on the right side of the column CDS circuit 104(4), and the optical communication unit 12A(4) is disposed on the right side of the A/D conversion unit 11A(4).

Thus, the transmission distance between the A/D conversion units 11A(1) through 11A(4) and the optical communication units 12A(1) through 12A(4) is reduced most. Also, a layout may be employed wherein the optical communication units 12A(1) through 12A(4) are grouped at the right side edge portion of the solid-state imaging device 1.

Note that, with the description in FIG. 46, as a pixel configuration, a classification due to a color filter is taken as an axis. As a pixel configuration, other than this configuration, a classification corresponding to a photodiode making up a pixel may be taken as an axis. For example, the material of a photodiode making up a pixel, light reception sensitivity, intensity wavelength profile, or the like may be taken as a classification axis, or a configuration such as pixel embedded type PD, layered type PD, or the like may be taken as a classification axis.

### (2) Layout Example of Optical Communication Unit in Case of Multi-Line Readout According to Electric Shutter Timing

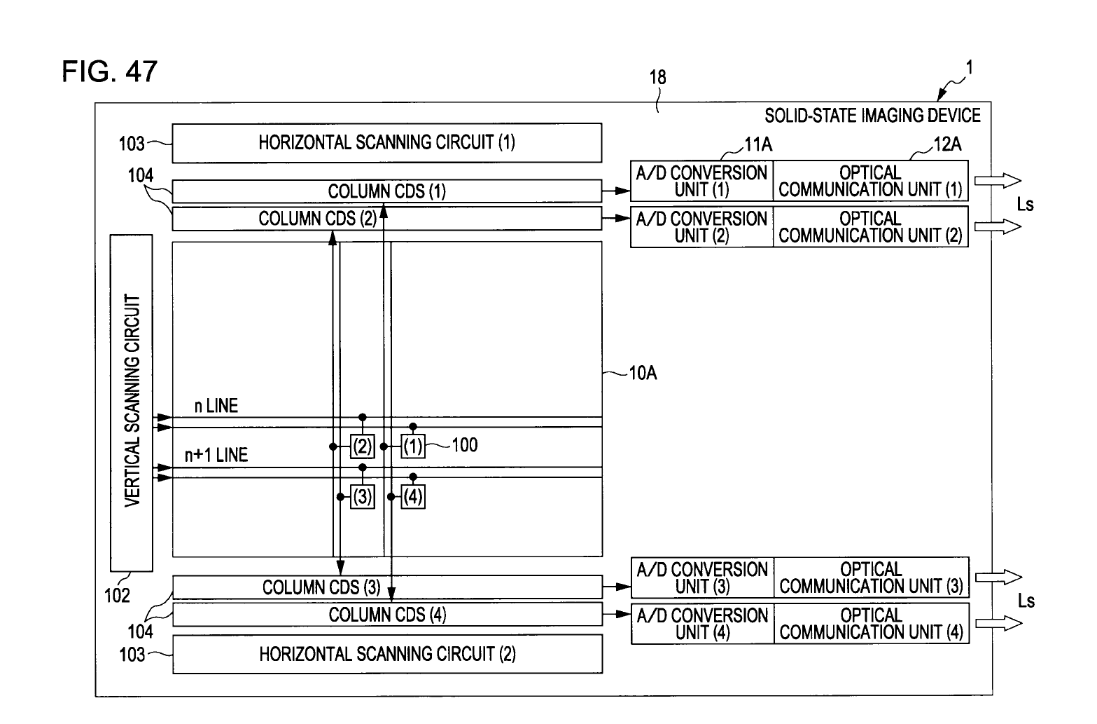

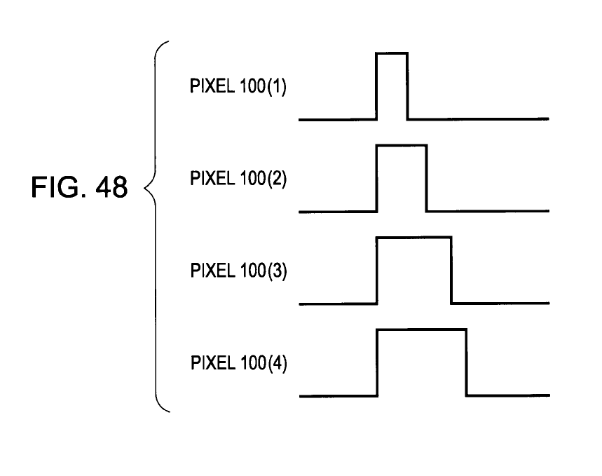

FIG. 47 is a schematic plan view illustrating a layout example of optical communication units at the time of multi-line readout according to electronic shutter timing. Also, FIG. 48 is a time chart illustrating electronic shutter timing and exposure time.

The solid-state imaging device 1 may have a configuration wherein the timing of an electric shutter is changed, such as shown in FIG. 48, with pixels 100(1) through 100(4), and accordingly, exposure time can be adjusted for each pixel. Therefore, with the example in FIG. 47, an optical communication unit is disposed based on the classification corresponding to exposure time.

With the present example, four column CDS circuits 104(1) through 104(4) are provided corresponding to pixels 100(1) through 100(4) having the same exposure time, of the pixel portion 10A. Also, A/D conversion units 11A(1) through 11A(4) are provided on the subsequent stages of the column CDS circuits 104(1) through 104(4), respectively. Further, optical communication units 12A(1) through 12A(4) are provided as to the outputs of the A/D conversion units 11A(1) through 11A(4), respectively.

The A/D conversion unit 11A(1) is disposed on the right side of the column CDS circuit 104(1), and the optical communication unit 12A(1) is disposed on the right side of the A/D conversion unit 11A(1). Between the column CDS circuit 104(1) and the A/D conversion unit 11A(1), and between the A/D conversion unit 11A(1) and the optical communication unit 12A(1) are connected with a signal line made up of an electric wiring, respectively. The column CDS circuit 104(1), A/D conversion unit 11A(1), and optical communication unit 12A(1) are formed on the surface of the substrate 18, and accordingly, electric wiring between components may be formed on the surface of the substrate 18.

Similarly, the A/D conversion unit 11A(2) is disposed on the right side of the column CDS circuit 104(2), and the optical communication unit 12A(2) is disposed on the right side of the A/D conversion unit 11A(2). The A/D conversion unit 11A(3) is disposed on the right side of the column CDS circuit 104(3), and the optical communication unit 12A(3) is disposed on the right side of the A/D conversion unit 11A(3). The A/D conversion unit 11A(4) is disposed on the right side of the column CDS circuit 104(4), and the optical communication unit 12A(4) is disposed on the right side of the A/D conversion unit 11A(4).

Thus, the transmission distance between the A/D conversion units 11A(1) through 11A(4) and the optical communication units 12A(1) through 12A(4) is reduced most. Also, a layout may be employed wherein the optical communication units 12A(1) through 12A(4) are grouped at the right side edge portion of the solid-state imaging device 1.

### (3) Layout Example of Optical Communication Unit in Case of Multi-Line Readout According to Pixel Readout Speed

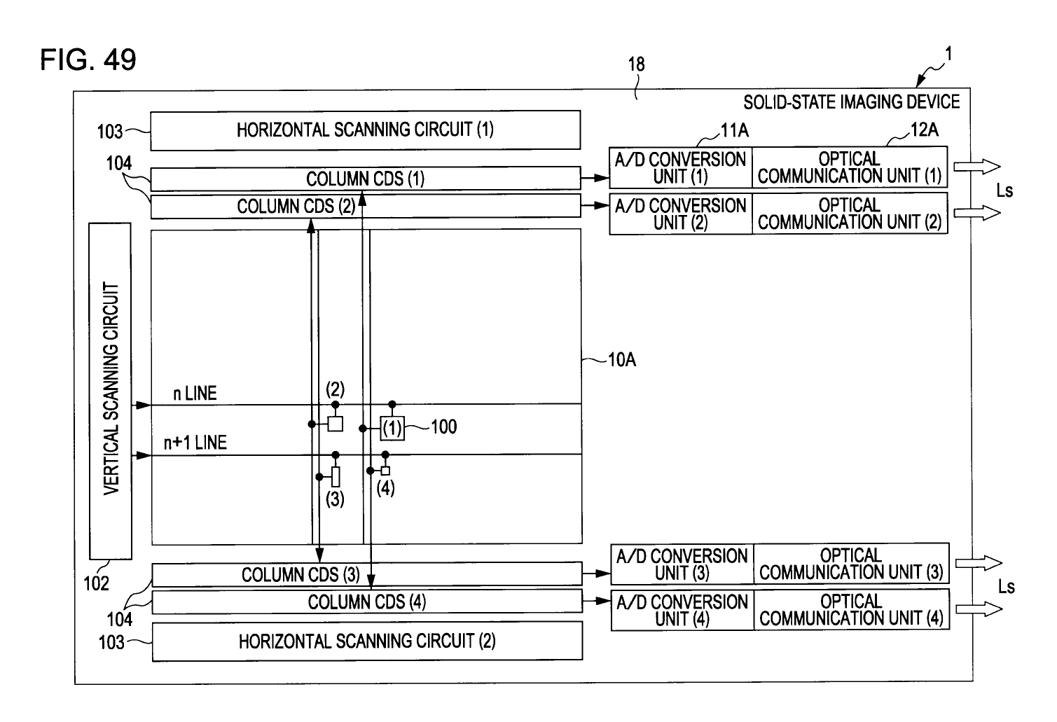

FIG. 49 is a schematic plan view illustrating a layout example of optical communication units at the time of multi-line readout according to pixel readout speed. The solid-state imaging device 1 may have a configuration wherein readout speed is changed according to the capacity or shape or the like of a pixel, such as shown in FIG. 49, with pixels 100(1) through 100(4).

With the present example, four column CDS circuits 104(1) through 104(4) are provided corresponding to pixels 100(1) through 100(4) having the same readout speed, of the pixel portion 10A. Also, A/D conversion units 11A(1) through 11A(4) are provided on the subsequent stages of the column CDS circuits 104(1) through 104(4), respectively. Further, optical communication units 12A(1) through 12A(4) are provided as to the outputs of the A/D conversion units 11A(1) through 11A(4), respectively.

The A/D conversion unit 11A(1) is disposed on the right side of the column CDS circuit 104(1), and the optical communication unit 12A(1) is disposed on the right side of the A/D conversion unit 11A(1). Between the column CDS circuit 104(1) and the A/D conversion unit 11A(1), and between the A/D conversion unit 11A(1) and the optical communication unit 12A(1) are connected with a signal line made up of an electric wiring, respectively. The column CDS circuit 104(1), A/D conversion unit 11A(1), and optical communication unit 12A(1) are formed on the surface of the substrate 18, and accordingly, electric wiring between components may be formed on the surface of the substrate 18.

Similarly, the A/D conversion unit 11A(2) is disposed on the right side of the column CDS circuit 104(2), and the optical communication unit 12A(2) is disposed on the right side of the A/D conversion unit 11A(2). The A/D conversion unit 11A(3) is disposed on the right side of the column CDS circuit 104(3), and the optical communication unit 12A(3) is disposed on the right side of the A/D conversion unit 11A(3). The A/D conversion unit 11A(4) is disposed on the right side of the column CDS circuit 104(4), and the optical communication unit 12A(4) is disposed on the right side of the A/D conversion unit 11A(4).

Thus, the transmission distance between the A/D conversion units 11A(1) through 11A(4) and the optical communication units 12A(1) through 12A(4) is reduced most. Also, a layout may be employed wherein the optical communication units 12A(1) through 12A(4) are grouped at the right side edge portion of the solid-state imaging device 1.

Note that, as a pixel configuration wherein the layout of an optical communication unit is classified, a pixel configuration other than the above examples may be employed such as a pixel configuration according to the amplifier (FD amplifier) included in each pixel, lens included in each pixel, waveguide configuration, or the like.

As described above, readout of a pixel is executed in increments of being classified according to the property or the like of a pixel, whereby the same correction can be executed in increments of the same property with the subsequent process. With a configuration wherein readout is executed with multi-line from the pixel portion 10A, an A/D conversion unit is disposed on the subsequent stage of each column CDS circuit, and an optical communication unit is disposed to the output of the A/D conversion unit, whereby the wiring length of electric wiring can be reduced most.

### Layout Example of Optical Communication Unit According to Pixel Readout Method

With the pixel portion 10A of the solid-state imaging device 1, in the case that the pixel portion 10A is divided into multiple areas, and readout is executed fore each area, readout of pixel data is executed with multi-line. In the case that pixel data to be read out with multi-line is transmitted with a single A/D conversion unit and a single optical communication unit, analog transmission over long distance, or high-speed parallel digital transmission over long distance has to be executed. In the case that such electric wiring is performed, there is a possibility that electromagnetic noise may frequently occur, and signal deterioration at a transmission path may become intense.

Therefore, optimization of transmission distance is executed by disposing an optical communication unit around the pixel portion. Specifically, an arrangement is made wherein an A/D conversion unit is provided on the subsequent stage of each column CDS circuit corresponding to multi-line readout, and an optical communication unit is disposed as to the output of the A/D conversion unit, whereby the transmission distance to the optical communication unit is reduced most.

Thus, a layout can be realized wherein optical communication units are disposed discretely in the vicinity portion of the solid-state imaging device. Consequently, influence of heat and electromagnetic noise generated at the optical communication units can be distributed to the whole.

### (1) Layout Example of Optical Communication Unit in Case of Multi-Line Readout According to Area Readout

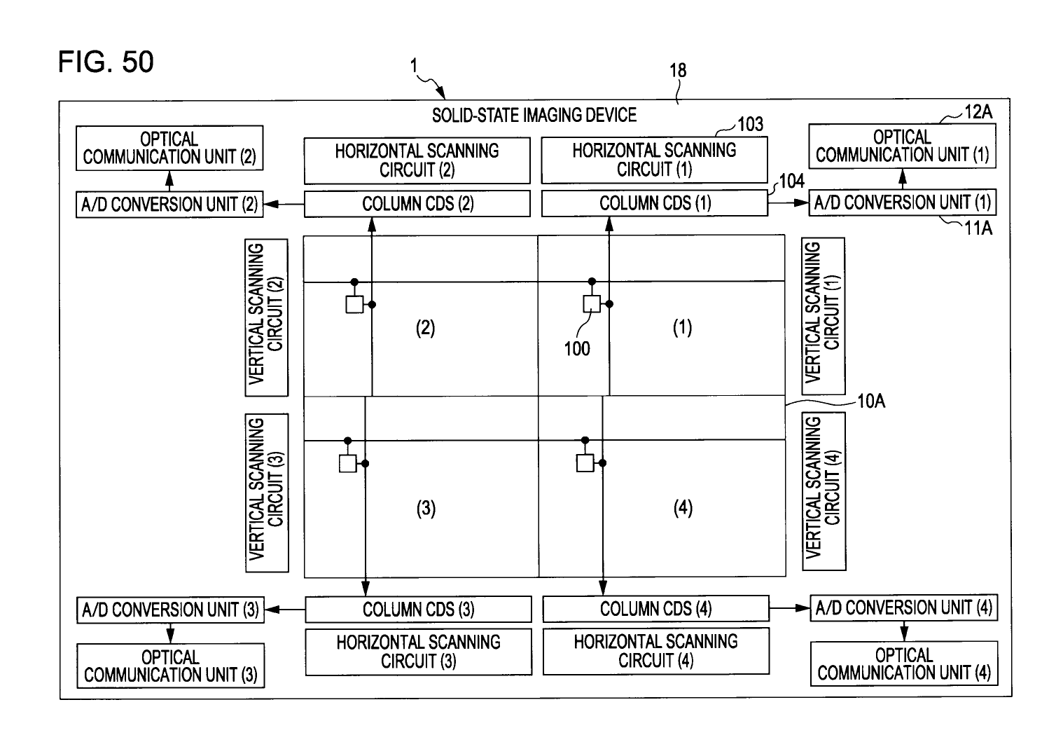

FIG. 50 is a schematic plan view illustrating a layout example of optical communication units at the time of multi-line readout according to area readout. The solid-state imaging device 1 has a configuration wherein the pixel portion 10A is divided into multiple areas, four areas (1) through (4) in the present example, and readout is executed. Four vertical scanning circuits 102(1) through 102(4), and four horizontal scanning circuits 103(1) through 103(4) are provided corresponding to the readout areas (1) through (4) of the pixel portion 10A.

Also, four column CDS circuits 104(1) through 104(4) are provided. Further, A/D conversion units 11A(1) through 11A(4) are provided on the subsequent stages of the column CDS circuits 104(1) through 104(4), respectively. Also, optical communication units 12A(1) through 12A(4) are provided as to the outputs of the A/D conversion units 11A(1) through 11A(4), respectively.

The A/D conversion unit 11A(1) is disposed on the right side of the column CDS circuit 104(1), and the optical communication unit 12A(1) is disposed on the upper side of the A/D conversion unit 11A(1). Between the column CDS circuit 104(1) and the A/D conversion unit 11A(1), and between the A/D conversion unit 11A(1) and the optical communication unit 12A(1) are connected with a signal line made up of an electric wiring, respectively. The column CDS circuit 104(1), A/D conversion unit 11A(1), and optical communication unit 12A(1) are formed on the surface of the substrate 18, and accordingly, electric wiring between components may be formed on the surface of the substrate 18.

Similarly, the A/D conversion unit 11A(2) is disposed on the left side of the column CDS circuit 104(2), and the optical communication unit 12A(2) is disposed on the upper side of the A/D conversion unit 11A(2). The A/D conversion unit 11A(3) is disposed on the left side of the column CDS circuit 104(3), and the optical communication unit 12A(3) is disposed on the lower side of the A/D conversion unit 11A(3). The A/D conversion unit 11A(4) is disposed on the right side of the column CDS circuit 104(4), and the optical communication unit 12A(4) is disposed on the lower side of the A/D conversion unit 11A(4).

Thus, the transmission distance between the A/D conversion units 11A(1) through 11A(4) and the optical communication units 12A(1) through 12A(4) is reduced most. Also, as to the column CDS circuits 104(1) and 104(4) disposed on the right side of the solid-state imaging device 1, the A/D conversion units 11A(1) and 11A(4), and the optical communication units 12A(1) and 12A(4) are disposed lateral to the right side. On the other hand, as to the column CDS circuits 104(2) and 104(3) disposed on the left side of the solid-state imaging device 1, the A/D conversion units 11A(2) and 11A(3), and the optical communication units 12A(2) and 12A(3) are disposed lateral to the left side. Thus, the optical communication units 12A(1) through 12A(4) can be disposed discretely on the edge portion side in the vicinity of the solid-state imaging device 1, e.g., four corner portions.

### (2) Layout Example of Optical Communication Unit in Case of Multi-Line Readout According to French-Door Readout

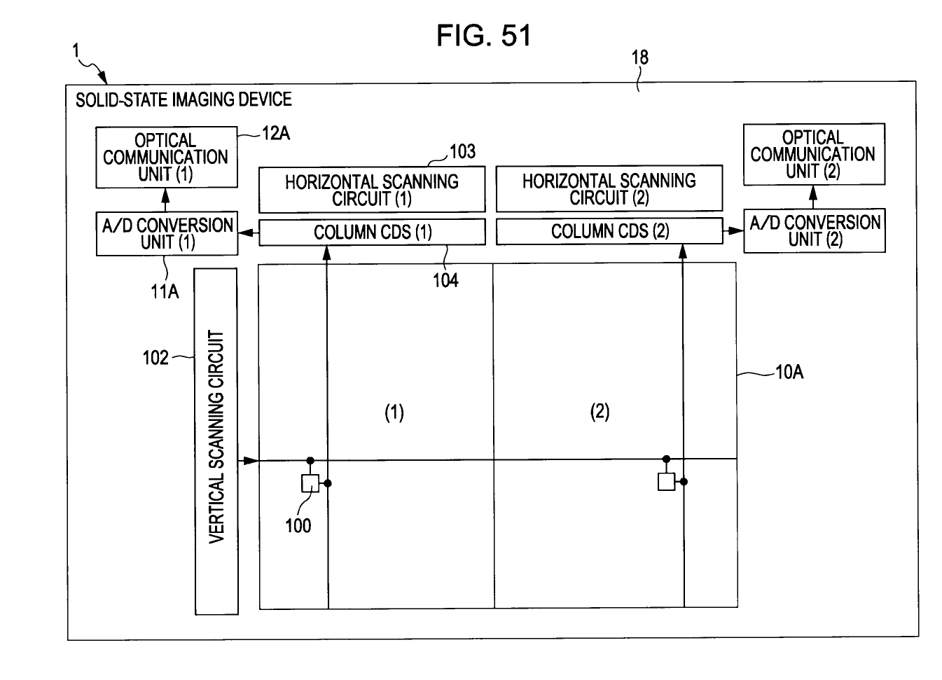

FIG. 51 is a schematic plan view illustrating a layout example of optical communication units at the time of multi-line readout according to door-door readout. The solid-state imaging device 1 has a configuration wherein the pixel portion 10A is divided into two areas (1) and (2) on either side, and readout is executed. Such readout is referred to as door-door readout. Two horizontal scanning circuits 103(1) and 103(2) are provided corresponding to the readout areas (1) and (2) of the pixel portion 10A.

Also, two column CDS circuits 104(1) and 104(2) are provided. Further, A/D conversion units 11A(1) and 11A(2) are provided on the subsequent stages of the column CDS circuits 104(1) and 104(2), respectively. Also, optical communication units 12A(1) and 12A(2) are provided as to the outputs of the A/D conversion units 11A(1) and 11A(2), respectively.

The A/D conversion unit 11A(1) is disposed on the left side of the column CDS circuit 104(1), and the optical communication unit 12A(1) is disposed on the upper side of the A/D conversion unit 11A(1). Between the column CDS circuit 104(1) and the A/D conversion unit 11A(1), and between the A/D conversion unit 11A(1) and the optical communication unit 12A(1) are connected with a signal line made up of an electric wiring, respectively. The column CDS circuit 104(1), A/D conversion unit 11A(1), and optical communication unit 12A(1) are formed on the surface of the substrate 18, and accordingly, electric wiring between components may be formed on the surface of the substrate 18.

Similarly, the A/D conversion unit 11A(2) is disposed on the right side of the column CDS circuit 104(2), and the optical communication unit 12A(2) is disposed on the upper side of the A/D conversion unit 11A(2).

Thus, the transmission distance between the A/D conversion units 11A(1) and 11A(2) and the optical communication units 12A(1) and 12A(2) is reduced most. Also, as to the column CDS circuit 104(1) disposed on the left side of the solid-state imaging device 1, the A/D conversion unit 11A(1) and the optical communication unit 12A(1) are disposed lateral to the left side. On the other hand, as to the column CDS circuit 104(2) disposed on the right side of the solid-state imaging device 1, the A/D conversion unit 11A(2) and the optical communication unit 12A(2) are disposed lateral to the right side. Thus, the optical communication units 12A(1) through 12A(4) can be disposed discretely on the edge portion side in the vicinity of the solid-state imaging device 1, e.g., both edges of the upper side.

### (3) Layout Example of Optical Communication Unit in Case of Multi-Line Readout According to Field Readout

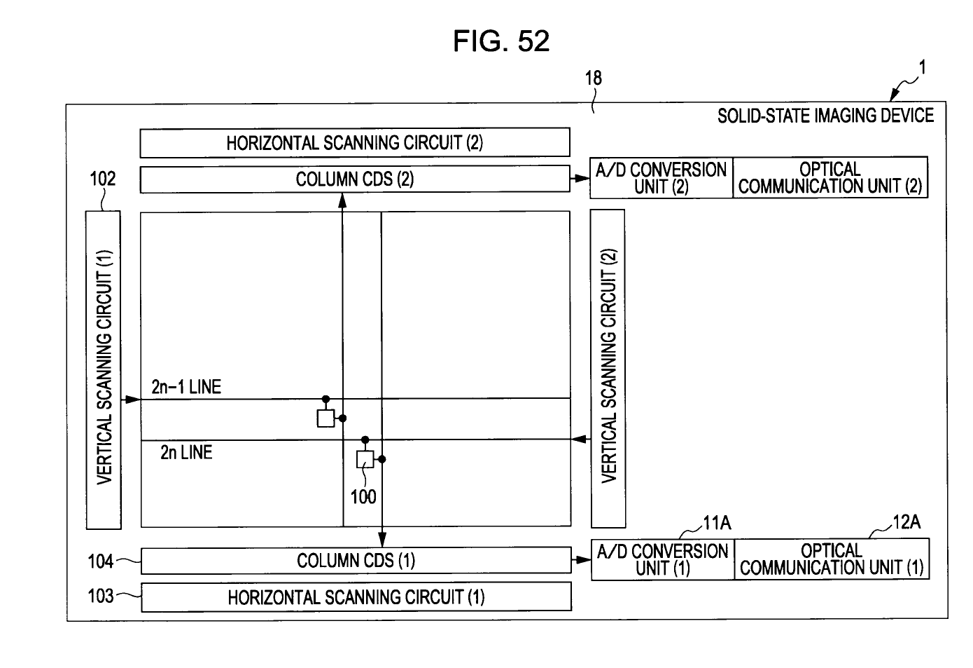

FIG. 52 is a schematic plan view illustrating a layout example of optical communication units at the time of multi-line readout according to field readout. The solid-state imaging device 1 has a configuration wherein readout is executed independently at an even line 2n and an odd line 2n-1 of the pixel portion 10A. Such readout is referred to as field readout. Two vertical scanning circuits 102(1) and 102(2), and two horizontal scanning circuits 103(1) and 103(2) are provided corresponding to an even field and an odd field of the pixel portion 10A.

Also, two column CDS circuits 104(1) and 104(2) are provided. Further, A/D conversion units 11A(1) and 11A(2) are provided on the subsequent stages of the column CDS circuits 104(1) and 104(2), respectively. Also, optical communication units 12A(1) and 12A(2) are provided as to the outputs of the A/D conversion units 11A(1) and 11A(2), respectively.

The A/D conversion unit 11A(1) is disposed on the right side of the column CDS circuit 104(1), and the optical communication unit 12A(1) is disposed on the right side of the A/D conversion unit 11A(1). Between the column CDS circuit 104(1) and the A/D conversion unit 11A(1), and between the A/D conversion unit 11A(1) and the optical communication unit 12A(1) are connected with a signal line made up of an electric wiring, respectively. The column CDS circuit 104(1), A/D conversion unit 11A(1), and optical communication unit 12A(1) are formed on the surface of the substrate 18, and accordingly, electric wiring between components may be formed on the surface of the substrate 18.

Similarly, the A/D conversion unit 11A(2) is disposed on the right side of the column CDS circuit 104(2), and the optical communication unit 12A(2) is disposed on the right side of the A/D conversion unit 11A(2).

Thus, the transmission distance between the A/D conversion units 11A(1) and 11A(2) and the optical communication units 12A(1) and 12A(2) is reduced most. Also, as to the column CDS circuit 104(1), sandwiching the pixel portion 10A of the solid-state imaging device 1, e.g., disposed on the lower side, the A/D conversion unit 11A(1) is disposed lateral to the right side. Similarly, as to the column CDS circuit 104(2) disposed on the upper side of the solid-state imaging device 1, the A/D conversion unit 11A(2) is disposed lateral to the right side. Thus, the optical communication units 12A(1) and 12A(2) can be disposed discretely on the edge portion side in the vicinity of the solid-state imaging device 1, e.g., the right edge.

### (4) Layout Example of Optical Communication Unit in Case of Multi-Line Readout According to Four-Pixel Addition Readout

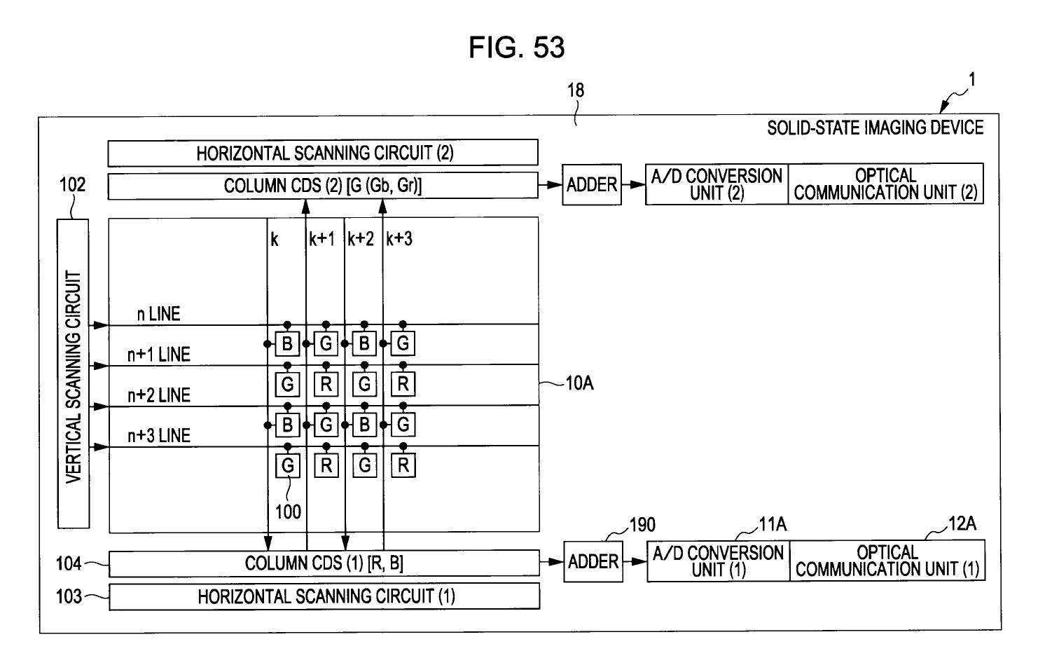

FIG. 53 is a schematic plan view illustrating a layout example of optical communication units at the time of multi-line readout according to four-pixel addition readout. The solid-state imaging device 1 has a configuration wherein R, Gb, Gr, and B color filters are included in the pixel portion 10A for the sake of colorization, and pixel signals are added regarding pixels corresponding to a specific wavelength (color), and readout is executed. With four-pixel addition readout, thinning of pixels, and averaging due to addition of surrounding pixels are executed, thereby reducing the number of pixels to be read out actually. Of pixels 100R, 100G, and 100B, pixel signals read out from pixels 100B positioned in (n, k), (n, k+2), (n+2, k), and (n+2, k+2) are added and output. Also, pixel signals read out from the pixels 100R and pixels 100G are added and output. Two horizontal scanning circuits 103(1) and 103(2) are provided corresponding to the pixels 100R and 100B, and pixel 100G(Gb, Gr).

Also, two column CDS circuits 104(1) and 104(2) are provided. Further, an adder 190 and an A/D conversion unit 11A(1) are provided on the subsequent stage of the column CDS circuit 104(1), and an adder 190 and an A/D conversion unit 11A(2) are provided on the subsequent stage of the column CDS circuit 104(2). Also, optical communication units 12A(1) and 12A(2) are provided as to the outputs of the A/D conversion units 11A(1) and 11A(2), respectively.

The A/D conversion unit 11A(1) is disposed on the right side of the column CDS circuit 104(1), and the optical communication unit 12A(1) is disposed on the right side of the A/D conversion unit 11A(1). Between the column CDS circuit 104(1), the adder 190, and the A/D conversion unit 11A(1), and between the A/D conversion unit 11A(1) and the optical communication unit 12A(1) are connected with a signal line made up of an electric wiring, respectively. The column CDS circuit 104(1), adder 190, A/D conversion unit 11A(1), and optical communication unit 12A(1) are formed on the surface of the substrate 18, and accordingly, electric wiring between components may be formed on the surface of the substrate 18.

Similarly, the A/D conversion unit 11A(2) is disposed on the right side of the column CDS circuit 104(2), and the optical communication unit 12A(2) is disposed on the right side of the A/D conversion unit 11A(2).

Thus, the transmission distance between the A/D conversion units 11A(1) and 11A(2) and the optical communication units 12A(1) and 12A(2) is reduced most. Also, as to the column CDS circuit 104(1), sandwiching the pixel portion 10A of the solid-state imaging device 1, e.g., disposed on the lower side, the A/D conversion unit 11A(1) is disposed lateral to the right side. Similarly, as to the column CDS circuit 104(2) disposed on the upper side of the solid-state imaging device 1, the A/D conversion unit 11A(2) is disposed lateral to the right side. Thus, the optical communication units 12A(1) and 12A(2) can be disposed discretely on the edge portion side in the vicinity of the solid-state imaging device 1, e.g., the right edge.

### Embodiment of Optical Communication Unit According to Signal Transmission Mode

With the solid-state imaging device 1, the output signal after A/D conversion at the A/D conversion unit 11A described in FIG. 2 and others becomes a parallel signal equivalent to the number of bits stipulated with the resolution of the A/D conversion unit. Description will be made regarding the optimal embodiment of an optical communication unit according to signal transmission to realize signal transmission of multiple bits by optical communication.

### (1) Parallel Transmission Example Using Arrayed Optical Communication Units

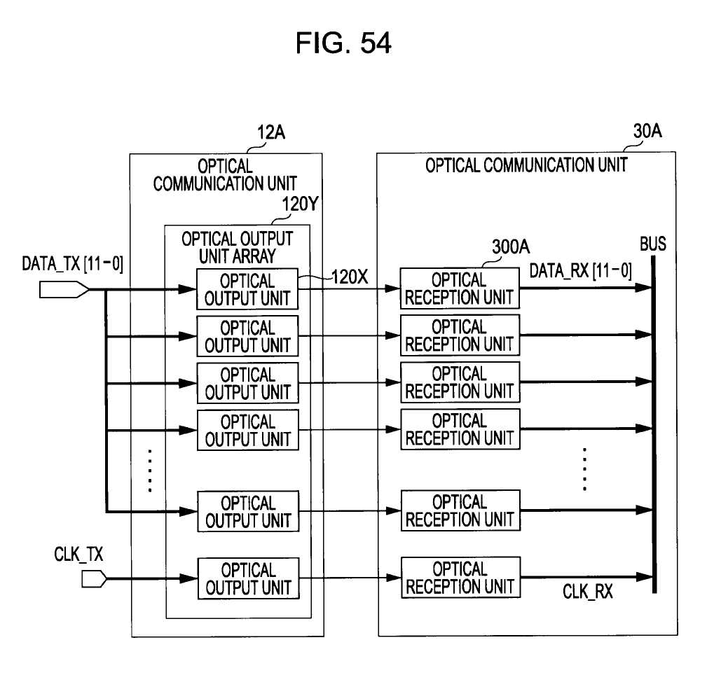

FIG. 54 is a functional block diagram illustrating an example of arrayed optical communication units. Next, the optimal embodiment of optical communication units according to parallel transmission will be described.

The optical communication unit 12A of the solid-state imaging device 1 includes an optical output unit array 120Y in which optical output units 120X made up of a self-emitting light emitting element or external-modulating optical modulator are arrayed. With the optical output unit array 120Y, the optical output units 120X are arrayed in parallel for the worth of the number of optical signal lines made up of data lines wherein pixel data DATA_TX converted into a digital signal at the A/D conversion unit 11A is output, and a clock line wherein a clock signal CLK_TX is output.

The solid-state imaging device 1 executes, as described above, optical communication with the optical communication unit 30A of the signal processing apparatus 3A described in FIG. 34. Therefore, with the optical communication unit 30A of the signal processing apparatus 3A, optical reception units 300A are arrayed in parallel for the worth of the number of optical signal lines output from the solid-state imaging device 1.

With the solid-state imaging device 1, the pixel data DATA_TX A/D-converted at the A/D conversion unit 11A described in FIG. 39, and the clock signal CLK_TX generated at the timing generator 13A are input to the optical communication unit 12A. The pixel data DATA_TX and clock signal CLK_TX converted into digital signals are converted into signal light at the corresponding optical output unit 120X of the optical output unit array 120Y, and are output.

The optical signals output from the optical communication unit 12A of the solid-state imaging device 1 are input to the optical communication unit 30A of the signal processing apparatus 3A, converted into electric signals at the corresponding optical reception units 300A respectively, whereby pixel data DATA_RX and a clock signal CLK_RX are output.

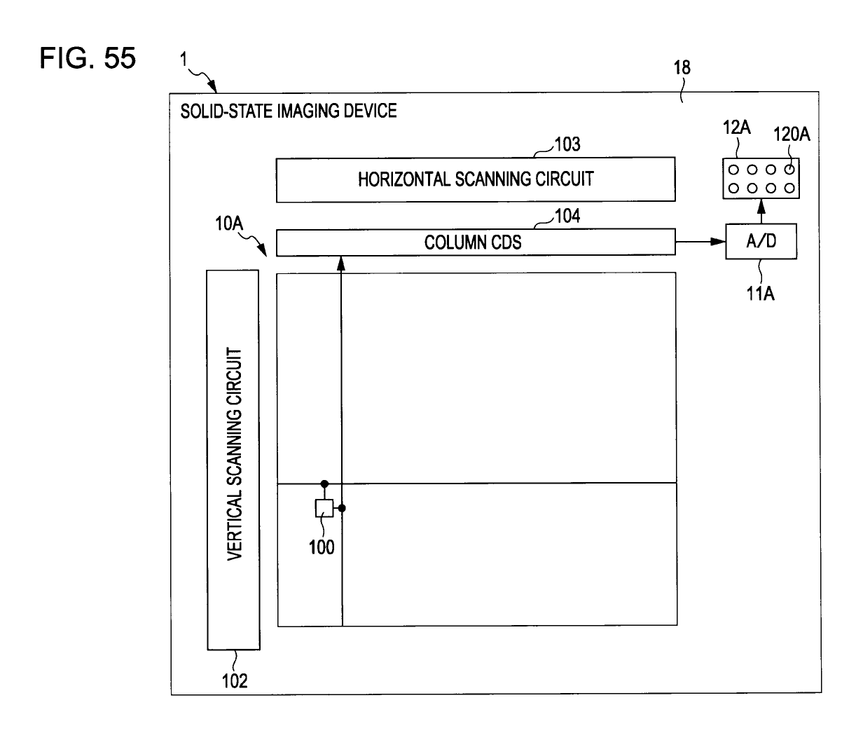

FIG. 55 is a schematic plan view of a solid-state imaging device illustrating a layout example of an optical communication unit which executes parallel transmission. In the case of a configuration including a single optical communication unit, the operation frequency of the optical communication unit becomes extremely high. Also, a processing unit to serialize data has to be provided, which leads to increase in cost in some cases. Therefore, with the example shown in FIG. 55, there is provided an optical communication unit 12A in which multiple optical output units 120A are arrayed. Pixel data is transmitted in parallel, whereby a processing unit such as a serial interface or the like does not have to be provided. Also, the operation frequency of each optical output unit 120A can be suppressed low as compared to the case of serial transmission, whereby load can be reduced. Thus, heat and occurrence of electromagnetic noise can be suppressed, and accordingly, improvement in communication quality can be realized. Also, the optical output units 120A are arrayed, whereby integrated formation can be carried out together, which reduces costs.

### (2) Serial Transmission Example Using Serialization of Data

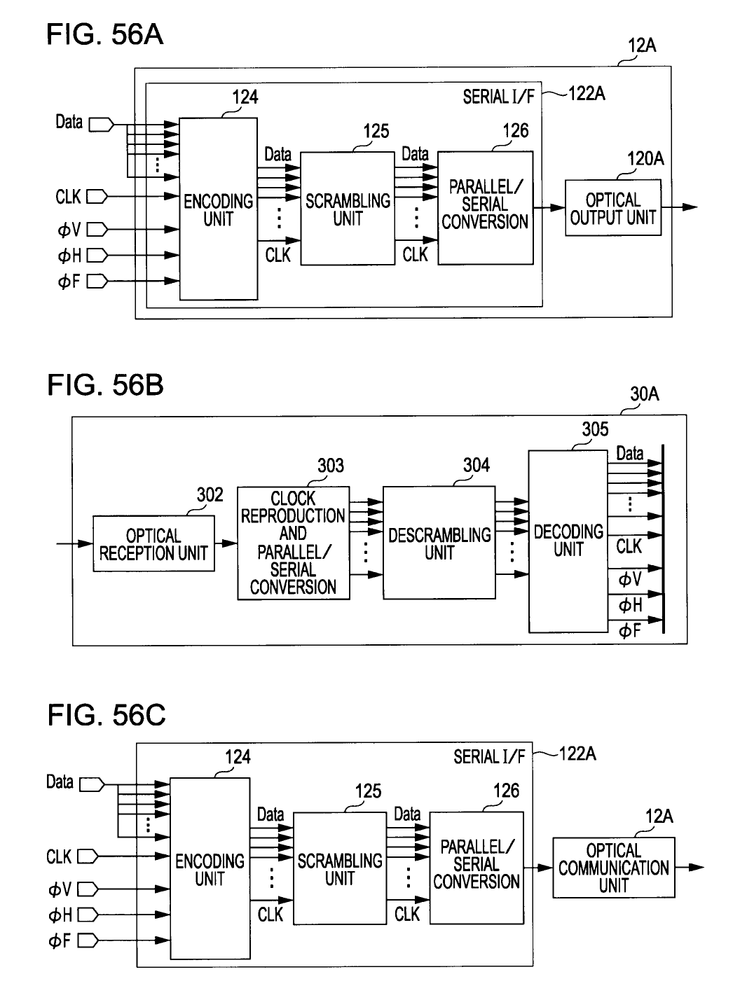

FIGS. 56A through 56C are functional block diagrams illustrating an example of an optical communication unit which serializes pixel data to execute optical communication. Next, the optimal embodiment of an optical communication unit according to serial transmission will be described.

With a configuration wherein pixel data converted into a digital signal at the A/D conversion unit 11A is transmitted in parallel, channels occur for the worth of the number of bits of pixel data stipulated with the number of bits of the A/D conversion unit. Therefore, upon the number of bits of pixel data increasing according to increase in the number of pixels, there is a possibility that the number of optical communication units may increase. Increase in the number of optical communication units leads to increase in costs. Also, with a configuration including an optical communication unit in which optical output units are arrayed as described above to handle increase in the number of bits of pixel data, the yield of heat at the optical communication unit increases. On the other hand, with a configuration wherein optical communication units including a single optical output unit are disposed discretely in the vicinity portion of the substrate, influence of heat and electromagnetic noise generated at each of the optical communication units can be reduced. However, sources for generating heat and electromagnetic noise are distributed, and accordingly, there is a possibility that management of heat and electromagnetic noise may become difficult.

Therefore, serialization of data is executed according to parallel property of signal transmission, and the number of mountable optical communication units, and the wiring, layout, and configuration of the optical communication units are determined. Thus, the number of the optical communication units is reduced so as to suppress occurrence of heat and electromagnetic noise.

That is to say, the optical communication unit 12A of the solid-state imaging device 1 serving as an example shown in FIG. 56A includes a serial interface (I/F) 122A which converts the pixel data converted into a digital signal at the A/D conversion unit 11A described in FIG. 39 into serial data.

The serial interface 122A includes an encoding unit 124 which superposes the pixel data DATA A/D-converted at the A/D conversion unit 11A, and a synchronizing signal generated at the timing generator 13A. The clock signal CLK generated at the timing generator 13A is input to the encoding unit 124. Also, the vertical synchronizing signal φV used for driving the vertical scanning circuit 102, the horizontal synchronizing signal φH used for driving the horizontal scanning circuit 103, and the field signal F used for selecting a field, which have been generated at the timing generator 13A, are input to the encoding unit 124. The encoding unit 124 employs, for example, the 8b/10b method to superpose the clock signal and the synchronizing signal on the data line to transmit these signals using one signal line.

Also, the serial interface 122A includes a data scrambling unit 125 which scrambles the pixel data on which the synchronizing signal has been superposed, and a parallel/serial conversion unit 126 which converts the scrambled pixel data on which the synchronizing signal has been superposed into serial data. Further, the optical communication unit 12A includes an optical output unit 120A which converts the serialized pixel data and synchronizing signal into an optical signal, and outputs this.

As shown in FIG. 56B, the optical communication unit 30A of the signal processing apparatus 3A includes an optical reception unit 302 which inputs the serialized pixel data and synchronizing signal as an optical signal, and converts the input optical signal into an electric signal. Also, the optical communication unit 30A includes a serial/parallel conversion unit 303 which reproduces a clock from the serialized pixel data and synchronizing signal, and detects the pixel data. Further, the optical communication unit 30A includes a descrambling unit 304 which descrambles the pixel data on which the synchronizing signal has been superposed, and a decoding unit 305 which detects the synchronizing signal.

With the solid-state imaging device 1 including the optical communication unit 12A which serializes pixel data to execute optical communication, the serial signal wherein the clock signal and synchronizing signal have been superposed on the data line by the serial interface 122A is transmitted from the serial interface 122A to the optical output unit 120A.

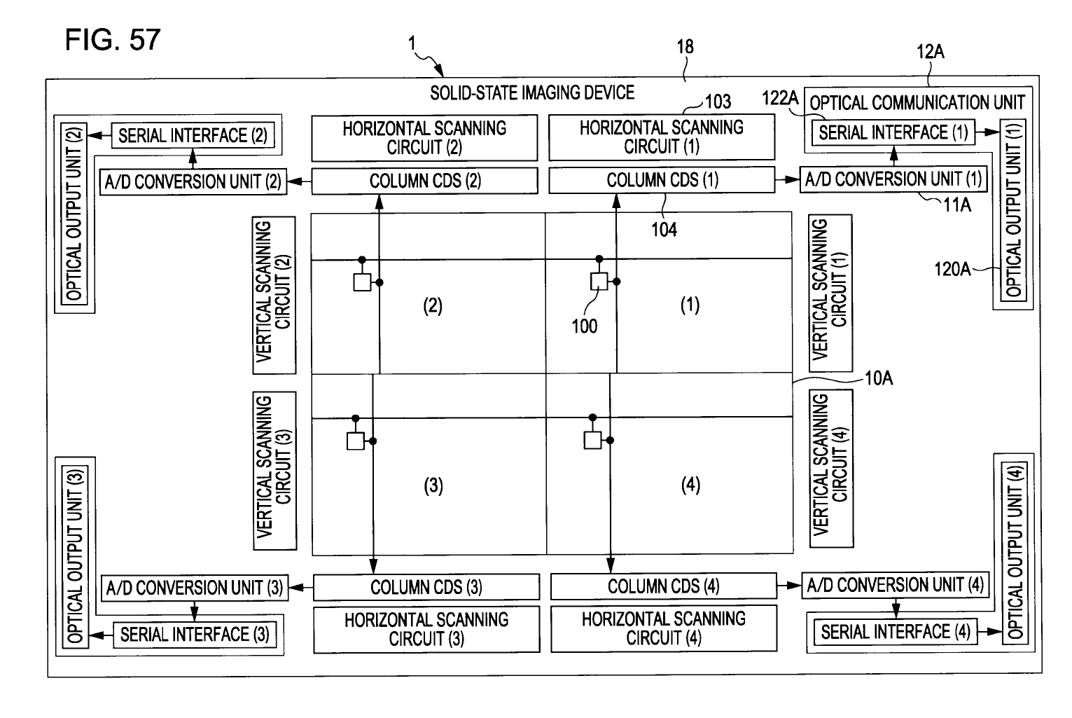

FIG. 57 is a schematic plan view of a solid-state imaging device illustrating a layout example of optical communication units which execute serial transmission. With the area readout example described in FIG. 50, the optical communication units 12A for the worth of the number of areas divided from the single pixel portion 10A are employed. Therefore, the transmission speed at each of the optical communication units 12A is suppressed low as compared to the case of transmitting the whole pixel portion data using a single optical communication unit.

Therefore, the serial interface 122A described in FIGS. 56A through 56C is provided at the output of each A/D conversion unit 11A. With the serial interface 122A, the synchronizing signal and clock signal are superposed on the data signal, and is serialized to generate a digital signal, whereby signal transmission can be executed using a single channel. Thus, each of the optical communication units 12A should include a single optical output unit 120A, whereby the number of the optical output units 120A can be reduced even with multi-bit use accompanied with increase in the number of pixels. Note that, as shown in FIG. 56C, the serial interface 122A may be provided as a function block independent from the optical communication units 12A.

### (3) Multi-Transmission Example According to Serialization of Pixel Data and Multiple Optical Output Units

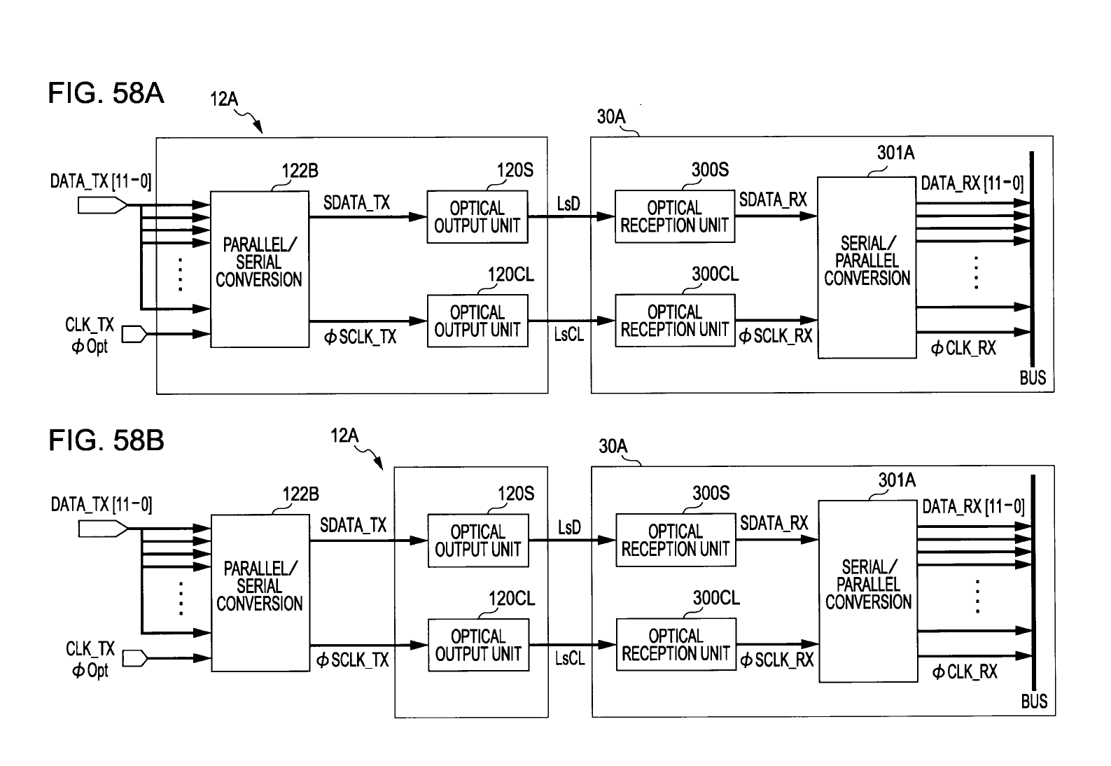

FIGS. 58A and 58B are functional block diagrams illustrating an example of an optical communication unit which serializes pixel data to execute optical communication using multiple optical output units. Next, description will be made regarding the optimal embodiment of an optical communication unit according to multi-transmission of serialized pixel data and a clock single.

The optical communication unit 12A of the solid-state imaging device 1A of the example shown in FIG. 58A includes a parallel/serial (P/S) conversion unit 122B which converts pixel data DATA_TX A/D-converted at the A/D conversion unit 11A into serial data. The pixel data DATA_TX A/D-converted at the A/D conversion unit 11A, and a clock signal CLK_TX generated at the timing generator 13A are input to the parallel/serial conversion unit 122B.

Also, the optical communication unit 12A includes an optical output unit 120S which converts serialized pixel data SDATA_TX into an optical signal and outputs this, and an optical output unit 120CL which converts a clock signal φSCLK_TX into an optical signal and outputs this.

The optical communication unit 30A of the signal processing apparatus 3A includes an optical reception unit 300S which inputs the pixel data SDATA_TX serialized and converted into an optical signal by way of a data line LsD according to optical communication, and converts the input optical signal into pixel data SDATA_RX serving as a serialized electric signal. Also, the optical communication unit 30A includes an optical reception unit 300CL which inputs the clock signal φSCLK_TX converted into an optical signal by way of a clock line LsCL according to optical communication, and converts the input optical signal into a clock signal φSCLK_RX serving as an electric signal.

Further, the optical communication unit 30A includes a serial/parallel conversion unit 301A which uses the clock signal φSCLK_RX converted into an electric signal at the optical reception unit 300CL to detect pixel data DATA_RX from the pixel data SDATA_RX converted into an electric signal at the optical reception unit 300S.

With the solid-state imaging device 1 including an optical communication unit 12A which serializes pixel data, and includes the data line LsD and the clock line LsCL to execute optical communication, the serial signal is transmitted from the parallel/serial conversion unit 122B to the optical output unit 120S. Also, the clock signal is transmitted from the parallel/serial conversion unit 122B to the output unit 120CL.

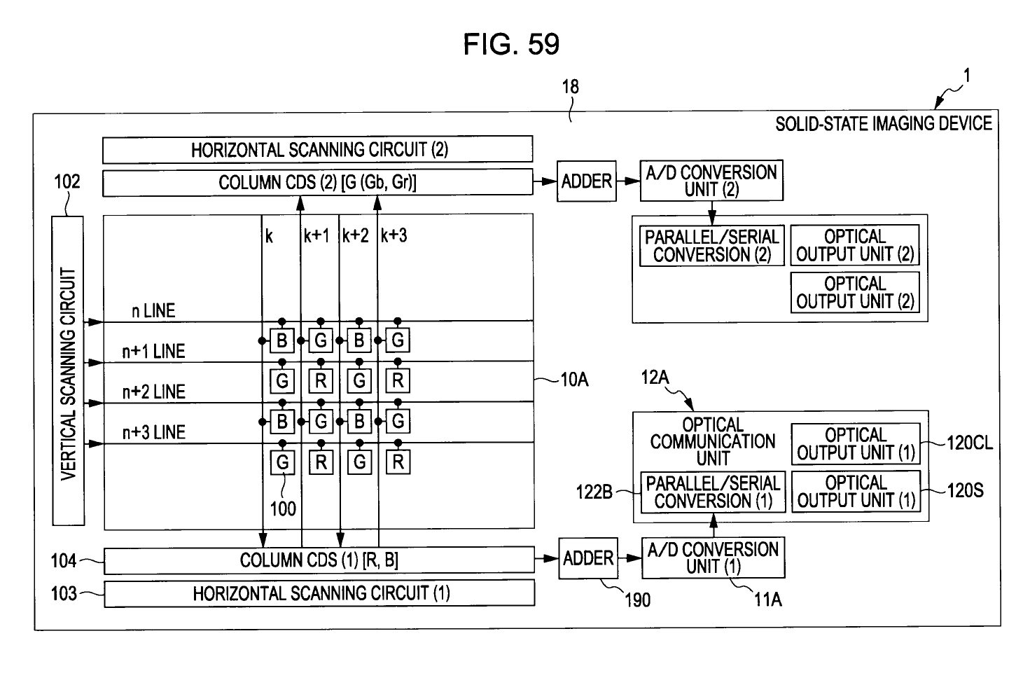

FIG. 59 is a schematic plan view of a solid-state imaging device illustrating a layout example of optical communication units which transmit a serialized data signal and a clock signal using independent channels. With the four-pixel addition readout described in FIG. 53, data transmission is executed at the two optical communication units 12A. Therefore, the parallel/serial conversion unit 122B described in FIGS. 58A and 58B is provided as to the output of each of the A/D conversion units 11A. With the parallel/serial conversion unit 122B, superposing of a clock signal is not executed, and accordingly, the circuit configuration is simple and reasonable. On the other hand, the data signals are serialized, whereby transmission can be executed with the two signal lines of the data line and the clock line.

Therefore, the optical communication unit 12A including the two optical output units 120S and 120CL is provided, whereby transmission of the data signal and clock signal can be executed. Thus, increase in costs due to increase in the number of optical communication units is suppressed low, and also load of the optical communication units can be decreased. Note that, as shown in FIG. 58B, the parallel/serial conversion unit 122B may be provided as a functional block independent from the optical communication units 12A.

Examples of Advantages of Solid-State Imaging Device with Optical Communication Units Disposed Grouped, Disposed Discretely, and Disposed Discretely Grouped

With the solid-state imaging devices according to the above embodiments, transmission of a pixel signal read out from a pixel portion is executed with an optical signal, and optical communication units are disposed grouped, disposed discretely, or disposed discretely grouped. Thus, optimization according to the layout of optical communication units can be realized regarding heat, electromagnetic noise, and false signals generated from the optical communication units, and effective removal of noise components can be executed.

Also, flexibility regarding the layout of optical communication units improves, whereby flexibility regarding the layout of cooling units of the optical communication units improves. Various cooling methods may be employed, for example, such as a method wherein optical communication units are disposed grouped, and are cooled together, a method wherein optical communication units are disposed discretely, and heat generating sources are cooled in a discrete manner, and so forth.

Further, flexibility regarding the layout of optical communication units improves, whereby various signal transmission methods may be employed, for example, such as parallel transmission, serial transmission wherein a synchronizing signal and a clock signal are superposed on a data line, multi-transmission of serialized data lines and clock signals, and so forth.

Also, optical communication units can be disposed according to a readout method from a pixel portion, whereby the optimal layout of optical communication units can be employed for each readout method, also a configuration can be selected according to readout data quantity or the like, whereby flexibility regarding the signal readout method of a solid-state imaging deice increases.

The present application contains subject matter related to that disclosed in Japanese Priority Patent Application JP 2008-264577 filed in the Japan Patent Office on Oct. 10, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A solid-state imaging device comprising:
a pixel portion configured to convert light into an electric signal;
a substrate where said pixel portion is formed;
an A/D conversion unit configured to convert a signal read out from said pixel portion into a digital signal; and
an optical communication unit configured to convert a signal digitized by said A/D conversion unit into an optical signal, and output the optical signal;
wherein said single optical communication unit or a plurality of said optical communication units are disposed grouped in the vicinity portion of said substrate around said pixel portion.

2. The solid-state imaging device according to claim 1, wherein said optical communication unit is disposed at the output of said A/D conversion unit.

3. The solid-state imaging device according to claim 1, further comprising:
a serial interface configured to convert a signal read out from said pixel portion and digitized at said A/D conversion unit into serial data;
wherein said optical communication unit converts a signal output from said serial interface into an optical signal, and outputs the optical signal.

4. The solid-state imaging device according to claim 2, wherein readout of a signal is executed in increments of being divided according to the property of each pixel or the position of each pixel from said pixel portion;
and wherein said A/D conversion unit is disposed as to each of a plurality of signal lines where a signal is read out from said pixel portion.

5. The solid-state imaging device according to claim 3, wherein readout of a signal is executed in increments of being divided according to the property of each pixel or the position of each pixel from said pixel portion;
and wherein said A/D conversion unit and said serial interface are disposed as to each of a plurality of signal lines where a signal is read out from said pixel portion.

6. The solid-state imaging device according to claim 1, said optical communication unit comprising at least in the vicinity thereof facing said pixel portion:
a cooling unit configured to cool heat generated at said optical communication unit.

7. A solid-state imaging device comprising:
a pixel portion configured to convert light into an electric signal;
a substrate where said pixel portion is formed;
an A/D conversion unit configured to convert a signal read out from said pixel portion into a digital signal; and
an optical communication unit configured to convert a signal digitized by said A/D conversion unit into an optical signal, and output the optical signal;
wherein said single optical communication unit is disposed discretely in the vicinity portion of said substrate around said pixel portion.

8. The solid-state imaging device according to claim 7, wherein said optical communication unit is disposed at the output of said A/D conversion unit.

9. The solid-state imaging device according to claim 7, further comprising:
a serial interface configured to convert a signal read out from said pixel portion and digitized at said A/D conversion unit into serial data;
wherein said optical communication unit converts a signal output from said serial interface into an optical signal, and outputs the optical signal.

10. The solid-state imaging device according to claim 8, wherein readout of a signal is executed in increments of being divided according to the property of each pixel or the position of each pixel from said pixel portion;
and wherein said A/D conversion unit is disposed as to each of a plurality of signal lines where a signal is read out from said pixel portion.

11. The solid-state imaging device according to claim 9, wherein readout of a signal is executed in increments of being divided according to the property of each pixel or the position of each pixel from said pixel portion;
and wherein said A/D conversion unit and said serial interface are disposed as to each of a plurality of signal lines where a signal is read out from said pixel portion.

12. The solid-state imaging device according to claim 7, said optical communication unit comprising at least in the vicinity thereof facing said pixel portion:
a cooling unit configured to cool heat generated at said optical communication unit.

13. A solid-state imaging device comprising:
a pixel portion configured to convert light into an electric signal;
a substrate where said pixel portion is formed;
an A/D conversion unit configured to convert a signal read out from said pixel portion into a digital signal; and
an optical communication unit configured to convert a signal digitized by said A/D conversion unit into an optical signal, and output the optical signal;
wherein a plurality of said optical communication units are disposed discretely grouped in the vicinity portion of said substrate around said pixel portion.

14. The solid-state imaging device according to claim 13, wherein said optical communication unit is disposed at the output of said A/D conversion unit.

15. The solid-state imaging device according to claim 13, further comprising:
a serial interface configured to convert a signal read out from said pixel portion and digitized at said A/D conversion unit into serial data;
wherein said optical communication unit converts a signal output from said serial interface into an optical signal, and outputs the optical signal.

16. The solid-state imaging device according to claim 14, wherein readout of a signal is executed in increments of being divided according to the property of each pixel or the position of each pixel from said pixel portion;
and wherein said A/D conversion unit is disposed as to each of a plurality of signal lines where a signal is read out from said pixel portion.

17. The solid-state imaging device according to claim 15, wherein readout of a signal is executed in increments of being divided according to the property of each pixel or the position of each pixel from said pixel portion;
and wherein said A/D conversion unit and said serial interface are disposed as to each of a plurality of signal lines where a signal is read out from said pixel portion.

18. The solid-state imaging device according to claim 13, said optical communication unit comprising at least in the vicinity thereof facing said pixel portion:
a cooling unit configured to cool heat generated at said optical communication unit.

19. A signal processing system comprising:
an optical apparatus including
a solid-state imaging device configured to convert incident light into an electric signal, and
an optical element configured to allow said solid-state imaging device to input light; and
a signal processing apparatus to which said optical apparatus is connected;
wherein said solid-state imaging device includes
a pixel portion configured to convert light into an electric signal;
a substrate where said pixel portion is formed;
an A/D conversion unit configured to convert a signal read out from said pixel portion into a digital signal; and
an optical communication unit configured to convert a signal digitized by said A/D conversion unit into an optical signal, and output the optical signal;
and wherein said single optical communication unit or a plurality of said optical communication units are disposed grouped in the vicinity portion of said substrate around said pixel portion, said single optical communication unit is disposed discretely in the vicinity portion of said substrate around said pixel portion, or a plurality of said optical communication units are disposed discretely grouped in the vicinity portion of said substrate around said pixel portion.
